(19) United States
(12) Patent Application Publication
(10) Pub. No.: US 2023/0261207 A1
(43) Pub. Date: Aug. 17, 2023

(54) ELECTRODE FOR POWER STORAGE DEVICES, POWER STORAGE DEVICE, AND SECONDARY BATTERY

(71) Applicant: TDK Corporation, Tokyo (JP)

(72) Inventors: Shuji HIGASHI, Tokyo (JP); Takuya AOKI, Tokyo (JP)

(73) Assignee: TDK Corporation, Tokyo (JP)

(21) Appl. No.: 17/634,372

(22) PCT Filed: Mar. 31, 2021
(86) PCT No.: PCT/JP2021/013925

§ 371 Date: Feb. 10, 2022

(51) Int. Cl. H01M 4/70; H01M 4/66; H01M 4/62; H01M 4/587; H01M 4/133

(52) U.S. Cl. CPC H01M 4/70; H01M 4/667; H01M 4/626; H01M 4/587; H01M 4/133; H01G 11/28

(57) ABSTRACT

An electrode for power storage devices includes: a conductor plate having a first surface which has at least one first recessed portion and a second surface located opposite to the first surface, the first surface including a first region located outside the first recessed portion; and a first composite film including a first layer which contains an insulative material, a first electrically-conductive layer and a second electrically-conductive layer, the first layer being provided between the first electrically-conductive layer and the second electrically-conductive layer, wherein the first electrically-conductive layer of the first composite film is connected with the conductor plate at the first recessed portion, and the second electrically-conductive layer of the first composite film is connected with the first electrically-conductive layer at a position overlapping the first recessed portion as viewed in a normal direction of the first region of the conductor plate.

### TECHNICAL FIELD

The present disclosure relates to an electrode for power storage devices, and a power storage device and a secondary battery including the electrode power storage devices.

### BACKGROUND ART

Using a composite material which includes a resin film with metal layers on opposite surfaces for the current collector of secondary batteries has been proposed. Patent Documents Nos. 1 and 2 listed below disclose lithium ion secondary batteries in which such a composite material is employed as the current collector.

### CITATION LIST

### Patent Literature

Patent Document No. 1: Specification of United States Patent Application No. 2020/0373584
Patent Document No. 2: Japanese Laid-Open Patent Publication No. 2012-155974

### SUMMARY OF INVENTION

### Technical Problem

In power storage devices such as lithium ion secondary battery, it is usual that an electrically-conductive member (lead) is connected with the current collector for taking power out of the enclosure. Betterment of the electrical and mechanical connection between the current collector and the lead can improve the reliability of the power storage devices.

### Solution to Problem

An electrode for power storage devices according to an embodiment of the present disclosure includes: a conductor plate having a first surface which has at least one first recessed portion and a second surface located opposite to the first surface, the first surface including a first region located outside the first recessed portion; and a first composite film including a first layer which contains an insulative material, a first electrically-conductive layer and a second electrically-conductive layer, the first layer being provided between the first electrically-conductive layer and the second electrically-conductive layer, wherein the first electrically-conductive layer of the first composite film is connected with the conductor plate at the first recessed portion, and the second electrically-conductive layer of the first composite film is connected with the first electrically-conductive layer at a position overlapping the first recessed portion as viewed in a normal direction of the first region of the conductor plate.

### Advantageous Effects of Invention

According to an embodiment of the present disclosure, the reliability of a power storage device can be improved.

### BRIEF DESCRIPTION OF DRAWINGS

FIG. 1 is a partially cut-away diagram showing an example of a power storage device according to an embodiment of the present disclosure.

FIG. 2 is an exploded perspective view showing a cell and leads taken out of the power storage device shown in FIG. 1.

FIG. 3 is a schematic cross-sectional view regarding a part of the first electrode shown in FIG. 2.

FIG. 4 is a schematic cross-sectional view regarding a part of the second electrode shown in FIG. 2.

FIG. 5 is a schematic perspective view showing a part of the structure shown in FIG. 2 which includes third portions provided between the second electrode and the lead and their surroundings.

FIG. 6 is a schematic perspective view enlargedly showing a part of the multilayer structure of the composite films which is bound to the lead.

FIG. 7 is a schematic partial cross-sectional view for describing the configuration of the third portions provided between the composite films and the lead.

FIG. 8 is an enlarged view of a region indicated by a dotted circle in FIG. 7.

FIG. 9 is a schematic diagram in which a microscopic image regarding a cross section of recessed portions formed in the upper surface of the lead and their surroundings is depicted with lines.

FIG. 10 is a schematic diagram in which a microscopic image regarding a cross section of the multilayer structure of the composite films and the lead is depicted with lines.

FIG. 11 is a schematic partial cross-sectional view showing an example of the cross-sectional shape of the composite film connected with the lead.

FIG. 12 is a schematic partial cross-sectional view showing another example of the cross-sectional shape of the composite film connected with the lead.

FIG. 13 is a schematic partial cross-sectional view showing still another example of the cross-sectional shape of the composite film connected with the lead.

FIG. 14 is a schematic partial cross-sectional view showing still another example of the cross-sectional shape of the composite film connected with the lead.

FIG. 15 is a schematic partial cross-sectional view enlargedly showing a connecting portion between the composite film in the lowermost layer of the multilayer structure of the composite films and the lead.

FIG. 16 is a schematic top view showing an example of the shape and arrangement of the recessed portions formed in the upper surface of the lead.

FIG. 17 is a schematic top view showing another example of the shape and arrangement of the recessed portions formed in the upper surface of the lead.

FIG. 18 is a schematic top view showing another example of a plurality of recessed portions which can be formed in the multilayer structure of the composite films.

FIG. 19 is a schematic top view showing still another example of a plurality of recessed portions which can be formed in the multilayer structure of the composite films.

FIG. 20 is a top view enlargedly showing one of the plurality of recessed portions which can be formed in the multilayer structure of the composite films.

FIG. 21 is a schematic top view showing still another example of the shape and arrangement of the recessed portions formed in the upper surface of the lead.

FIG. 22 is a schematic top view showing an example of the shape of a plurality of recessed portions which can be formed in a composite film connected with a lead which has the recessed portions shown in FIG. 21 in the upper surface.

FIG. 23 is a top view enlargedly showing one of the plurality of recessed portions shown in FIG. 22.

FIG. 24 is a schematic top view showing still another example of the shape and arrangement of the recessed portions formed in the upper surface of the lead.

FIG. 25 is a schematic cross-sectional view showing a part of the structure shown in FIG. 24.

FIG. 26 is a schematic top view showing an example of the shape of a plurality of recessed portions which can be formed in a composite film connected with a lead which has the recessed portions shown in FIG. 24 in the upper surface.

FIG. 27 is a schematic top view showing still another example of the shape and arrangement of the recessed portions formed in the upper surface of the lead.

FIG. 28 is a schematic top view showing an example of the shape of a plurality of recessed portions which can be formed in a composite film connected with a lead which has the recessed portions shown in FIG. 27 in the upper surface.

FIG. 29 is a schematic top view showing still another example of the shape and arrangement of the recessed portions formed in the upper surface of the lead.

FIG. 30 is a schematic top view showing an example of the shape of a plurality of recessed portions which can be formed in a composite film connected with a lead which has the recessed portions shown in FIG. 29 in the upper surface.

FIG. 31 is a schematic top view showing still another example of the shape and arrangement of the recessed portions formed in the upper surface of the lead.

FIG. 32 is a schematic top view showing an example of the shape of a plurality of recessed portions which can be formed in a composite film connected with a lead which has the recessed portions shown in FIG. 31 in the upper surface.

FIG. 33 is a schematic top view showing still another example of the shape and arrangement of the recessed portions formed in the upper surface of the lead.

FIG. 34 is a schematic top view showing an example of the shape of a plurality of recessed portions which can be formed in a composite film connected with a lead which has the recessed portions shown in FIG. 33 in the upper surface.

FIG. 35 is a schematic top view showing still another example of the shape and arrangement of the recessed portions formed in the upper surface of the lead.

FIG. 36 is a schematic top view showing an example of the shape of a plurality of recessed portions which can be formed in a composite film connected with a lead which has the recessed portions shown in FIG. 35 in the upper surface.

FIG. 37 is a schematic top view showing still another example of the shape and arrangement of the recessed portions formed in the upper surface of the lead.

FIG. 38 is a schematic top view showing an example of the shape of a plurality of recessed portions which can be formed in a composite film connected with a lead which has the recessed portions shown in FIG. 37 in the upper surface.

FIG. 39 is a schematic cross-sectional view for describing another example of the connection between an electrode and a lead in a power storage device of an embodiment of the present disclosure.

FIG. 40 is a partially cut-away view showing a variation example of a power storage device of an embodiment of the present disclosure.

FIG. 41 is a schematic exploded perspective view showing a cell taken out of the power storage device shown in FIG. 40.

FIG. 42 is a partially cut-away view showing another variation example of a power storage device of an embodiment of the present disclosure.

FIG. 43 is a schematic exploded view for describing the configuration of the stack of the first electrode, the second electrode and the separator in the cell shown in FIG. 42.

FIG. 44 is a schematic perspective view showing the second electrode taken out of the cell shown in FIG. 42.

FIG. 45 is a schematic perspective view showing the first electrode taken out of the cell shown in FIG. 42.

FIG. 46 is a partially cut-away view showing still another variation example of a power storage device of an embodiment of the present disclosure.

FIG. 47 is a schematic exploded view for describing the configuration of the stack of the first electrode, the second electrode and the separator in the cell shown in FIG. 46.

FIG. 48 is a flowchart for describing an exemplary manufacturing method of a power storage device of another embodiment of the present disclosure.

FIG. 49 is a perspective view for describing an exemplary tip end shape of a horn applicable to ultrasonic bonding between the lead and the composite films.

FIG. 50 is a perspective view showing another example of the tip end shape of a horn applicable to ultrasonic bonding between the lead and the composite films.

FIG. 51 is a schematic cross-sectional view for describing an exemplary manufacturing process of a power storage device.

FIG. 52 is a schematic cross-sectional view for describing an exemplary manufacturing process of a power storage device.

FIG. 53 is an enlarged schematic cross-sectional view for describing an exemplary manufacturing process of a power storage device.

FIG. 54 is a schematic diagram in which an example of a microscopic image regarding the lower surface of the lead after execution of ultrasonic bonding is depicted with lines.

FIG. 55 is a partially cut-away view showing an example of a power storage device of still another embodiment of the present disclosure.

FIG. 56 is a schematic partial cross-sectional view of the power storage device shown in FIG. 55.

FIG. 57 is a schematic cross-sectional view for describing the geometric properties of a horn microscope used in production of Battery 1-1.

FIG. 58 is a schematic diagram in which a microscopic image of the third portion on the positive electrode side of Battery 1-1 as viewed in the stacking direction of the composite films is depicted with lines.

FIG. 59 is a schematic diagram in which a microscopic image regarding a cross section of a binding portion on the positive electrode side of Battery 1-1 after execution of ultrasonic bonding is depicted with lines.

FIG. 60 is an enlarged view of a part of FIG. 59 and is a schematic diagram in which a microscopic image of a binding portion on the positive electrode side of Battery 1-1 is depicted with lines.

FIG. 61 is a schematic diagram in which a schematic cross-sectional microscopic image for describing the geometric properties of the horn used in production of Battery 2 is depicted with lines.

FIG. 62 is a schematic diagram in which a microscopic image of the third portion on the positive electrode side of Battery 2 as viewed in the stacking direction of the composite films is depicted with lines.

FIG. 63 is a schematic cross-sectional view for describing the geometric properties of the horn used in production of Battery 3.

FIG. 64 is a schematic diagram in which a microscopic image of the third portion on the positive electrode side of Battery 3 as viewed in the stacking direction of the composite films is depicted with lines.

FIG. 65 is a schematic perspective view showing a part of the structure shown in FIG. 2 which includes third portions provided between the first electrode and the lead and their surroundings.

FIG. 66 is a schematic perspective view enlargedly showing a part of the multilayer structure of the composite films which is bound to the lead.

FIG. 67 is a schematic partial cross-sectional view for describing the configuration of the third portions provided between the composite films and the lead.

### DESCRIPTION OF EMBODIMENTS

Hereinafter, embodiments of the present disclosure will be described with reference to the drawings. In the following description, numerical values, shapes, materials, steps, and the order of the steps, etc., are merely exemplary, and various modifications can be made thereto so long as they do not lead to technical contradictions. The embodiments described in the following sections are also merely illustrative, and various combinations are possible so long as they do not lead to technical contradictions.

The size, shape, etc., of the components shown in the drawings of the present disclosure are sometimes exaggerated for convenience of description. In some of the drawings of the present disclosure, excessive complexity is avoided by taking out some of the components for illustration or omitting illustration of some of the components. Thus, the dimensions of each of the components and the arrangement of the components shown in the drawings of the present disclosure sometimes do not reflect the dimensions of each of the components and the arrangement of the components in an actual device.

In the following sections, the configuration, shape, etc., of the components are sometimes explained based on their resemblance to a plane figure such as polygon, circle, etc., or a solid figure such as rectangular solid, pyramid, cone, etc. However, illustration of figures in such an explanation does not intend that the configuration, shape, etc., of the components are identical to such figures in a mathematically strict sense. For example, an actual component can have a shape with partially deformed sides or planes of an illustrated figure. In the present disclosure, the terms “perpendicular” and “orthogonal” are not limited to a case where two straight lines, sides, planes, etc., strictly form an angle of 90° but also involve a case where the angle is in the range of about 90±5°.

In this specification, the term “cell” refers to a structure realized by integrally assembling at least one pair of electrodes, a positive electrode and a negative electrode. The term “battery” used in this specification includes various forms such as battery module, battery pack, etc., which include one or more mutually electrically-connected “cells”.

### Embodiment 1 of Power Storage Device

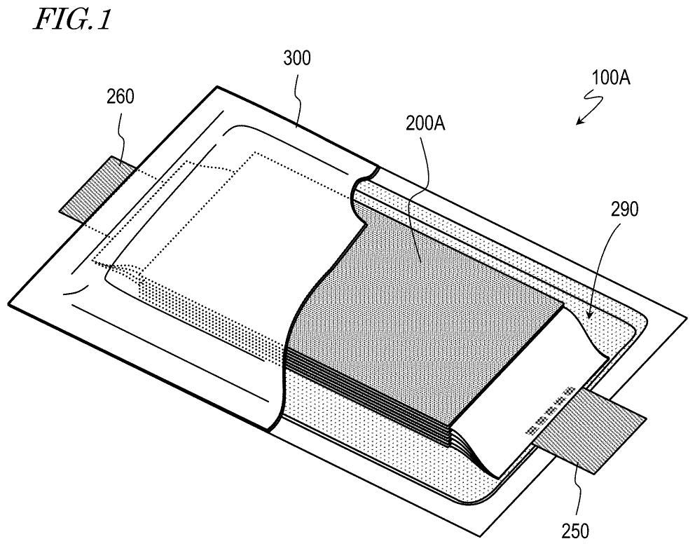

FIG. 1 shows an example of the configuration of a power storage device of an embodiment of the present disclosure. Herein, a laminated-type lithium ion secondary battery is illustrated as the power storage device.

The lithium ion secondary battery 100A shown in FIG. 1 includes a cell 200A which includes one or more sets of a positive electrode and a negative electrode, a pair of conductor plates 250 and 260 connected with the cell 200A, an enclosure 300 covering the cell 200A, and an electrolyte 290. Herein, a lithium ion secondary battery called pouch-type or laminate type is described as the secondary battery 100A.

The cell 200A is contained in a space formed inside the enclosure 300. The conductor plate 250 includes a portion located inside the enclosure 300 and a portion located outside the enclosure 300. Likewise, the conductor plate 260 also includes a portion located inside the enclosure 300 and a portion located outside the enclosure 300. The portion of the conductor plate 250 located outside the enclosure 300 serves as the positive electrode terminal of the secondary battery 100A. The portion of the conductor plate 260 located outside the enclosure 300 serves as the negative electrode terminal of the secondary battery 100A. In the following sections, the conductor plate 250 and the conductor plate 260 are referred to as “lead 250” and “lead 260”, respectively.

The space inside the enclosure 300 further contains the electrolyte 290. The electrolyte 290 is, for example, a non-aqueous electrolytic solution. When a non-aqueous electrolytic solution is employed as the electrolyte 290, a sealing member for preventing leakage of the electrolytic solution (for example, a resin film of polypropylene or the like; not shown in FIG. 1) may be provided between the enclosure 300 and the lead 250 and between the enclosure 300 and the lead 260.

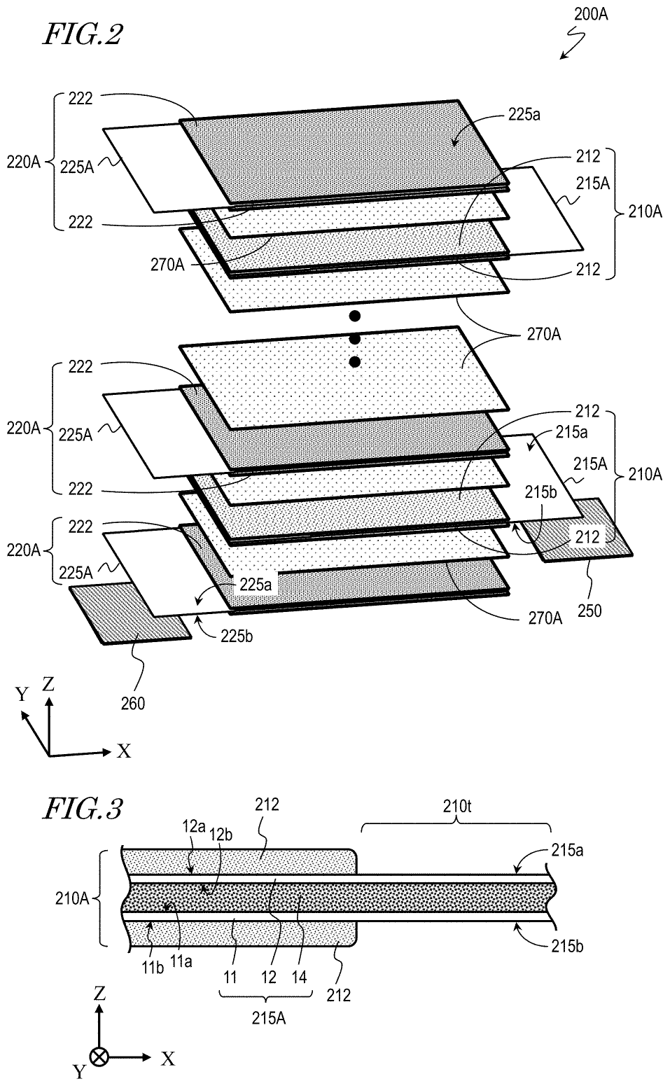

FIG. 2 schematically shows the cell and the pair of leads out of FIG. 1. In the configuration illustrated in FIG. 2, the cell 200A includes one or more first electrodes 210A, one or more second electrodes 220A, and one or more third layers 270A. The first electrodes 210A are, for example, the positive electrodes of the cell 200A. The second electrodes 220A are, for example, the negative electrodes of the cell 200A. In the configuration illustrated in FIG. 2, each of the first electrodes 210A, the second electrodes 220A and the third layers 270A is in the form of a sheet. FIG. 2 shows arrows which represent three mutually-orthogonal directions, X direction, Y direction and Z direction, for convenience of description. In the example shown in FIG. 2, the first electrodes 210A, the second electrodes 220A and the third layers 270A are stacked up along Z direction of the drawing.

As schematically shown in FIG. 2, the cell 200A has such a configuration that the first electrodes 210A and the second electrodes 220A are alternately stacked up with the third layers 270A interposed therebetween. The third layers 270A contain an insulative material and serve as the separators of the cell 200A. The cell 200A includes, for example, 19 first electrodes 210A and 20 second electrodes 220A. In this case, the cell 200A includes 38 third layers 270A in total, which are respectively located between the first electrodes 210A and the second electrodes 220A. Herein, Z direction of the drawing is coincident with a direction in which the first electrodes 210A, the second electrodes 220A and the third layers 270A are stacked up. In this specification, Z direction of the drawing is also referred to as stacking direction.

Each of the first electrodes 210A includes a composite film 215A, which has the first surface 215a and the second surface 215b, and a first material layer 212. The first surface 215a is the upper surface of the composite film 215A. The second surface 215b is the lower surface of the composite film 215A, which is oriented to the side opposite to the first surface 215a in Z direction of the drawing. The first material layer 212 is provided on the first surface 215a and the second surface 215b of the composite film 215A. The first material layer 212 is a layer of the cell 200A which contains, for example, the positive electrode active material. Note that, in the description of the present disclosure, terms including “upper” or “lower”, such as “upper surface”, “lower surface”, “upper layer”, “lower layer”, etc., are sometimes used. However, this is only for the convenience in describing the relative arrangement of the components but does not intend to limit the orientation of the power storage device in use. For example, “upper surface” refers to a surface located at the positive side in Z direction of the drawing, while “lower surface” refers to a surface located at the negative side in Z direction of the drawing.

Each of the second electrodes 220A includes a composite film 225A, which has the third surface 225a and the fourth surface 225b, and a second material layer 222. The third surface 225a is the upper surface of the composite film 225A. The fourth surface 225b is the lower surface of the composite film 225A, which is oriented to the side opposite to the third surface 225a in Z direction of the drawing. The second material layer 222 is a layer of the cell 200A which contains, for example, the negative electrode active material. The second material layer 222 is provided on one or both of the third surface 225a and the fourth surface 225b of the composite film 225A. Note that, however, one of the plurality of second electrodes 220A located in the uppermost layer of the multilayer structure of the first electrodes 210A and the second electrodes 220A may not be provided with a second material layer 222 on its third surface 225a. Likewise, one of the plurality of second electrodes 220A located in the lowermost layer of the multilayer structure of the first electrodes 210A and the second electrodes 220A may not be provided with a second material layer 222 on its fourth surface 225b that is opposite to the third surface 225a.

Each of the third layers 270A is provided between a first electrode 210A and a second electrode 220A located closest to that first electrode 210A. The third layer 270A is made of an insulative material, such as resin, and prevents direct contact between the first material layer 212 on the composite film 215A and the second material layer 222 on the composite film 225A.

As will be described later, the composite film 215A includes an electrically-conductive layer which is in contact with the first material layer 212 and serves as the current collector of the first electrode 210A. Likewise, the composite film 225A includes an electrically-conductive layer which is in contact with the second material layer 222 and serves as the current collector of the second electrode 220A. As schematically shown in FIG. 2, the composite film 215A of each of the first electrodes 210A includes, in each of the first surface 215a and the second surface 215b, a region on which the first material layer 212 is not provided. Those regions in an actual device are in physical contact with, and electrically connected with, each other between different composite films 215A, although they are illustrated as being separated from each other in FIG. 2. This also applies to the second electrode 220A. Each of the third surface 225a and the fourth surface 225b of each composite film 225A includes a region on which the second material layer 222 is not provided and which is mutually connected between a plurality of second electrodes 220A. FIG. 2 shows an example of the configuration where a plurality of sets, each including a single first electrode 210A and a single second electrode 220A, are electrically connected in parallel.

In the example shown in FIG. 2, the lead 250 is connected with the second surface 215b of one of the plurality of first electrodes 210A which is located in the lowermost layer of the multilayer structure of the first electrodes 210A and the second electrodes 220A. The lead 260 is connected with the fourth surface 225b of one of the plurality of second electrodes 220A which is located in the lowermost layer of the multilayer structure of the first electrodes 210A and the second electrodes 220A.

In an embodiment of the present disclosure, as the composite film 215A and the composite film 225A, a composite material realized by a film containing an insulative material, such as resin, with electrically-conductive layers on opposite surfaces of the film, is employed. As will be described later in detail with reference to the drawings, in an embodiment of the present disclosure, electrical connection is formed between two electrically-conductive layers in a composite film, while electrical connection is also formed between the electrically-conductive layer in the composite film and the lead. Herein, it is beneficial that one of the surfaces of the lead facing the composite film has one or more recessed portions, and the recessed portions realize mechanical connection and electrical connection between the lead and the electrically-conductive layer in the composite film.

According to an embodiment of the present disclosure, one or more recessed portions provided in the lead realize connection between the lead and the electrically-conductive layer of the composite film and therefore can increase the area of the interface between the lead and the composite film. Since a region where mechanical and electrical connection is formed between the lead and the composite film can be increased, these components can be more firmly bonded together and the bonding strength improves. As a result, the reliability of a power storage device, such as secondary battery, can be improved. Hereinafter, the first electrode 210A, the second electrode 220A and the leads 250, 260, and the connection between these components are described in more detail.

FIG. 3 schematically shows a part of a cross section of the first electrode shown in FIG. 2. FIG. 3 shows arrows which represent mutually-orthogonal directions, X direction, Y direction and Z direction, as does FIG. 2. Some of the other drawings of the present disclosure also show arrows which represent X direction, Y direction and Z direction.

As previously described with reference to FIG. 2, the first electrode 210A includes the composite film 215A and the first material layer 212 supported by the composite film 215A. The first material layer 212 is provided on both of the first surface 215a side and the second surface 215b side of the composite film 215A.

As shown in FIG. 3, each of the first surface 215a and the second surface 215b of the composite film 215A includes a region overlapping the first material layer 212 and a region located outside the first material layer 212 as viewed in Z direction. Hereinafter, for convenience of description, a region of the composite film 215A which does not overlap the first material layer 212 as viewed in Z direction of the drawing, i.e., a region located outside the first material layer 212, is also referred to as “tab region 210t”.

In the configuration illustrated in FIG. 3, the composite film 215A includes a first electrically-conductive layer 11, a second electrically-conductive layer 12, and a first layer interposed between the first electrically-conductive layer 11 and the second electrically-conductive layer 12. The first electrically-conductive layer 11 has an upper surface 11a which is on the first layer 14 side and a lower surface 11b which is opposite to the upper surface 11a. The second electrically-conductive layer 12 has a lower surface 12b which is on the first layer 14 side and an upper surface 12a which is opposite to the lower surface 12b. Herein, the lower surface 11b of the first electrically-conductive layer 11 is identical with the second surface 215b of the composite film 215A, and the upper surface 12a of the second electrically-conductive layer 12 is identical with the first surface 215a of the composite film 215A.

The first layer 14 is a supporting layer for the first electrically-conductive layer 11 and the second electrically-conductive layer 12 and contains an insulative material, such as resin. An example of the first layer 14 is a resin layer containing a thermoplastic resin such as polyethylene terephthalate (PET). The first layer 14 has a thickness in the range of not less than 3 μm and not more than 12 μm, preferably in the range of not less than 3 μm and not more than 6 μm (e.g., about 4.5 μm). In application to the positive electrode of a lithium ion secondary battery, each of the first electrically-conductive layer 11 and the second electrically-conductive layer 12 can be an aluminum film.

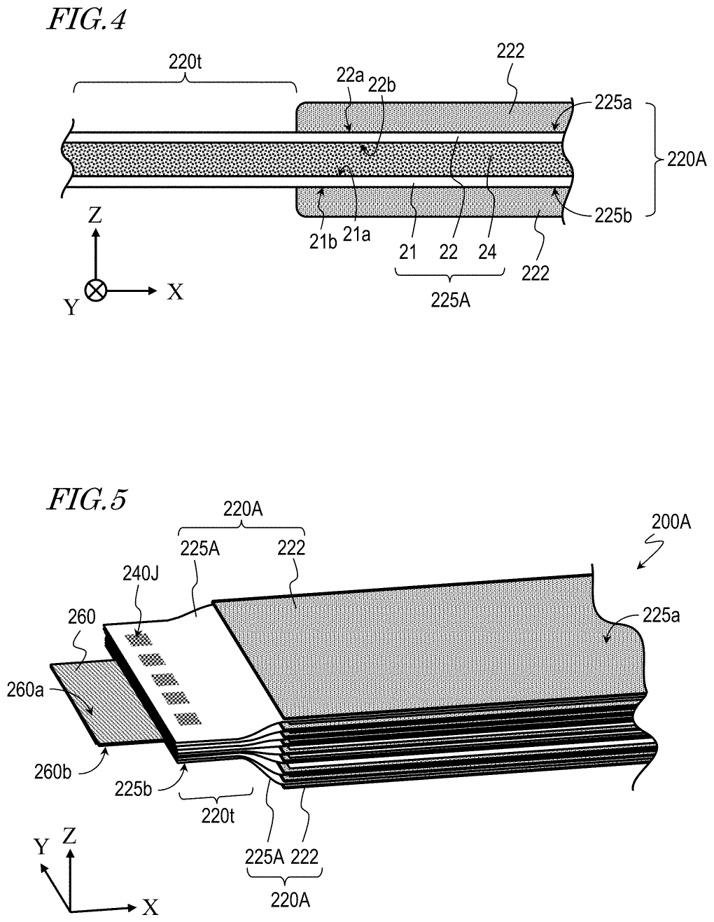

FIG. 4 schematically shows a part of a cross section of the second electrode shown in FIG. 2. The second electrode 220A of the present embodiment has basically the same configuration as the first electrode 210A except that the materials of the respective parts are different. Specifically, the second electrode 220A includes the composite film 225A which has the third surface 225a and the fourth surface 225b. The second electrode 220A further includes one or more second material layers 222. In the configuration illustrated in FIG. 2, one of the second electrodes 220A in the cell 200A which is located in the outermost part of the multilayer structure of the first electrodes 210A and the second electrodes 220A has the second material layer 222 at either of the third surface 225a side and the fourth surface 225b side of the composite film 225A. The second electrodes 220A at other positions in the multilayer structure of the first electrodes 210A and the second electrodes 220A include, as shown in FIG. 4, a second material layer 222 provided on the third surface 225a side of the composite film 225A and a second material layer 222 provided on the fourth surface 225b side.

In the configuration illustrated in FIG. 4, the composite film 225A includes a first electrically-conductive layer 21, a second electrically-conductive layer 22, and a first layer 24 provided between the first electrically-conductive layer 21 and the second electrically-conductive layer 22. The first electrically-conductive layer 21 has an upper surface 21a which is on the first layer 24 side and a lower surface 21b which is opposite to the upper surface 21a. The second electrically-conductive layer 22 has a lower surface 22b which is on the first layer 24 side and an upper surface 22a which is opposite to the lower surface 22b. As shown in FIG. 4, herein, the lower surface 21b of the first electrically-conductive layer 21 is identical with the fourth surface 225b of the composite film 225A, and the upper surface 22a of the second electrically-conductive layer 22 is identical with the third surface 225a of the composite film 225A. As does the composite film 215A of the first electrode 210A, the composite film 225A of the second electrode 220A also includes a region on which the second material layer 222 is not provided (hereinafter, referred to as “tab region 220t”).

The first layer 24 is a supporting layer for the first electrically-conductive layer 21 and the second electrically-conductive layer 22 and can be a resin layer containing an insulative material, such as polyethylene terephthalate, as is the above-described first layer 14. Meanwhile, in application to a lithium ion secondary battery, each of the first electrically-conductive layer 21 and the second electrically-conductive layer 22 can be an electrically-conductive layer made of copper.

As previously briefly described with reference to FIG. 2, the lead 250 is connected with the first electrode 210A, and the lead 260 is connected with the second electrode 220A. As the lead 250 on the first electrode 210A side, for example, an aluminum plate of about 100-200 μm in thickness is employed. Meanwhile, as the lead 260 on the second electrode 220A side, for example, a nickel plate of about 100-200 μm in thickness is employed. Note that, in this specification, the “plate” means a self-supporting structure but is not limited to a member which has a thickness in a particular range. In this specification, the “plate” can include various forms such as foil, sheet, bar, etc.

FIG. 5 schematically shows a part of the structure shown in FIG. 2, including a plurality of portions (hereinafter, referred to as “third portions”) which include a bonded portion of the second electrode and the lead and their surroundings, which are taken out for illustration. The lead 260 has an upper surface 260a (first surface) and a lower surface 260b (second surface) located on a side opposite to the upper surface 260a. In the configuration illustrated in FIG. 5, a part of the upper surface 260a of the lead 260 faces the fourth surface 225b of one of the plurality of second electrodes 220A which is located in the lowermost part of the cell 200A and is bonded to its composite film 225A.

As schematically shown in FIG. 5, one or more third portions 240J are provided between the lead 260 and the multilayer structure of a plurality of tab regions 220t on the lead 260. Each of the third portions 240J includes one or more bonded portions. FIG. 5 shows an example where the third portions 240J between the second electrode 220A and the lead 260 are provided at a plurality of locations in the tab regions 220t. As will be described later, each of the third portions 240J includes one or more bonded portions at which the second electrode 220A and the lead 260 are electrically and mechanically bonded to each other by solid-phase bonding. The third portions 240J can also include a region where solid-phase bonding is not formed between the second electrode 220A and the lead 260. Note that the same connection structure as the second electrode 220A can be employed between the first electrodes 210A and the lead 250 in the cell 200A. Note that, however, in the following sections, details of the connection between the second electrode 220A and the lead 260 are mainly described for the purpose of avoiding redundant description.

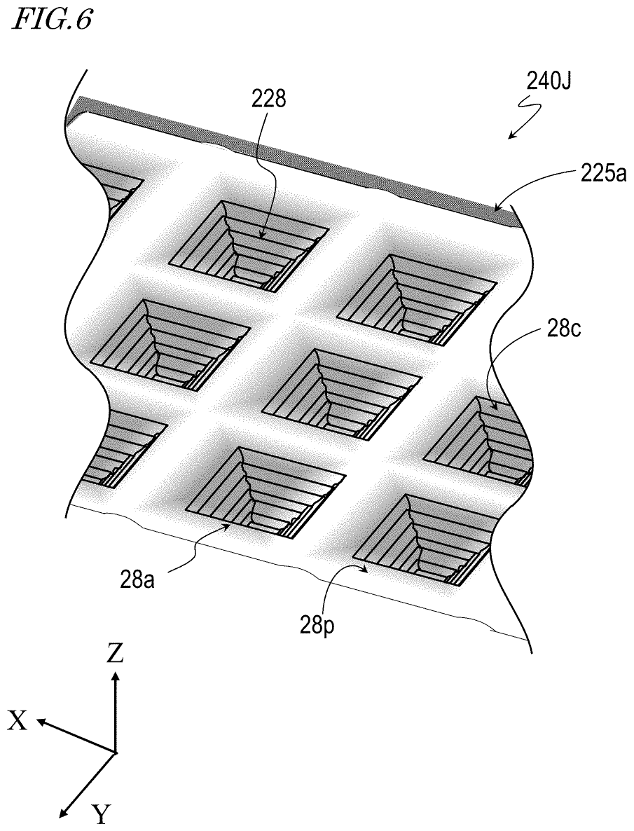

FIG. 6 schematically shows the appearance of the third portion in the multilayer structure of the composite films. Each of the third portions 240J shown in FIG. 5 has a plurality of recessed portions 228 formed in the multilayer structure of the composite films 225A as shown in FIG. 6. In the example shown in FIG. 6, the plurality of recessed portions 228 are formed along X direction and Y direction of the drawing, which are orthogonal to each other, in the multilayer structure of the composite films 225A.

FIG. 6 is an example where a plurality of recessed portions 228 are formed in tab regions 220t as the connection structure between the lead 260 and the plurality of second electrodes 220A. In the configuration illustrated in FIG. 6, each of the plurality of recessed portions 228 has an opening 28a in the third surface 225a of the composite film 225A in the uppermost layer and inner wall surfaces 28c.

When viewed in Z direction of the drawing, the opening 28a has a generally rectangular shape. Herein, “rectangular” in this specification is not limited to a quadrilateral in which all of the corners are at strictly right angles. A shape with rounded corners can be included in “rectangular” in this specification. Each side of a quadrilateral is not limited to a line segment but may have windings. “Having windings” means that, for example, with respect to an imaginary line segment which is a side of a rectangle, the side has meanders in the range of ±30% of the length of that line segment in its orthogonal direction. In other cases, it means that with respect to an imaginary line segment which is a side of a rectangle, the side has meanders in the range of ±300 μm in its orthogonal direction.

In the example shown in FIG. 6, a raised portion 28p, which is raised in positive Z direction with respect to the upper surface 260a of the lead 260, is provided so as to surround the openings 28a. When viewed in Z direction of the drawing, two raised portions 28p may be provided between two adjacent openings 28a in some cases, while a single raised portion 28p may be provided between two adjacent openings 28a in other cases. It is not essential for an embodiment of the present disclosure that the third surface 225a of the composite film 225A has the raised portion 28p around each of the openings 28a.

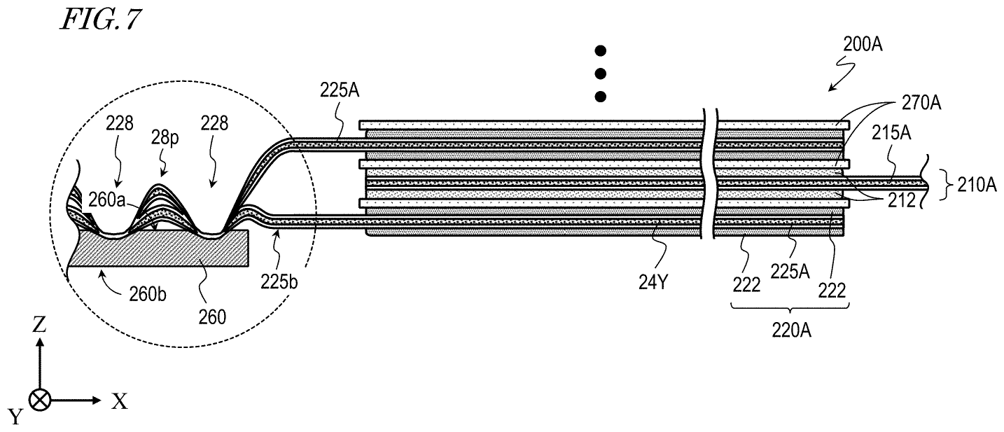

FIG. 7 schematically shows a part of a cross section of a third portion between composite films and a lead. Although in an actual device about 20 composite films can be connected with the lead, FIG. 7 only shows, for the purpose of avoiding an excessively complex drawing, one of the composite films 225A included in the cell 200A which is in the lowermost layer of the multilayer structure of the first electrodes 210A and the second electrodes 220A (in other words, one of the composite films 225A which is closest to the lead 260) and another composite film 225A which is provided above the lowermost composite film 225A with a first electrode 210A interposed therebetween, which are taken out for illustration.

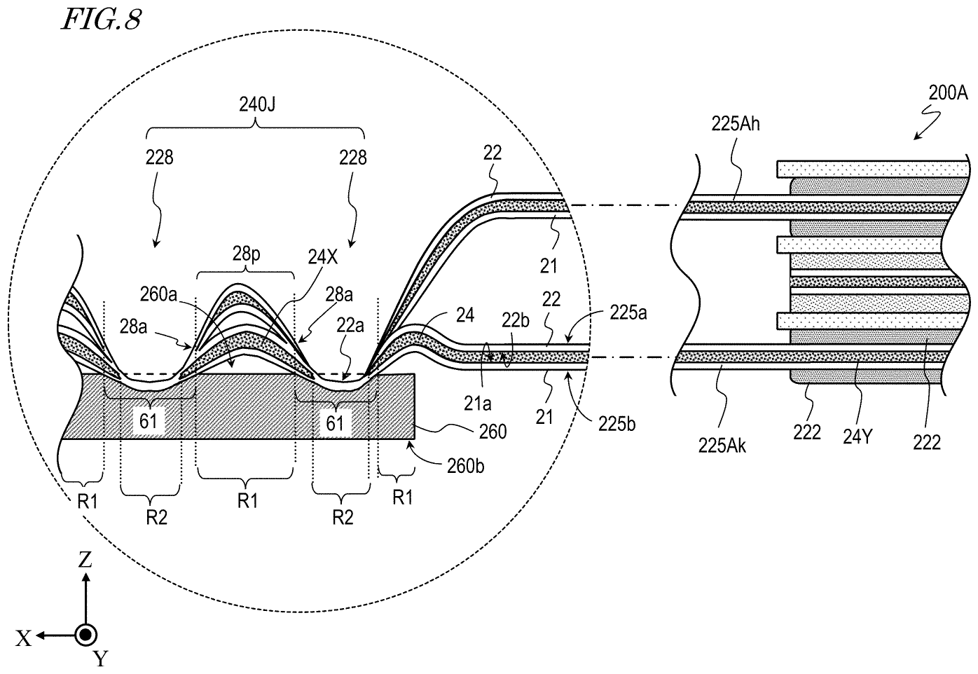

The lead 260 has a plate-like shape extending across a plane parallel to the XY plane of the drawing. Herein, “plate-like shape” in this specification also includes a shape which partially has warpages and a shape which has recesses in a part of the surface. FIG. 8 enlargedly shows a region indicated by a dotted circle in FIG. 7. As shown in FIG. 8, the upper surface 260a of the lead 260 can have at least one recessed portion 61. Each of the recessed portions 61 has an opening 61a in the upper surface 260a of the lead 260.

The composite films 225A in the cell 200A are electrically and mechanically connected at, for example, the recessed portions 61 of the lead 260. Herein, for convenience of description, one of the plurality of composite films 225A included in the multilayer structure of the first electrodes 210A and the second electrodes 220A which is closest to the lead 260 is referred to as composite film 225Ak, and another composite film 225A which is one layer above the composite film 225Ak is referred to as composite film 225Ah. In this specification, the composite film 225Ak is also referred to as “first composite film”, and the composite film 225Ah is also referred to as “second composite film”. In that case, the first layer, the first electrically-conductive layer and the second electrically-conductive layer of the first composite film are also referred to as “first layer”, “first electrically-conductive layer” and “second electrically-conductive layer”, respectively, and the first layer, the first electrically-conductive layer and the second electrically-conductive layer of the second composite film are also referred to as “second layer”, “third electrically-conductive layer” and “fourth electrically-conductive layer”.

Firstly, attention is paid to one of the plurality of composite films 225A which is closest to the lead 260, the composite film 225Ak. As schematically shown in FIG. 8, parts of the first electrically-conductive layer 21 of the composite film 225Ak are in contact with, and connected with, the lead 260 at positions overlapping the recessed portions 61 as viewed in Z direction of the drawing. Next, attention is paid to the second electrically-conductive layer 22 of the composite film 225Ak which is located on a side opposite to the first electrically-conductive layer 21 with respect to the first layer 24. This second electrically-conductive layer 22 is connected with the first electrically-conductive layer 21 at positions overlapping the recessed portions 61 as viewed in Z direction of the drawing. In other words, in this example, the first electrically-conductive layer 21 and the second electrically-conductive layer 22 of the composite film 225Ak are connected with the lead 260 at positions overlapping the recessed portions 61 of the lead 260 as viewed in Z direction of the drawing. The first electrically-conductive layer 21 and the second electrically-conductive layer 22 may be connected with the lead 260 at positions lower than a region of the upper surface 260a of the lead 260 which does not have a recessed portion 61.

At least part of the first electrically-conductive layer 21 of the composite film 225Ah in the second layer is located between the second electrically-conductive layer 22 of the composite film 225Ah and the second material layer 222 of the composite film 225Ak in the lowermost layer. Other parts of the first electrically-conductive layer 21 of the composite film 225Ah are connected with the second electrically-conductive layer 22 of the composite film 225Ak in the lowermost layer at positions overlapping the recessed portions 61 of the lead 260 as viewed in Z direction of the drawing as schematically shown in FIG. 8. Further, the second electrically-conductive layer 22 of the composite film 225Ah is connected with the first electrically-conductive layer 21 of the composite film 225Ah at positions overlapping the recessed portions 61 of the lead 260 as viewed in Z direction of the drawing. That is, at positions overlapping the recessed portions 61 of the lead 260 as viewed in Z direction of the drawing, a channel of electrical conduction is formed between the first electrically-conductive layer 21 and the second electrically-conductive layer 22 of the plurality of composite films 225A.

As shown in FIG. 8, the upper surface 260a of the lead 260 has a flat first region R1 which faces the fourth surface 225b of the composite film 225Ak in the lowermost layer. Herein, in this specification, the “flatness” of the first region R1 means that the distance from the highest part to the lowest part of the first region R1 is within 3% of the thickness of the lead. The thickness of the lead is the distance in Z direction from the lower surface to the upper surface of the lead. In this specification, viewing in Z direction (planar view) is also referred to as “viewing in the normal direction of the first region”.

The upper surface 260a of the lead 260 further includes one or more second regions R2. The second regions R2 are regions where a bond interface is formed between the material of the first electrically-conductive layer 21 of the composite film 225A and the material of the lead 260. It can be said that the previously-described first region R1 is a region located outside the second regions R2.

When the upper surface 260a has one or more recessed portions 61, the second regions R2 may be located inside respective ones of the recessed portions 61 as illustrated in FIG. 8. Alternatively, as will be described later, the second regions R2 may include the recessed portions 61. The first region R1 is a region which is located outside one or more recessed portions 61 and which is located outside the second regions R2. The first region R1 may include a flat region. As illustrated in FIG. 8, when the upper surface 260a has, for example, a plurality of recessed portions 61 two-dimensionally arranged along X direction and Y direction of the drawing, the first region R1 is formed in the form of a grid across the upper surface 260a as viewed in Z direction of the drawing.

When the upper surface 260a of the lead 260 has recessed portions 61, at least parts of the third surface 225a of the composite film 225A located above the recessed portions 61 are recessed toward the lead 260 side. That is, it can be said that the openings 28a of the composite film 225A are parts of the third surface 225a of the composite film 225A overlapping the perimeters of the recessed portions 61 (i.e., opening 61a) as viewed in Z direction.

In the example shown in FIG. 8, the upper surface 260a of the lead 260 has two recessed portions 61 adjacent each other in X direction of the drawing. In this example, a portion of the first layer 24 of the composite film 225Ak located closest to the lead 260 which is provided between these two recessed portions 61 as viewed in Z direction of the drawing (hereinafter, referred to as “first portion 24X”) includes a part whose thickness varies along X direction of the drawing. More specifically, the first portion 24X includes a part whose thickness increases in a direction from one to the other of these two recessed portions 61 and another part whose thickness decreases in a direction from one to the other of these two recessed portions 61. The thickness of the first portion 24X refers to the distance in the direction of stacking of the plurality of composite films (which is coincident with Z direction of the drawings in the example of FIG. 7 and FIG. 8) from the upper surface 21a (the surface on the first layer 24 side) of the first electrically-conductive layer 21 to the lower surface 22b (the surface on the first layer 24 side) of the second electrically-conductive layer 22.

The first portion 24X of the first layer 24 in the same composite film 225A can have a portion whose thickness is greater than a part of the first layer 24 overlapping the second material layer 222 as viewed in Z direction of the drawing (hereinafter, referred to as “second portion 24Y”; see FIG. 7). Since the thickness of the composite film increases in a region lying between two adjacent recessed portions of the upper surface of the lead, when for example shear stress is applied to the composite film, occurrence of a tear in the composite film starting from a position between two recessed portions of the lead can be suppressed. That is, rupture of the composite film is suppressed, and the effect of improving the reliability of the power storage device is achieved.

In FIG. 8, attention is now paid to the composite film 225Ah that is one layer above the composite film 225Ak in the lowermost layer. The second electrically-conductive layer 22 of the composite film 225Ah has an upper surface 22a located on a side opposite to the first electrically-conductive layer 21. The upper surface 22a of the second electrically-conductive layer 22 forms the third surface 225a of the composite film 225A. In the configuration illustrated in FIG. 8, parts of the upper surface 22a of the second electrically-conductive layer 22 overlapping the recessed portions 61 of the lead 260 as viewed in Z direction of the drawing are present at a lower level than the position of the first region R1 of the lead 260 which is indicated by broken lines in FIG. 8. That is, the upper surface 22a of the second electrically-conductive layer 22 can include parts which are closer to the lower surface 260b of the lead 260 relative to the position of the first region R1 of the upper surface 260a of the lead 260.

The same connection structure as the second electrodes 220A is also applicable to the connection between the first electrodes 210A and the lead 250 in the cell 200A.

FIG. 65 schematically shows a part of the structure shown in FIG. 2, including a plurality of third portions 140J which include a bonded portion of the first electrode and the lead and their surroundings, which are taken out for illustration. The lead 250 has the upper surface 250a (first surface) and the lower surface 250b (second surface) located on a side opposite to the upper surface 250a. In the configuration illustrated in FIG. 65, a part of the upper surface 250a of the lead 250 faces the second surface 215b of one of the plurality of first electrodes 210A located in the lowermost part of the cell 200A and is bonded to its composite film 215A.

As schematically shown in FIG. 65, one or more third portions 140J each including one or more bonded portions are provided between the lead 250 and a multilayer structure of a plurality of tab regions 210t on the lead 250. FIG. 65 shows an example where the third portions 140J between the first electrodes 210A and the lead 250 are provided at a plurality of locations in the tab regions 210t. As will be described later, each of the third portions 140J includes one or more bonded portions at which the first electrodes 210A and the lead 250 are electrically and mechanically bonded by solid-phase bonding. The third portions 140J can include a region where solid-phase bonding is not formed between the first electrodes 210A and the lead 250.

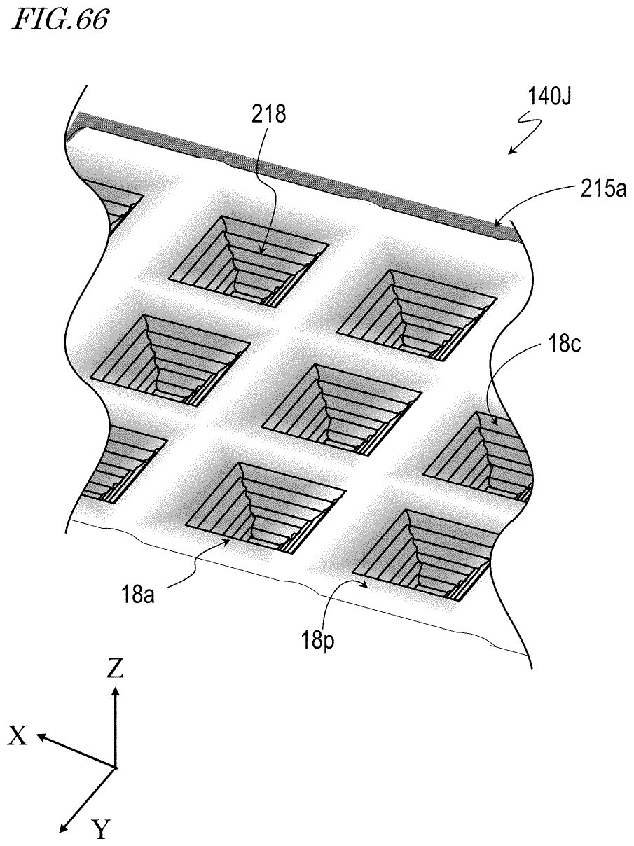

FIG. 66 schematically shows the appearance of the third portions 140J in the multilayer structure of the composite films. Each of the third portions 140J shown in FIG. 65 has a plurality of recessed portions 218 formed in the multilayer structure of the composite films 215A as shown in FIG. 66. In the example shown in FIG. 66, the plurality of recessed portions 218 are formed along X direction and Y direction of the drawing, which are orthogonal to each other, in the multilayer structure of the composite films 215A.

FIG. 66 is an example where a plurality of recessed portions 218 are formed in tab regions 210t as the connection structure between the lead 250 and the plurality of first electrodes 210A. In the configuration illustrated in FIG. 66, each of the plurality of recessed portions 218 has an opening 18a in the first surface 215a of the composite film 215A in the uppermost layer and four inner wall surfaces 18c. The opening 18a has a generally rectangular shape as viewed in Z direction of the drawing likewise as illustrated in FIG. 6.

In the example shown in FIG. 66, a raised portion 18p, which is raised in positive Z direction with respect to the upper surface 250a of the lead 250, is provided so as to surround the openings 18a. When viewed in Z direction of the drawing, two raised portions 18p may be provided between two adjacent openings 18a in some cases, while a single raised portion 18p may be provided between two adjacent openings 18a in other cases. It is not essential for an embodiment of the present disclosure that the first surface 215a of the composite film 215A has the raised portion 18p around each of the openings 18a.

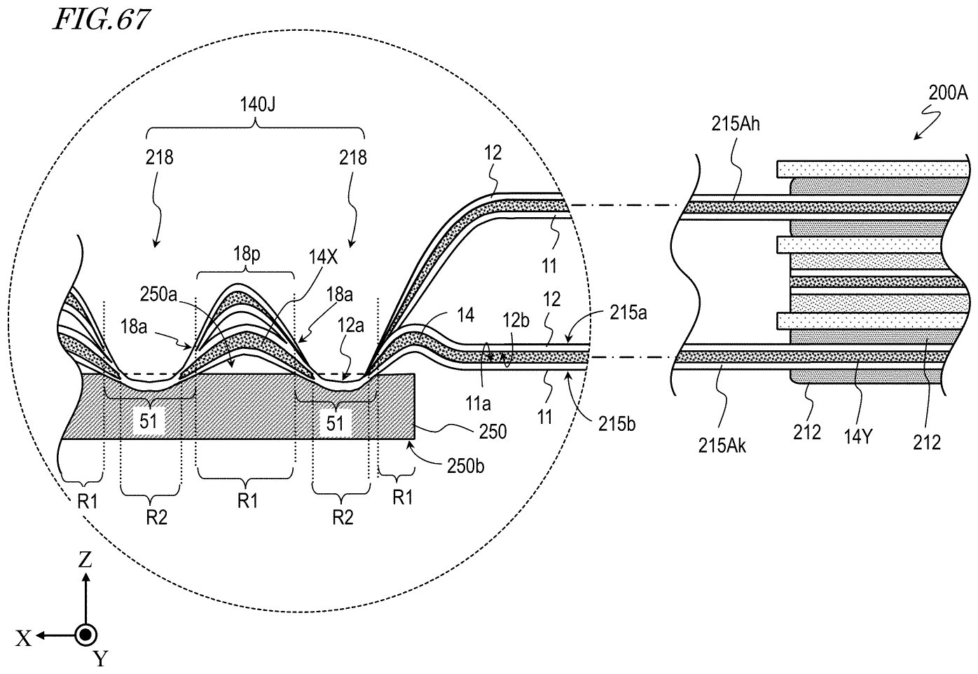

FIG. 67 schematically shows a part of a cross section of the third portion between composite films and a lead. FIG. 67 only shows one of the composite films 215A included in the cell 200A which is in the lowermost layer of the multilayer structure of the first electrodes 210A and the second electrodes 220A (in other words, one of the composite films 215A which is closest to the lead 250) and another composite film 215A which is provided above the lowermost composite film 215A with a second electrode 220A interposed therebetween, which are taken out for illustration, as does FIG. 8.

The lead 250 has a plate-like shape extending across a plane parallel to the XY plane of the drawing. FIG. 67 also shows together an enlarged view of a region indicated by a dotted circle in FIG. 67. As shown in FIG. 67, the upper surface 250a of the lead 250 can have at least one recessed portion 51.

The composite films 215A in the cell 200A are electrically and mechanically connected at, for example, the recessed portions 51 of the lead 250. Herein, for convenience of description, one of the plurality of composite films 215A included in the multilayer structure of the first electrodes 210A and the second electrodes 220A which is closest to the lead 250 is referred to as composite film 215Ak, and another composite film 215A which is one layer above the composite film 215Ak is referred to as composite film 215Ah. In this specification, the composite film 215Ak is also referred to as “first composite film”, and the composite film 215Ah is also referred to as “second composite film”. In that case, the first layer, the first electrically-conductive layer and the second electrically-conductive layer of the first composite film are also referred to as “first layer”, “first electrically-conductive layer” and “second electrically-conductive layer”, respectively, and the first layer, the first electrically-conductive layer and the second electrically-conductive layer of the second composite film are also referred to as “second layer”, “third electrically-conductive layer” and “fourth electrically-conductive layer”, respectively.

Firstly, attention is paid to one of the plurality of composite films 215A which is closest to the lead 250, the composite film 215Ak. As schematically shown in FIG. 67, parts of the first electrically-conductive layer 11 of the composite film 215Ak are in contact with, and connected with, the lead 250 at positions overlapping the recessed portions 51 as viewed in Z direction of the drawing. Next, attention is paid to the second electrically-conductive layer 12 of the composite film 215Ak which is located on a side opposite to the first electrically-conductive layer 11 with respect to the first layer 14. This second electrically-conductive layer 12 is connected with the first electrically-conductive layer 11 at positions overlapping the recessed portions 51 as viewed in Z direction of the drawing. In other words, in this example, the first electrically-conductive layer 11 and the second electrically-conductive layer 12 of the composite film 215Ak are connected with the lead 250 at positions overlapping the recessed portions 51 of the lead 250 as viewed in Z direction of the drawing. The first electrically-conductive layer 11 and the second electrically-conductive layer 12 may be connected with the lead 260 at positions lower than a region of the upper surface 250a of the lead 250 which does not have a recessed portion 51.

At least part of the first electrically-conductive layer 11 of the composite film 215Ah in the layer which is the second in order is located between the second electrically-conductive layer 12 of the composite film 215Ah and the first material layer 212 of the composite film 215Ak in the lowermost layer. Other parts of the first electrically-conductive layer 11 of the composite film 215Ah are connected with the second electrically-conductive layer 12 of the composite film 215Ak in the lowermost layer at positions overlapping the recessed portions 51 of the lead 250 as viewed in Z direction of the drawing as schematically shown in FIG. 67. Further, the second electrically-conductive layer 12 of the composite film 215Ah is connected with the first electrically-conductive layer 11 of the composite film 215Ah at positions overlapping the recessed portions 51 of the lead 250 as viewed in Z direction of the drawing. That is, at positions overlapping the recessed portions 51 of the lead 250 as viewed in Z direction of the drawing, a channel of electrical conduction is formed between the first electrically-conductive layer 11 and the second electrically-conductive layer 12 of the plurality of composite films 215A.

As shown in FIG. 67, the upper surface 250a of the lead 250 has a flat first region R1 which faces the second surface 215b of the composite film 215Ak in the lowermost layer. The upper surface 250a of the lead 250 further includes one or more second regions R2 each having recessed portions 51. Herein, the second regions R2 are regions where a bond interface is formed between the material of the first electrically-conductive layer 11 of the composite film 215A and the material of the lead 250. It can be said that the first region R1 is a region located outside the second regions R2.

When the upper surface 250a has one or more recessed portions 51, the second regions R2 may be located inside respective ones of the recessed portions 51 as illustrated in FIG. 67. Alternatively, as will be described later, the second regions R2 may include the recessed portions 51. The first region R1 is a region which is located outside one or more recessed portions 51 and which is located outside the second regions R2. The first region R1 may include a flat region. As illustrated in FIG. 67, when the upper surface 250a has, for example, a plurality of recessed portions 51 two-dimensionally arranged along X direction and Y direction of the drawing, the first region R1 is formed in the form of a grid across the upper surface 250a as viewed in Z direction of the drawing.

When the upper surface 250a of the lead 250 has recessed portions 51, at least parts of the upper surface 215a of the composite film 215A located above the recessed portions 51 are recessed toward the lead 250 side. That is, it can be said that the openings 18a of the composite film 215A are parts of the upper surface 215a of the composite film 215A overlapping the perimeters of the recessed portions 51 (i.e., opening 51a) as viewed in Z direction.

In the example shown in FIG. 67, the upper surface 250a of the lead 250 has two recessed portions 51 adjacent each other in X direction of the drawing. In this example, a portion of the first layer 14 of the composite film 215Ak located closest to the lead 250 which is provided between these two recessed portions 51 as viewed in Z direction of the drawing (hereinafter, referred to as “first portion 14X”) includes a part whose thickness varies along X direction of the drawing. More specifically, the first portion 14X includes a part whose thickness increases along a direction from one to the other of these two recessed portions 51 and another part whose thickness decreases along a direction from one to the other of these two recessed portions 51. The thickness of the first portion 14X refers to the distance in the direction of stacking of the plurality of composite films (which is coincident with Z direction of the drawings in the example of FIG. 67) from the upper surface 11a (the surface on the first layer 14 side) of the first electrically-conductive layer 11 to the lower surface 12b (the surface on the first layer 14 side) of the second electrically-conductive layer 12.

The first portion 14X of the first layer 14 in the same composite film 215A can have a portion whose thickness is greater than a part of the first layer 14 overlapping the first material layer 212 as viewed in Z direction of the drawing (hereinafter, referred to as “second portion 14Y”). Since the thickness of the composite film increases in a region lying between two adjacent recessed portions of the upper surface of the lead, when for example shear stress is applied to the composite film, occurrence of a tear in the composite film starting from a position between two recessed portions of the lead can be suppressed. That is, rupture of the composite film is suppressed, and the effect of improving the reliability of the power storage device is achieved.

In FIG. 67, attention is now paid to the composite film 215Ah that is one layer above the composite film 215Ak in the lowermost layer. The second electrically-conductive layer 12 of the composite film 215Ah has an upper surface 12a located on a side opposite to the first electrically-conductive layer 11. The upper surface 12a of the second electrically-conductive layer 12 forms the first surface 215a of the composite film 215A. In the configuration illustrated in FIG. 67, parts of the upper surface 12a of the second electrically-conductive layer 12 overlapping the recessed portions 51 of the lead 250 as viewed in Z direction of the drawing are present at a lower level than the position of the first region R1 of the lead 250 which is indicated by broken lines in FIG. 67. That is, the upper surface 12a of the second electrically-conductive layer 12 can include parts which are closer to the lower surface 250b of the lead 250 relative to the position of the first region R1 of the upper surface 250a of the lead 250.

The connection structure of the first electrode and the lead and the connection structure of the second electrode and the lead are described in more detail. Hereinafter, the connection structure of the first electrode and the lead is described as an example, although the same connection structure is also applicable to the second electrode.

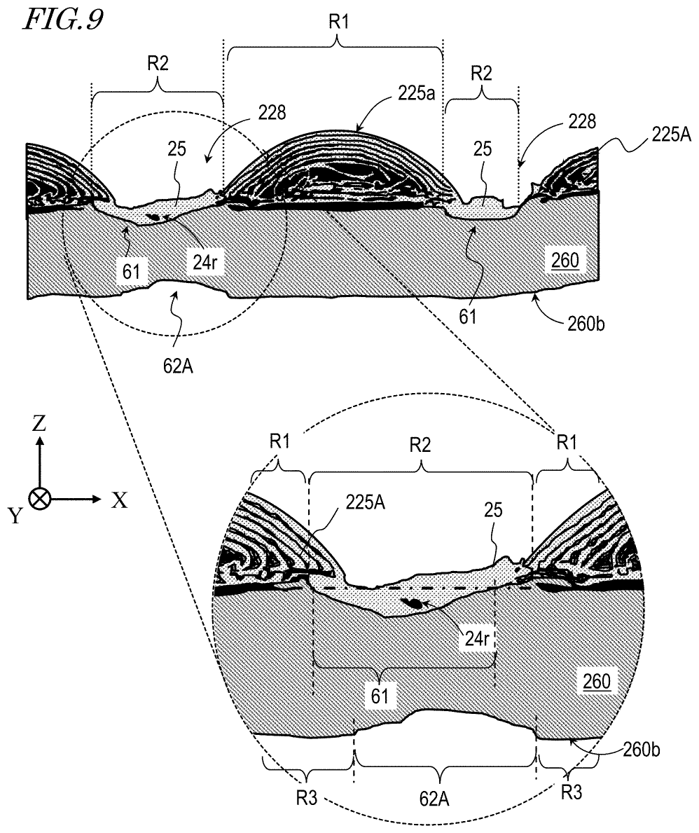

FIG. 9 is a microscopic image regarding a cross section of recessed portions formed in the upper surface of the lead and their surroundings, which is depicted with lines. FIG. 9 is an example of the configuration where 9 composite films in total are connected with a lead.

In the example shown in FIG. 9, the upper surface 260a of the lead 260 has two recessed portions 61 adjacent along X direction of the drawing. A part of the multilayer structure of the composite films 225A located between the two recessed portions 61 of the lead 260 bulges in positive Z direction of the drawing. Meanwhile, in parts of the multilayer structure of the composite films 225A overlapping the recessed portions 61 as viewed in Z direction of the drawing, the total thickness of the multilayer structure is small. As a result, recessed portions 228 (see FIG. 6) are formed in parts of the multilayer structure of the composite films 225A overlapping the recessed portions 61 as viewed in Z direction of the drawing.

As schematically shown in FIG. 9, regions of the multilayer structure of the composite films 225A overlapping the second regions R2 of the upper surface 260a of the lead 260 include bonded portions 25 at which the first electrically-conductive layer 21 and the second electrically-conductive layer 22 of the plurality of composite films 225A are connected to each other. The bonded portions 25 contain the material of the first electrically-conductive layer 21 and the material of the second electrically-conductive layer 22. As viewed in Z direction of the drawing, the bonded portions 25 at least include a part located inside the recessed portions 61. Note that, however, the bonded portions 25 may include a part located outside the recessed portions 61 as viewed in Z direction of the drawing.

In an embodiment of the present disclosure, it is not essential that a plurality of composite films are selectively connected with the lead only at the positions of the recessed portions on the upper surface side of the lead. It suffices that the plurality of composite films are bonded to the lead at least at the positions overlapping the recessed portions on the upper surface side of the lead in the stacking direction of the plurality of composite films. For example, one of the plurality of composite films which is closest to the lead may be connected with the lead at the entirety of the second regions R2.

As schematically shown in FIG. 9, the bonded portions 25 can contain the resin 24r inside. The resin 24r can be a resin originally contained in the first layer 24 of any of the plurality of composite films 225A connected with the lead 260. When the bonded portions 25 involve the resin 24r, the raised portion 28p can be suppressed to a low height. The bonding strength can sometimes be higher when the bonded portions 25 include a metal-resin-metal bond of different types of materials rather than a case where the bonded portions 25 are formed by only a metal-metal bond. Further, the resin 24r tightly adheres, due to its viscosity, to the electrically-conductive layer included in the bonded portions 25, so that separation of the electrically-conductive layer included in the bonded portions 25 can be suppressed and, hence, the bonding reliability of the bonded portions 25 can be improved.

As enlargedly and schematically shown in FIG. 9, the resin 24r can be located in a portion overlapping the recessed portions 61 of the lead 260 as viewed in Z direction of the drawing and can be located deeper than the first region R1 of the upper surface 260a of the lead 260 with respect to Z direction of the drawing. In other words, the resin 24r can be located closer to the lower surface 260b in terms of Z direction of the drawing relative to the first region R1 of the upper surface 260a.

In the configuration illustrated in FIG. 9, the lead 260 further has a recessed portion 62A in the lower surface 260b, in addition to the recessed portions 61 located on the upper surface 260a side. In the example shown in FIG. 9, the recessed portion 62A is present approximately just below one of the recessed portions 61 on the upper surface 260a side. In other words, in these examples, the recessed portion 62A is formed in the lower surface 260b at a position overlapping one of the recessed portions 61 as viewed in Z direction of the drawing. The recessed portion 62A is, for example, a part of the lower surface 260b which is closer to the upper surface 260a side than a flat third region R3. The “flat region” of the lower surface 260b of the lead 260 refers to a region where the distance from the highest part to the lowest part is within 3% of the thickness of the lead. The third region R3 may at least partially overlap the first region R1 of the upper surface 260a as viewed in Z direction of the drawing.

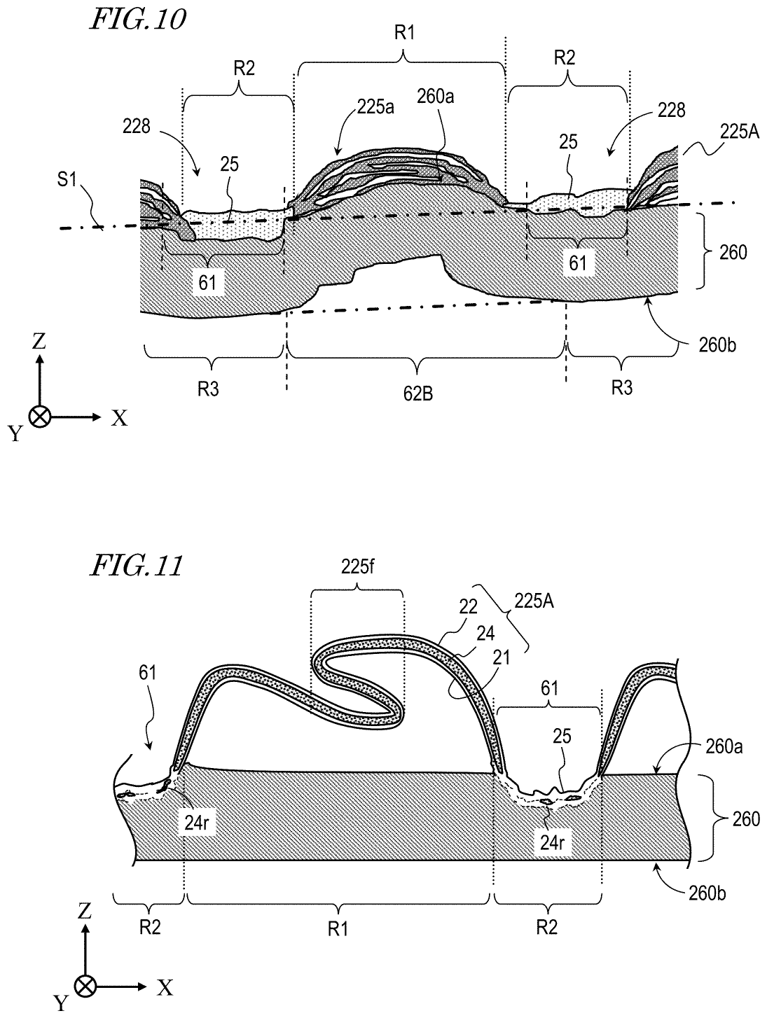

The shape and arrangement of recessed portions formed at the lower surface side of the lead (i.e., a side of the lead which is not in contact with the composite film) are not limited to the example shown in FIG. 9. FIG. 10 is a schematic diagram in which another example of a microscopic image regarding a cross section of the multilayer structure of the composite films and the lead is depicted with lines. In the configuration illustrated in FIG. 10, the lower surface 260b of the lead 260 has a recessed portion 62B. The recessed portion 62B is located between two recessed portions 61 adjacent each other along X direction of the drawing as viewed in Z direction of the drawing. In other words, the recessed portion 62B is located on a side opposite to the first region R1 of the upper surface 260a of the lead 260. The first region R1 may be convexly curved. Although not shown in FIG. 10 because it is an enlarged view, the other first regions of the upper surface 260a of the lead 260 may include a flat region. The flat region can be recognized from a microscopic image of the multilayer structure of the composite films. In FIG. 10, an imaginary plane (datum plane) S1 assumed relative to the flat region is depicted by a broken line. The above-described recessed portions 61 are portions of the upper surface 260a located closer to the lower surface 260b side than the plane S1.

The shape and arrangement of the recessed portions at the lower surface side of the lead are not limited to those illustrated in FIG. 9 and FIG. 10 but can be various shapes and arrangements. The lower surface 260b of the lead 260 may have both a recessed portion 62A at a position overlapping one of the recessed portions 61 on the upper surface 260a side as viewed in Z direction of the drawing and a recessed portion 62B located between two adjacent recessed portions 61.

The recessed portions at the upper surface side of the lead can also have various shapes. The bottom of the recessed portions 61 may partially include a flat region. In the example shown in FIG. 10, one of two recessed portions 61 adjacent each other along X direction of the drawing which is on the left side has a flat portion at the bottom as compared with the recessed portion 61 on the right side. In this specification, the “flatness” of the bottom of the recessed portions 61 means that the distance from the highest part to the lowest part of the surface of the bottom of the recessed portions 61 is within 3% of the thickness of the lead.

FIG. 11 schematically shows an example of the cross-sectional shape of the composite film connected with the lead. In FIG. 11, a part of a cross section of the lead 260 and the composite film 225A taken along a plane perpendicular to the first region R1 of the upper surface 260a of the lead 260 is shown. Note that, herein, for the purpose of avoiding an excessively complex drawing, one of the plurality of composite films 225A connected with the lead 260 which is in the lowermost layer that is closest to the lead 260 is taken out for illustration.

The cross section of a part of the composite film extending between two adjacent recessed portions 61 can have such a shape that the composite film is wound multiple times as shown in FIG. 11. In the configuration illustrated in FIG. 11, the composite film 225A has a mutually-overriding section 225f between two recessed portions 61 adjacent each other in X direction of the drawing. In other words, in the configuration illustrated in FIG. 11, the composite film 225A has a section 225f in which the composite film 225A overlaps itself as viewed in Z direction of the drawing.

In a typical embodiment of the present disclosure, a part of the composite film 225A located between two adjacent recessed portions 61 is distant from a first region R1 of the upper surface 260a of the lead 260 which is interposed between those two recessed portions 61. In other words, a part of the composite film 225A located between the two adjacent recessed portions 61 is not connected with the first region R1. When the composite film 225A includes a mutually-overriding section 225f between two adjacent recessed portions 61, occurrence of a tear in the composite film 225A starting from a portion of the composite film 225A located between the two adjacent recessed portions 61 can be suppressed even if, for example, an external force is applied to the lead 260. That is, the effect that can be achieved in this case is equivalent to increasing the thickness of the composite film 225A. Note that a part of the composite film 225A may be in contact with the first region R1.

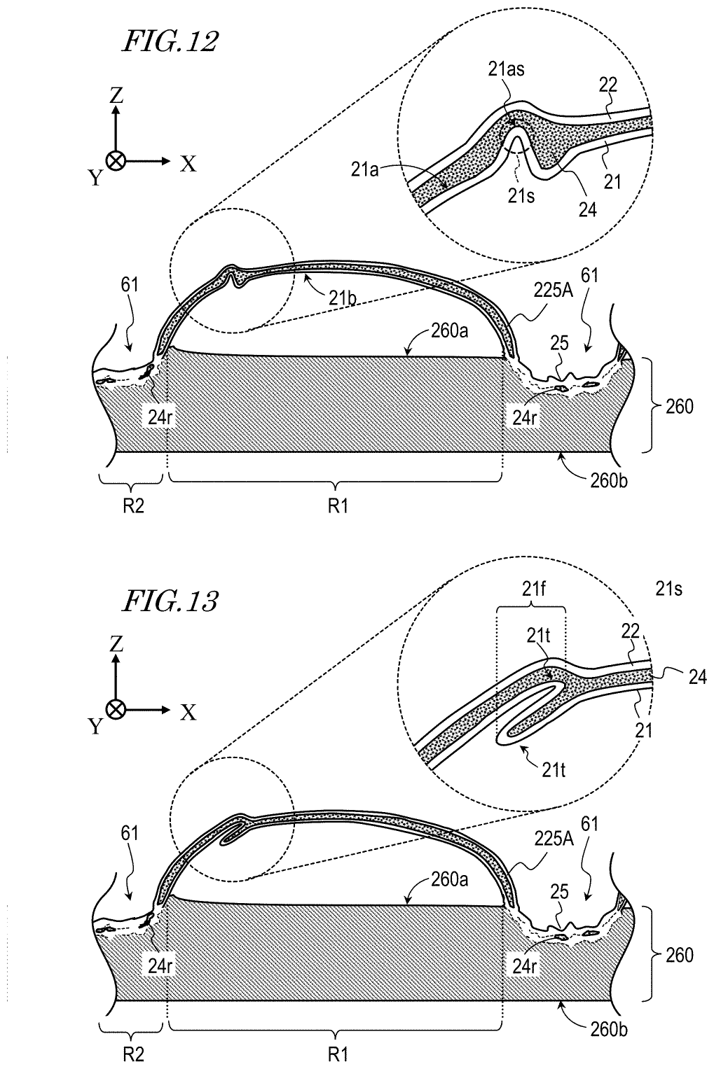

FIG. 12 schematically shows another example of the cross-sectional shape of the composite film connected with the lead. As schematically shown in FIG. 12, either or both of the first electrically-conductive layer 21 and the second electrically-conductive layer 22 of the composite film 225A may have a bent shape as viewed in cross section.

In the configuration illustrated in FIG. 12, the first electrically-conductive layer 21 of the composite film 225A has an arc-shaped portion 21s, which is curved, between two recessed portions 61 adjacent each other in X direction of the drawing. Now, attention is paid to a part 21as of the upper surface 21a of the first electrically-conductive layer 21 which is present at the arc-shaped portion 21s. The part 21as is curved in a direction away from the lead 260 as viewed in cross section. The upper surface 21a of the first electrically-conductive layer 21 is a surface on a side opposite to the lower surface 21b that faces the first region R1 of the lead 260. It can also be said when attention is paid to the first electrically-conductive layer 21 of the composite film 225A that the upper surface 21a is a surface located on a side opposite to the lead 260.

In this specification, “curved” refers to a shape which has a greater curvature than an arc extending between the centers of two adjacent recessed portions 61 as viewed in cross section. Further, in the present disclosure, “arc-shaped” means having a curve shape as viewed in cross section but is not limited to having a hunched shape or drawing an arc of a circle.

FIG. 13 schematically shows still another example of the cross-sectional shape of the composite film connected with the lead. In the configuration illustrated in FIG. 13, the first electrically-conductive layer 21 of the composite film 225A includes two arc-shaped portions 21t, each of which is curved, between two recessed portions 61 adjacent each other in X direction of the drawing. In the example shown in FIG. 13, the first electrically-conductive layer 21 includes an arc-shaped portion 21t in which it turns back from +X direction to −X direction of the drawing and an arc-shaped portion 21t in which it turns back oppositely from −X direction to +X direction of the drawing. That is, in this example, the first electrically-conductive layer 21 includes, between two recessed portions 61 adjacent each other in X direction of the drawing, a turned-back section 21f in which the first electrically-conductive layer 21 is curved so as to mutually override such that the first electrically-conductive layer 21 mutually overlaps as viewed in Z direction of the drawing.

In the example shown in FIG. 13, attention is now paid to the section in which the first electrically-conductive layer 21 mutually override. The effective thickness of the first layer 24 along Z direction of the drawing is the total thickness of the two portions overlapping as viewed in Z direction of the drawing. When the first electrically-conductive layer 21 includes between two recessed portions 61 a section in which the first electrically-conductive layer 21 mutually overrides, the effect of suppressing occurrence of a tear in the composite film 225A starting from a position between these two recessed portions 61 even in the presence of shear stress on the composite film 225A can be expected likewise as in a case where the composite film 225A includes mutually-overriding portions (see FIG. 11).

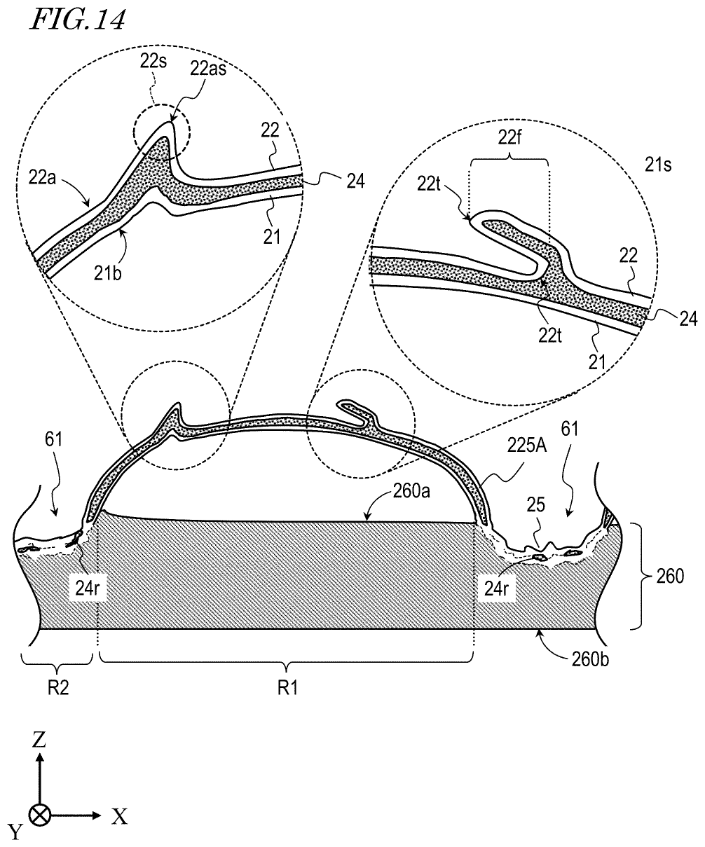

The second electrically-conductive layer 22 may also have a bent shape as viewed in cross section as does the first electrically-conductive layer 21. FIG. 14 schematically shows still another example of the cross-sectional shape of the composite film connected with the lead. In the example shown in FIG. 14, the second electrically-conductive layer 22 of the composite film 225A has an arc-shaped portion 22s, which is curved, between two recessed portions 61 adjacent each other in X direction of the drawing.

In the configuration illustrated in FIG. 14, the arc-shaped portion 22s of the second electrically-conductive layer 22 is curved in a direction away from the lead 260. A portion 22as of the upper surface 22a of the second electrically-conductive layer 22 which is located at the arc-shaped portion 22s has a shape conforming to the shape of the second electrically-conductive layer 22. That is, the portion 22as has a shape which is curved in a direction away from the lead 260 as viewed in cross section. Herein, the upper surface 22a is a surface located on a side opposite to the lower surface 21b of the first electrically-conductive layer 21 with respect to the first layer 24 of the composite film 225A.

In the configuration illustrated in FIG. 14, the second electrically-conductive layer 22 further includes between two recessed portions 61 a turned-back section 22f in which the second electrically-conductive layer 22 is curved so as to mutually override such that the second electrically-conductive layer 22 mutually overlaps as viewed in Z direction of the drawing. The turned-back section 22f includes an arc-shaped portion 22t in which the second electrically-conductive layer 22 turns back from −X direction to +X direction of the drawing and an arc-shaped portion 22t in which the second electrically-conductive layer 22 turns back oppositely from +X direction to −X direction of the drawing.

Between two recessed portions of the lead, a complicated structure such as shown in, for example, FIG. 11 is employed between the closest two of the plurality of stacked composite films, whereby mechanical engagement can be caused between the two composite films. When the cross-sectional shape is arranged so as to cause mutual engagement between the plurality of composite films, an integral structure can be formed in the plurality of composite films between two recessed portions of lead. Thereby, separation of the composite films from the lead and/or occurrence of a tear can be suppressed. Forming a cross-sectional shape which can cause mutual engagement among a plurality of composite films can contribute to improvement in the reliability of the power storage device.

FIG. 15 shows a connecting portion between the composite film in the lowermost layer of the multilayer structure of the composite films and the lead, which is taken out and enlarged for illustration. As schematically shown in FIG. 15, when attention is paid to a part of the composite film 225A which is connected with the recessed portions 61 of the lead 260, a bonded portion 25 is formed in the composite film 225A.

In the bonded portion 25, the first electrically-conductive layer 21 and the second electrically-conductive layer 22 are connected with each other, whereby a channel of electrical conduction is formed between these layers. When the first electrically-conductive layer 21 and the second electrically-conductive layer 22 contain a common material, there is a probability that a clear border cannot be found between the first electrically-conductive layer 21 and the second electrically-conductive layer 22. Note that, however, as shown in FIG. 15, when a resin 24r is present inside the bonded portion 25, the position of the border between the first electrically-conductive layer 21 and the second electrically-conductive layer 22 can be approximately estimated from the position of the resin 24r in the depth direction (herein, Z direction of the drawing).

When the first electrically-conductive layer 21 and the lead contain a common material, there is a probability that a clear border cannot be found between these components. However, for example, when the presence of the resin 24r is found at a position deeper than the first region R1 of the upper surface of the lead, it can be concluded that the upper surface of the lead has a recessed portion. Alternatively, when the upper surface of the second electrically-conductive layer includes a portion which is closer to the lower surface side of the lead relative to the position of the first region R1 of the upper surface of the lead at a position overlapping the recessed portion of the lead as viewed in Z direction of the drawing likewise as in the example previously described with reference to FIG. 8, it can be said that the upper surface of the lead has a recessed portion.

The bonded portion 25 can have a smaller thickness than the other part of the composite film 225A (for example, a part overlapping the second material layer 222 in the stacking direction). In that case, when the composite film 225A is taken out as a single element, it can be said that the composite film 225A has a recessed portion 63, which is recessed toward the lead 260, at the third surface 225a that is on a side opposite to the lead 260 (see FIG. 15). The recessed portion 63 of the composite film 225A is present at a position corresponding to the recessed portions 61 of the upper surface 260a of the lead 260 (for example, just above the recessed portions 61).

In FIG. 15, a double-headed arrow H1 represents the thickness of a part of the composite film 225A overlapping the recessed portion 61 of the lead 260 as viewed in Z direction of the drawing. Herein, the length represented by the double-headed arrow H1 is identical with the distance from the deepest position 61z of the weld interface between the composite film 225A and the lead 260 to a position where line z1 extending along Z direction of the drawing intersects with the upper surface 22a of the second electrically-conductive layer 22. Note that the upper surface 22a of the second electrically-conductive layer 22 refers to a surface of the second electrically-conductive layer 22 which is on a side opposite to the lead 260 and forms the third surface 225a of the composite film 225A.

As shown in FIG. 11 to FIG. 14, the composite film 225A connected with the lead 260 can have a shape swollen in a direction away from the lead 260 between two recessed portions 61 of the lead 260. In FIG. 15, a double-headed arrow H2 represents the distance in Z direction of the drawing from a part of the upper surface 22a of the second electrically-conductive layer 22 which overlaps the first region R1 of the lead 260 as viewed in Z direction of the drawing and which is most distant from the lead 260 to the lead 260. Comparing this distance H2 with the above-described distance H1, the relationship of H1<H2 holds in an embodiment of the present disclosure.

As previously described, in FIG. 9 to FIG. 15, some examples of the connection structure with the lead have been described based on the second electrode as an example, although the same connection structure is also applicable to the first electrode. An example of the connection structure of the first electrode is shown in a schematic diagram based on a microscopic image of Examples which will be described later (e.g., FIG. 60).

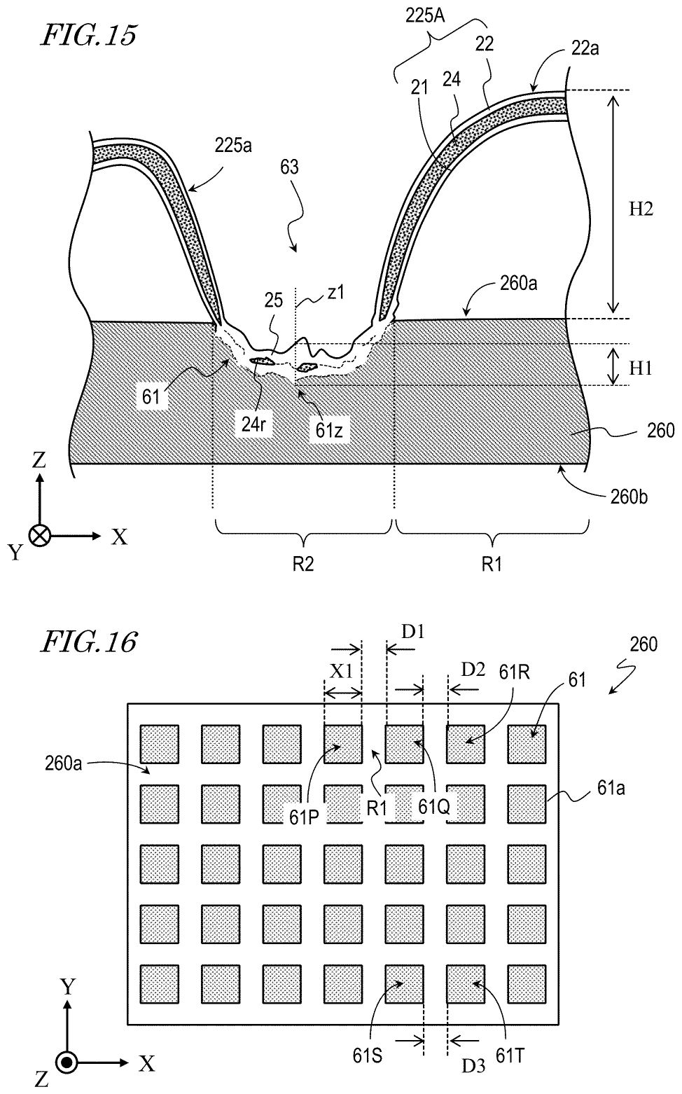

FIG. 16 schematically shows an example of the shape and arrangement of the recessed portions formed in the upper surface of the lead. FIG. 16 corresponds to a top view of the lead 260 separated from the second electrode group of the cell 200A shown in FIG. 1, where the third portions 240J are viewed in the normal direction of the upper surface 260a of the lead 260.

In the configuration illustrated in FIG. 16, the upper surface 260a of the lead 260 has 35 recessed portions 61 in total, which are two-dimensionally arranged along X direction and Y direction of the drawing. In this example, the plurality of recessed portions 61 are provided in the upper surface 260a of the lead 260 such that the centers of the respective recessed portions 61 approximately reside at the lattice points of a rectangular lattice. The arrangement of the plurality of recessed portions 61 is, as a matter of course, not limited to this example. The plurality of recessed portions 61 may be two-dimensionally arranged along the first axis and the second axis that forms an acute or obtuse angle with respect to the first axis in a plane parallel to the XY plane of the drawing.

The lead and the composite film are connected with each other at a plurality of locations which are two-dimensionally arranged, whereby the binding between these components can be further strengthened. Even if an external force is applied to the lead, the stress is dispersed to a plurality of locations so that falling off of the lead from the composite film can be avoided. That is, the effect of improving the reliability of the power storage device is achieved.

Each of the recessed portions 61 has an opening 61a in the upper surface 260a of the lead 260. In the configuration illustrated in FIG. 16, the openings 61a of the recessed portions 61 have a rectangular shape. As will be described later, the shape of the openings 61a of the recessed portions 61 as viewed in Z direction of the drawing is not limited to rectangular shapes.

Now, attention is paid to two openings adjacent each other along X direction or Y direction of the drawing, for example, in FIG. 16, the openings 61a of a recessed portion 61P and a recessed portion 61Q, which are two of the plurality of recessed portions 61 adjacent each other along X direction of the drawing. These two openings are arranged side by side along X direction of the drawing with the first region R1 of the upper surface 260a of the lead 260 interposed therebetween.

In this example, the width X1 in X direction of the opening 61a of the recessed portion 61P that is one of these two recessed portions is greater than the distance D1 from the opening 61a of the recessed portion 61P to the opening 61a of the recessed portion 61Q. Herein, the width X1 of the opening 61a means the maximum of the width in a certain direction (herein, X direction of the drawing) of the opening 61a, and the distance D1 between the openings 61a means the minimum of the distance in the certain direction between the openings 61a.

By increasing, for example, the width X1 in X direction of the opening 61a of the recessed portion 61P, the bond interface between the composite film 225A and the lead 260 can be enlarged. By enlarging the bond interface between the composite film 225A and the lead 260, the effect of reducing the connection resistance between the composite film 225A and the lead 260 is achieved. Also, in each of the recessed portions 61, the effect of improving the bonding strength between the composite film 225A and the lead 260 is expected. From the viewpoint of achieving low connection resistance and high bonding strength, it is advantageous that the width X1 is greater than the distance D1 between the openings 61a.

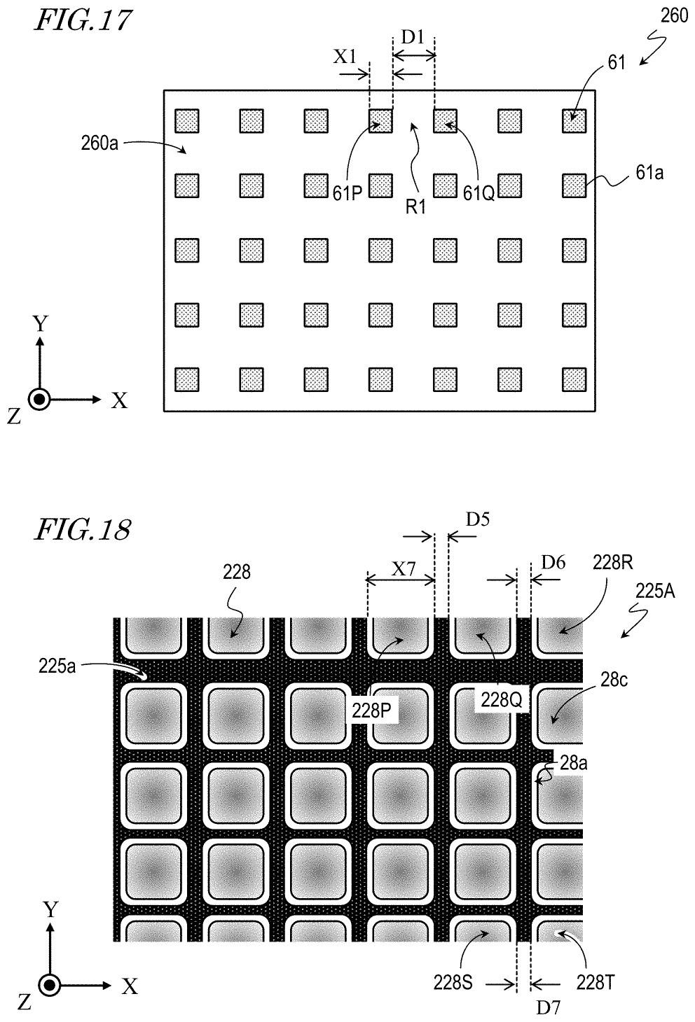

On the contrary, as shown in FIG. 17, the width X1 in X direction of the opening 61a of the recessed portion 61P may be smaller than the distance D1 from the opening 61a of the recessed portion 61P to the opening 61a of the recessed portion 61Q. The shape and arrangement of the recessed portions 61 which make the distance D1 between the openings 61a greater than the width X1 of the openings 61a facilitate connection of a larger number of composite films 225A with the lead 260. That is, the shape and arrangement of the recessed portions 61 which make X1<D1 hold are advantageous in a configuration which is capable of connecting a larger number of composite films 225A with the lead 260. Alternatively, the width X1 of the opening 61a of the recessed portion 61P may be equal to the distance D1 between the openings 61a. Thus, the shape of the respective recessed portions 61 and the arrangement of the recessed portions 61 are not limited to a particular combination.

It is not essential for an embodiment of the present disclosure that the width (e.g., the width in X direction of the drawing) of the opening 61a is equal among the plurality of recessed portions 61. Also, it is not essential that the distance in X direction of the drawing between the openings 61a of two adjacent recessed portions 61 is equal among all of the plurality of recessed portions 61.

In the example shown in FIG. 16, the plurality of recessed portions 61 include, in addition to the aforementioned set of the recessed portion 61P and the recessed portion 61Q, a recessed portion 61R which adjoins the recessed portion 61Q on a side opposite to the recessed portion 61P along X direction of the drawing. Where D2 is the distance along X direction of the drawing from the opening 61a of the recessed portion 61Q to the opening 61a of the recessed portion 61R, the distance D2 may be different from the distance D1 from the opening 61a of the recessed portion 61P to the opening 61a of the recessed portion 61Q.

As described above, the recessed portions 61 may be uniformly or non-uniformly distributed in the binding portion (third portion). For example, the intervals between the recessed portions 61 may be randomly varied. Alternatively, for example, in the third portion, the arrangement pitch of the recessed portions 61 may be varied stepwise. By making the distribution of the recessed portions 61 nonuniform, the recessed portions 61 can have a density distribution. Accordingly, for example, in the third portion, the bonding strength with the composite film can have a distribution. Also, based on the arrangement of the recessed portions 61, the flowage of the resin of the composite film bonded to the lead 260 can be controlled. Further, by varying the intervals of the recessed portions 61, the raised portions formed in the composite film (the raised portion 28p in FIG. 8) can have a distribution in height.

In the example shown in FIG. 16, the plurality of recessed portions 61 further includes a set of a recessed portion 61S and a recessed portion 61T which adjoin each other along X direction of the drawing. Where D3 is the distance along X direction of the drawing from the opening 61a of the recessed portion 61S to the opening 61a of the recessed portion 61T, the distance D3 may be different from at least either of the above-described distance D1 and distance D2.

In FIG. 16 and FIG. 17, the openings 61a are depicted as a figure which is generally similar to a square. However, this is merely for convenience of description. The shape of the openings 61a as viewed in the stacking direction of the plurality of composite films (herein, Z direction of the drawing) can be a quadrilateral with contortions or a quadrilateral with a partially-curved side. A quadrilateral “with contortions” means that some or all of the vertices of the quadrilateral are displaced from the vertices of an ideal shape (rectangle). The distance between the vertices of the quadrilateral with contortions and the vertices of the ideal rectangle may be, for example, within 30% of the length of the sides that form the rectangle. Alternatively, the distance between the vertices of the quadrilateral with contortions and the vertices of the ideal rectangle may be, for example, not more than 300 μm. Herein, the shape of the openings 61a can be determined from the shape of the boundary between the first region R1 of the upper surface 260a of the lead 260 and a part of the upper surface 260a which is at a lower level than the first region R1 in the stacking direction of the composite films.

In an embodiment of the present disclosure, it is not essential that the plurality of recessed portions 61 formed in the upper surface 260a of the lead 260 are strictly identical in size (for example, the area as viewed in Z direction of the drawing). For example, the recessed portion 61P and the recessed portion 61Q which adjoin each other may be different in the width in X direction of the drawing of the opening 61a or the width along Y direction of the drawing of the opening 61a. In other words, the third portion 240J may include a plurality of recessed portions 61 which are different in the width along X direction or Y direction of the drawing of the openings 61a.

Also, it is not essential that these dimensions are strictly identical among the plurality of recessed portions 228 formed in the multilayer structure of the composite films 225A. The plurality of recessed portions 228 may include recessed portions 228 which are different in the width along X direction or Y direction of the drawing of the openings 28a.

FIG. 18 shows an example of a plurality of recessed portions which can be formed in the multilayer structure of the composite films. In the example shown in FIG. 18, the multilayer structure of the composite films 225A has a plurality of recessed portions 228 two-dimensionally arranged along X direction and Y direction of the drawing. Each of the plurality of recessed portions 228 has a shape recessed toward the lead 260. In this example, each of the plurality of recessed portions 228 has a shape which includes four inner wall surfaces 28c. The plurality of recessed portions 228 are provided in the third surface 225a of the composite film 225A at positions corresponding to the plurality of recessed portions 61 of the lead 260 (e.g., just above the recessed portions 61).

In the example shown in FIG. 18, the plurality of recessed portions 228 include a recessed portion 228P and a recessed portion 228Q which adjoin each other along X direction of the drawing. In this example, the width X7 in X direction of the opening 28a of the recessed portion 228P that is one of these recessed portions is greater than the distance D5 from the opening 28a of the recessed portion 228P to the opening 28a of the recessed portion 228Q. Herein, the width X7 of the openings 28a means the maximum of the width in a certain direction (herein, X direction of the drawing) of the opening 28a, and the distance D5 between the openings 28a means the minimum of the distance in the certain direction between the openings 28a.

When the width X7 of the opening 28a of the recessed portion 228P is large, it means that the bond interface between the composite film 225A and the lead 260 is relatively large. That is, when the shape and arrangement of the recessed portions 228 satisfy X7>D5, the effect of reducing the connection resistance or improving the bonding strength can be expected.

FIG. 19 schematically shows another example of a plurality of recessed portions which can be formed in the multilayer structure of the composite films. The relationship of X7<D5, which is contrary to the example shown in FIG. 18, may hold as shown in FIG. 19. The shape and arrangement of the recessed portions 228 which make the relationship of X7<D5 hold are advantageous in a configuration which is capable of connecting a larger number of composite films 225A with the lead 260.

In the configuration illustrated in FIG. 18, the plurality of recessed portions 228 further include a recessed portion 228R which adjoins the recessed portion 228Q on a side opposite to the recessed portion 228P along X direction of the drawing. Where D6 is the distance along X direction of the drawing from the opening 28a of the recessed portion 228Q to the opening 28a of the recessed portion 228R, the distance D6 may be different from the distance D5 from the opening 28a of the recessed portion 228P to the opening 28a of the recessed portion 228Q.

In the example shown in FIG. 18, the plurality of recessed portions 228 further includes a set of a recessed portion 228S and a recessed portion 228T which adjoin each other along X direction of the drawing. Where D7 is the distance along X direction of the drawing from the opening 28a of the recessed portion 228S to the opening 28a of the recessed portion 228T, the distance D7 may be different from at least either of the above-described distance D5 and distance D6.

Thus, the relationship between the width of the recessed portions 61 formed in the upper surface 260a of the lead 260 and the distance between two recessed portions 61 may apply to the relationship between the width of the recessed portions 228 formed in the third surface 225a of the composite film 225A and the distance between two recessed portions 228. It is not essential for an embodiment of the present disclosure that the width (for example, the width in X direction of the drawing) of the opening 28a is equal among the plurality of recessed portions 228. Also, it is not essential that the distance in X direction of the drawing between the openings 28a of two adjacent recessed portions 228 is equal among all of the plurality of recessed portions 228. As for the distance between two recessed portions 228, the distance between the centers of two recessed portions 228 may be adopted instead of the distance between the openings 28a. Note that, in FIG. 18 and FIG. 19, the openings 28a are depicted as a figure which is generally similar to a square. However, this is merely for convenience of description. The shape of the openings 28a as viewed in the stacking direction of the plurality of composite films (herein, Z direction of the drawing) can be a contorted quadrilateral or a quadrilateral with a partially-curved side.

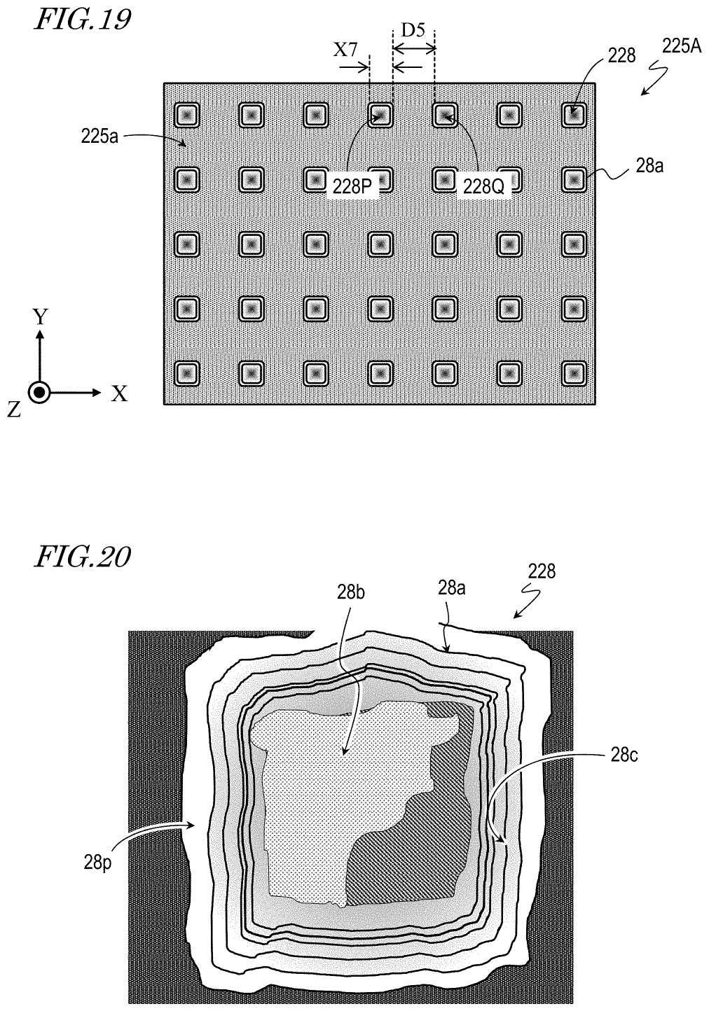

FIG. 20 enlargedly shows one of the plurality of recessed portions which can be formed in the multilayer structure of the composite films. In the example shown in FIG. 20, a raised portion 28p provided around a rectangular opening 28a is a structure realized by bulging the third surface 225a of the composite film 225A. In the example shown in FIG. 20, the bottom surface 28b of the recessed portion 228 has a rectangular shape. As a matter of course, the shape of the recessed portion 228 itself formed in the multilayer structure of the composite films 225A is also not limited to the shape such as shown in FIG. 20. The shape of the bottom surface 28b and the shape of the opening 28a of the recessed portion 228 are not limited to rectangular shapes.

FIG. 21 schematically shows still another example of the shape and arrangement of the recessed portions formed in the upper surface of the lead. It can also be said that FIG. 21 is an example where a plurality of recessed portions 61 each having a rectangular opening 61a are relatively dispersedly arranged. In the configuration illustrated in FIG. 21, the centers of the respective recessed portions 61 reside at the lattice points of a triangular lattice.

In the example shown in FIG. 21, the plurality of recessed portions 61 are two-dimensionally arranged along X direction of the drawing and a direction different from both of X direction and Y direction. In the example shown in FIG. 21, it can be said that the opening 61a of each of the recessed portions 61 has a shape whose width varies along X direction and Y direction of the drawing.

In this example, the plurality of recessed portions 61 are two-dimensionally arranged along a direction which forms an angle of +45° with respect to X direction of the drawing (hereinafter, simply referred to as “+45° direction”) and a direction which forms an angle of −45° with respect to X direction of the drawing (hereinafter, simply referred to as “−45° direction”). Now, attention is paid to two recessed portions 61 adjacent each other in −45° direction. Between the width S1 in −45° direction of the opening 61a of one of these two recessed portions and the distance E1 between the openings 61a of the two recessed portions, the relationship of S1<E1 holds. The shape and arrangement of the recessed portions 61 which make the relationship of S1>E1 hold may be employed likewise as in the example described with reference to FIG. 16.

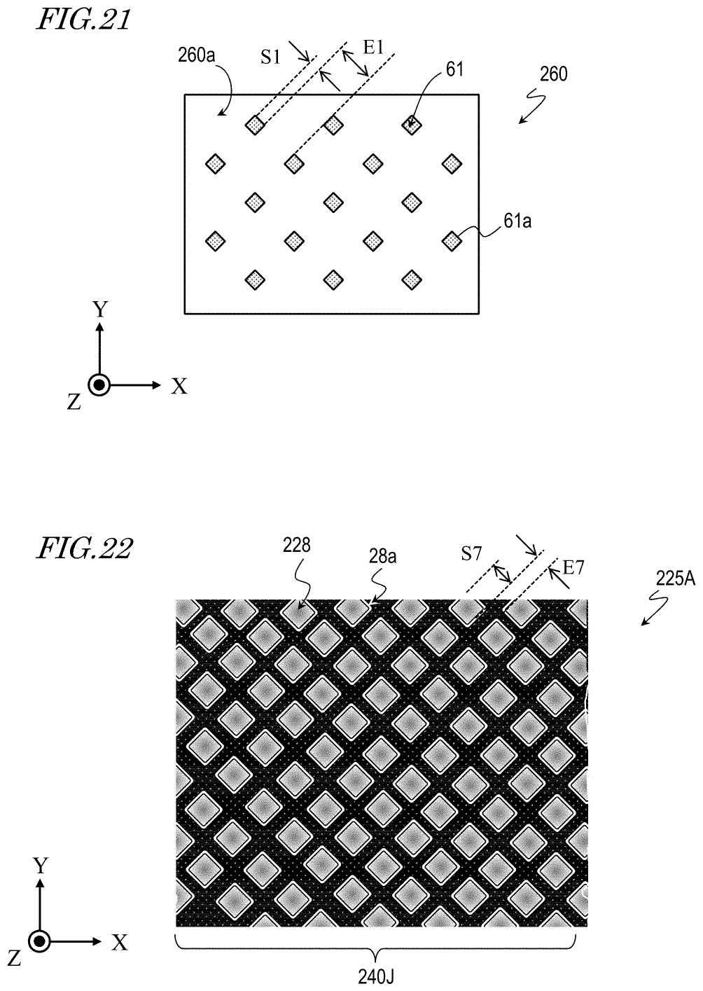

FIG. 22 shows an example of the shape of a plurality of recessed portions which can be formed in a composite film connected with a lead which has the recessed portions 61 shown in FIG. 21. FIG. 22 corresponds to a top view of the multilayer structure of the composite films 225A on the lead 260 as viewed from the third surface 225a side of the composite film 225A in the uppermost layer.

FIG. 22 is an example where two composite films 225A are connected with the lead 260. In either example, a plurality of recessed portions 228, each having a rectangular opening 28a, are formed in the third surface 225a of the composite film 225A in the uppermost layer.

In the example shown in FIG. 22, the plurality of recessed portions 228 are two-dimensionally arranged along +45° direction and −45° direction. Now, attention is paid to two recessed portions 228 adjacent each other in −45° direction. In this example, between the width S7 in −45° direction of the opening 28a of one of these two recessed portions and the distance E7 in −45° direction between the openings 28a of the two recessed portions, the relationship of S7>E7 holds. On the contrary, the relationship of S7<E7 may hold.

Herein, a collection of recessed portions 228 as a whole is arranged in a rectangular region, whereby a single third portion 240J is formed. Each of the third portions 240J includes a plurality of recessed portions 228 in, for example, an oblong square region of 3 mm×4 mm. Note that, however, the shape of each of the third portions 240J is not limited to rectangular shapes. For example, a single third portion 240J may be formed by arranging a collection of recessed portions 228 as a whole in a circular region. In other words, the shape of each of the third portions 240J may be a circular shape or the like.

FIG. 23 enlargedly shows one of the plurality of recessed portions shown in FIG. 22. In this example, the inner wall surfaces 28c of the recessed portion 228 have a plurality of steps. Thus, it is not essential that each of the inner wall surfaces 28c that define the shape of the recessed portion 228 is a flat surface. The inner wall surfaces and/or bottom surface that define the shape of the recessed portion 228 may have such a shape that has steps or the like.

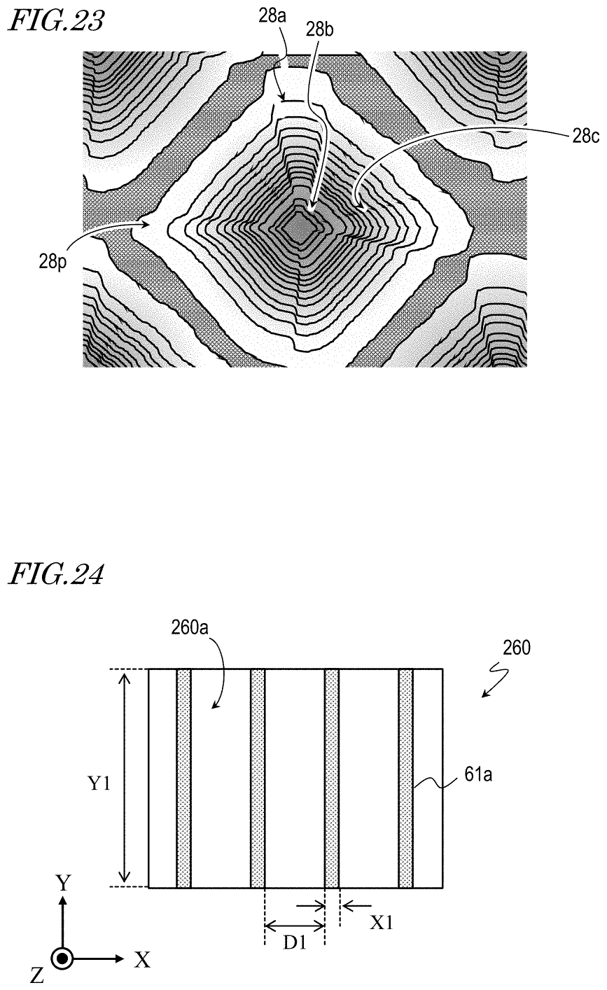

FIG. 24 schematically shows still another example of the shape and arrangement of the recessed portions formed in the upper surface of the lead. FIG. 25 schematically shows a cross section of a part of the structure shown in FIG. 24. In the example shown in FIG. 24, the recessed portions 61 has a stripe shape elongated in Y direction rather than X direction of the drawing in plan view.

In the example shown in FIG. 24, the width X1 in X direction of the openings 61a of the recessed portions 61 is smaller than the width Y1 in Y direction of the openings 61a. When the bonded portions 25 are in the form of stripes, the bond between the lead and the composite film is strong as compared with a case where the bonded portions 25 are in the form of dots. Note that, in this example, as schematically shown in FIG. 24 and FIG. 25, between the width X1 in X direction of the openings 61a of the recessed portions 61 and the distance D1 between the openings 61a of two recessed portions 61 adjacent each other in X direction of the drawing, the relationship of D1>X1 holds. On the contrary, between the width X1 of the openings 61a and the distance D1 between the openings 61a, the relationship of D1<X1 may hold.

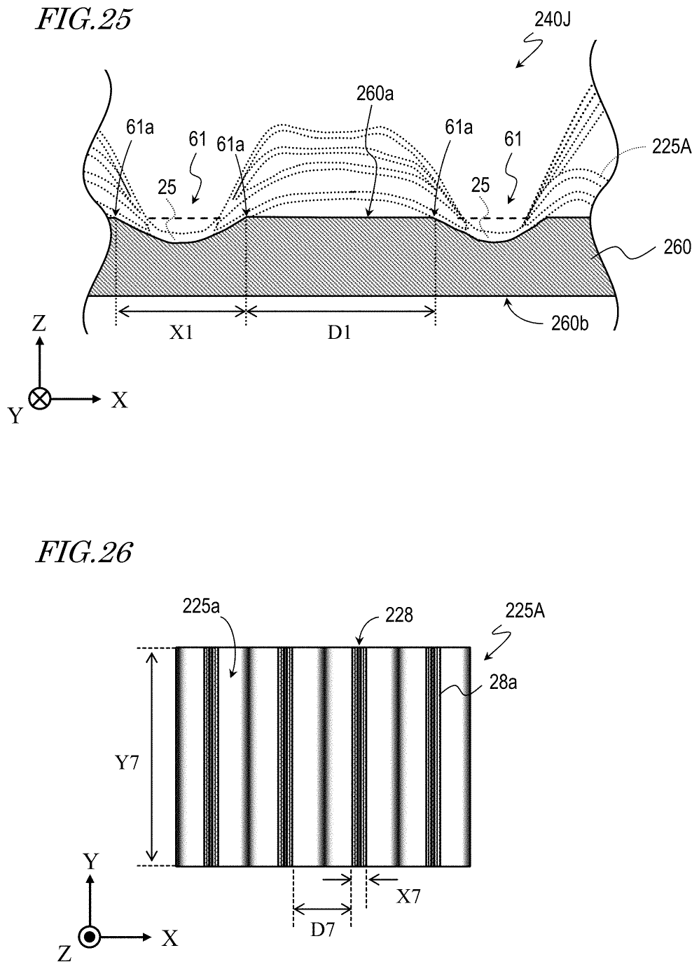

FIG. 26 schematically shows an example of the shape of a plurality of recessed portions which can be formed in a composite film connected with a lead which has the recessed portions shown in FIG. 24 in the upper surface. In this example, each of the plurality of recessed portions 228 formed in the multilayer structure of the composite films 225A has a stripe shape elongated in Y direction rather than X direction of the drawing in plan view. The width X7 in X direction of the openings 28a of the recessed portions 228 may be smaller than the width Y7 in Y direction of the openings 28a. Further, in this example, the distance D7 between the openings 28a of two recessed portions 228 adjacent each other in X direction of the drawing is greater than the width X7 in X direction of the openings 28a. On the contrary, the relationship of D7<X7 may hold.

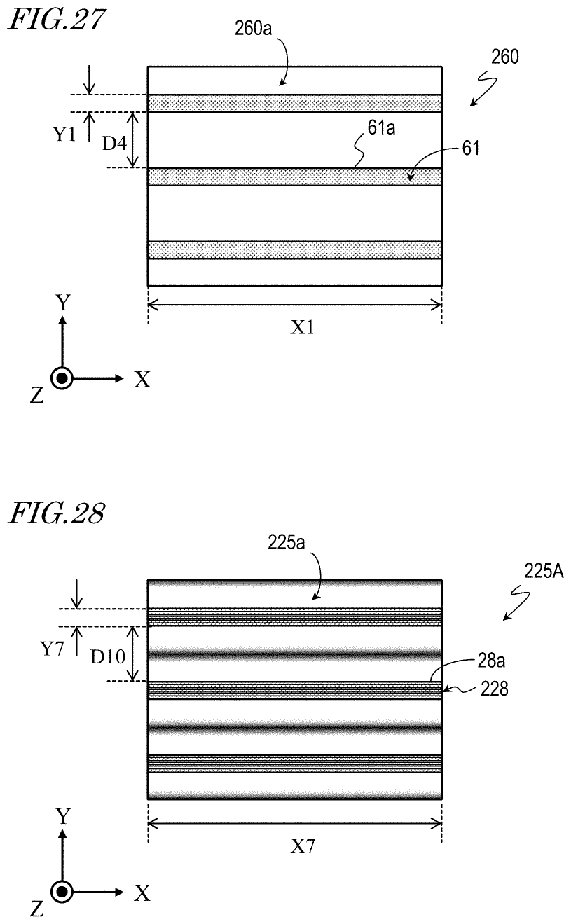

FIG. 27 schematically shows still another example of the shape and arrangement of the recessed portions formed in the upper surface of the lead. As illustrated in FIG. 27, the recessed portions 61 may have a shape elongated in X direction rather than Y direction of the drawing in plan view. In the example shown in FIG. 27, the relationship of X1>Y1 holds. Further, in FIG. 27, where D4 is the distance along Y direction between the openings 28a of two recessed portions 228 adjacent each other in Y direction of the drawing, the relationship of D4>Y1 holds between the distance D4 and the width Y1 in Y direction of the openings 61a of the recessed portions 61. On the contrary, the relationship of D4<Y1 may hold.

FIG. 28 schematically shows an example of the shape of a plurality of recessed portions which can be formed in a composite film connected with a lead which has the recessed portions shown in FIG. 27 in the upper surface. In the example shown in FIG. 28, the recessed portions 228 have a shape elongated in X direction rather than Y direction of the drawing in plan view. In the example shown in FIG. 28, between the width X7 in X direction of the openings 28a of the recessed portions 228 and the width Y7 in Y direction, the relationship of X7>Y7 holds. Further, in this example, between the distance D10 along Y direction between the openings 28a of two adjacent recessed portions 228 and the width Y7 in Y direction of the openings 28a, the relationship of D10>Y7 holds. On the contrary, the relationship of D10<Y7 may hold.

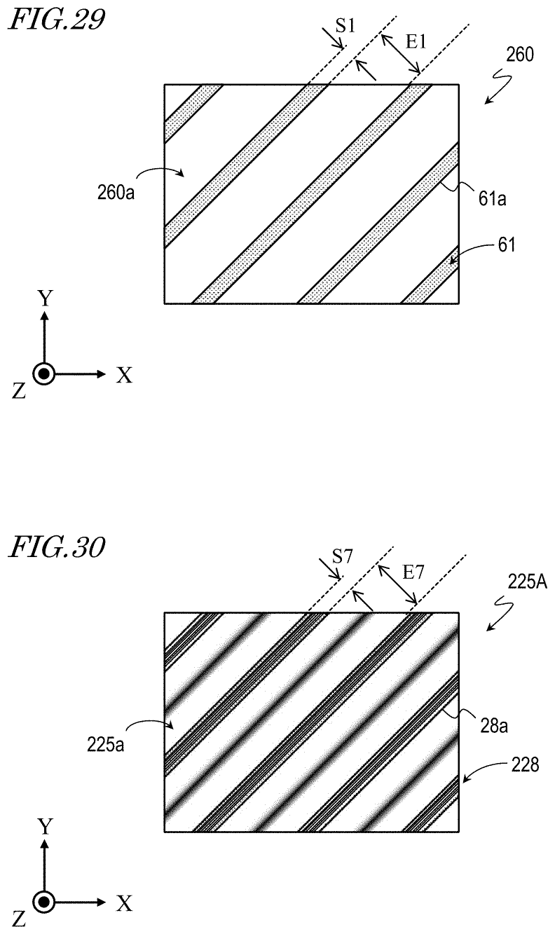

FIG. 29 schematically shows still another example of the shape and arrangement of the recessed portions formed in the upper surface of the lead. In an embodiment of the present disclosure, it is not essential that the direction of elongation of the recessed portions 61 is, for example, parallel or perpendicular to one side of the tab region. As illustrated in FIG. 29, the direction of elongation of the recessed portions 61 may be an oblique direction with respect to one side of the tab region. When the direction of elongation of the bonded portions 25 is oblique with respect to the direction in which the composite film is likely to tear, the effect of suppressing occurrence of a tear in the composite film is expected.

In this example, between the width S1 in −45° direction of the opening 61a of one of two recessed portions 61 adjacent each other in −45° direction and the distance E1 between the openings 61a of the two recessed portions, the relationship of S1<E1 holds likewise as in the example described with reference to FIG. 21. On the contrary, the relationship of S1>E1 may hold.

FIG. 30 schematically shows an example of the shape of a plurality of recessed portions which can be formed in a composite film connected with a lead which has the recessed portions shown in FIG. 29 in the upper surface. In the example shown in FIG. 30, each of the recessed portions 228 extends, for example, in a direction oblique to one side of the tab region.

In the example shown in FIG. 30, between the width S7 in −45° direction of the opening 28a of one of two recessed portions 228 adjacent each other in −45° direction and the distance E7 in −45° direction between the openings 28a of the two recessed portions, the relationship of S7<E7 holds, which is contrary to the example shown in FIG. 22. As a matter of course, the relationship of S7>E7 may hold.

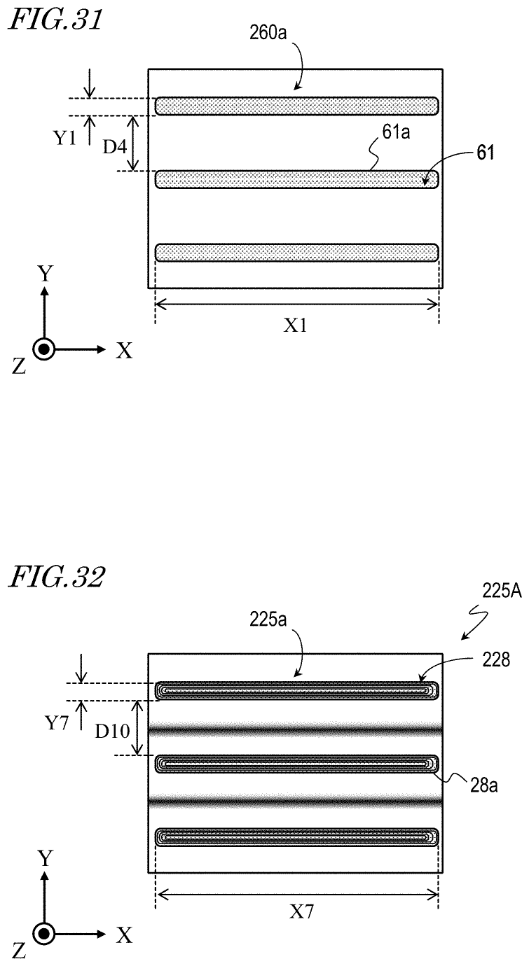

FIG. 31 schematically shows still another example of the shape and arrangement of the recessed portions formed in the upper surface of the lead. As illustrated in FIG. 24, FIG. 27 and FIG. 29, when the openings 61a of the recessed portions 61 have an oblong shape such as stripe, the oblong shape of the openings 61a may have rounded corners as in the example shown in FIG. 31. In the example shown in FIG. 31, the relationship of X1>Y1 also holds likewise as in the example shown in FIG. 27. Comparing the distance D4 between the openings 28a of two recessed portions 228 adjacent each other in Y direction of the drawing and the width Y1 in Y direction of the openings 61a of the recessed portions 61, the relationship of D4>Y1 holds. On the contrary, the relationship of D4<Y1 may hold.

FIG. 32 schematically shows an example of the shape of a plurality of recessed portions which can be formed in a composite film connected with a lead which has the recessed portions shown in FIG. 31 in the upper surface. As schematically shown in FIG. 32, the oblong shape of the openings 28a of the recessed portions 228 formed in the composite film may have rounded corners likewise as the shape of the openings 61a of the recessed portions 61 formed in the upper surface of the lead. Herein, the relationship of X7>Y7 and the relationship of D10>Y7 hold likewise as in the example shown in FIG. 28. The relationship of D10<Y7 may hold.

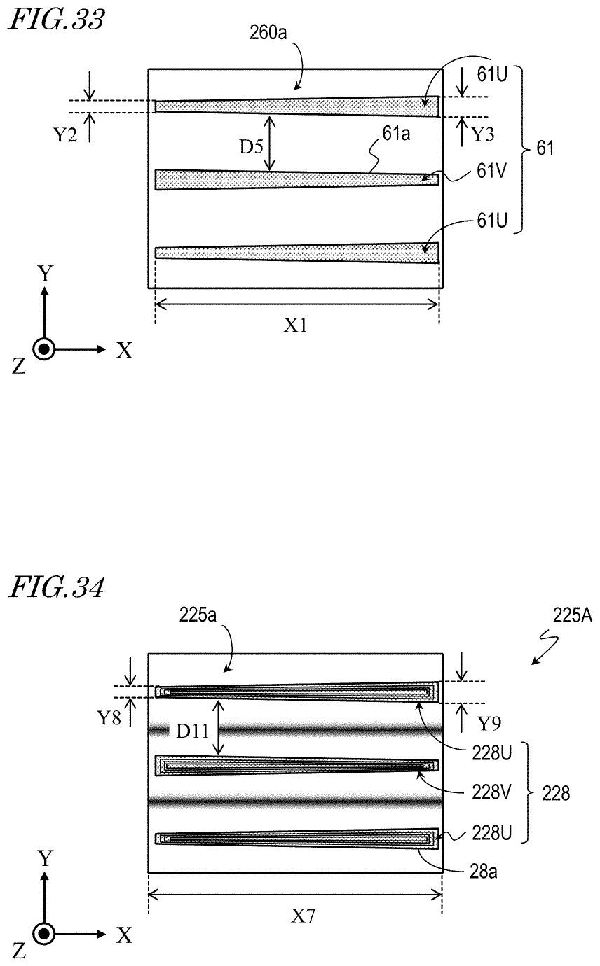

The width of the oblong shape of the openings 61a and/or the width of the oblong shape of the openings 28a may be constant, or may be varied, along the direction of elongation of the oblong shape. FIG. 33 schematically shows still another example of the shape and arrangement of the recessed portions formed in the upper surface of the lead. In the configuration illustrated in FIG. 33, the plurality of recessed portions 61 include recessed portions 61U and a recessed portion 61V which are arranged along Y direction of the drawing.

As schematically shown in FIG. 33, the openings 61a of the recessed portions 61U have such a shape that the width in Y direction gradually increases along X direction of the drawing. That is, the width in Y direction of the drawing of the openings 61a of the recessed portions 61U differs at positions in X direction of the drawing. For example, the width Y2 at the left end of the openings 61a of the recessed portions 61U is smaller than the width Y3 at the right end. Meanwhile, in the example shown in FIG. 33, the opening 61a of the recessed portion 61V has such a shape that the width in Y direction gradually decreases along X direction of the drawing.

In this example, the distance D5 in Y direction of the drawing between the opening 61a of the recessed portion 61U and the opening 61a of the recessed portion 61V is constant irrespective of the position in X direction of the drawing. As a matter of course, a shape of the opening 61a of the recessed portion 61U and a shape of the opening 61a of the recessed portion 61V may be employed which make the distance D5 varied depending on the position in X direction of the drawing. Note that, in this example, the width in X direction of the drawing of the opening 61a of the recessed portion 61U and the width in X direction of the drawing of the opening 61a of the recessed portion 61V are both X1 and equal.

FIG. 34 schematically shows an example of the shape of a plurality of recessed portions which can be formed in a composite film connected with a lead which has the recessed portions shown in FIG. 33 in the upper surface. In the example shown in FIG. 34, the plurality of recessed portions 228 formed in the multilayer structure of the composite films 225A include recessed portions 228U and a recessed portion 228V which are arranged along Y direction of the drawing.

In the configuration illustrated in FIG. 34, the openings 28a of the recessed portions 228U have such a shape that the width in Y direction gradually increases along X direction of the drawing. Meanwhile, the opening 28a of the recessed portion 228V has such a shape that the width in Y direction gradually decreases along X direction of the drawing. Herein, the width Y8 at the left end of the opening 28a of the recessed portion 228U is smaller than the width Y9 at the right end. The distance D11 in Y direction of the drawing between the opening 28a of the recessed portion 228U and the opening 28a of the recessed portion 228V may be constant irrespective of the position in X direction of the drawing or may differ at positions in X direction of the drawing.

The recessed portions 61 and/or the recessed portions 228 may have a crooked shape as viewed in the stacking direction of the composite films 225A. FIG. 35 schematically shows still another example of the shape and arrangement of the recessed portions formed in the upper surface of the lead. In the configuration illustrated in FIG. 35, the openings 61a of the recessed portions 61 have a shape meandering in the XY plane of the drawing and partially include crooked portions 61d. In this example, between the width Y1 in Y direction of the openings 61a of the recessed portions 61 and the distance D4 between the openings 61a of two recessed portions 61 adjacent each other in Y direction of the drawing, the relationship of D4>Y1 holds. The relationship of D4<Y1 may hold. Further, in this example, the width X1 in X direction of the openings 61a of the recessed portions 61 is greater than the width Y1 in Y direction of the openings 61a.

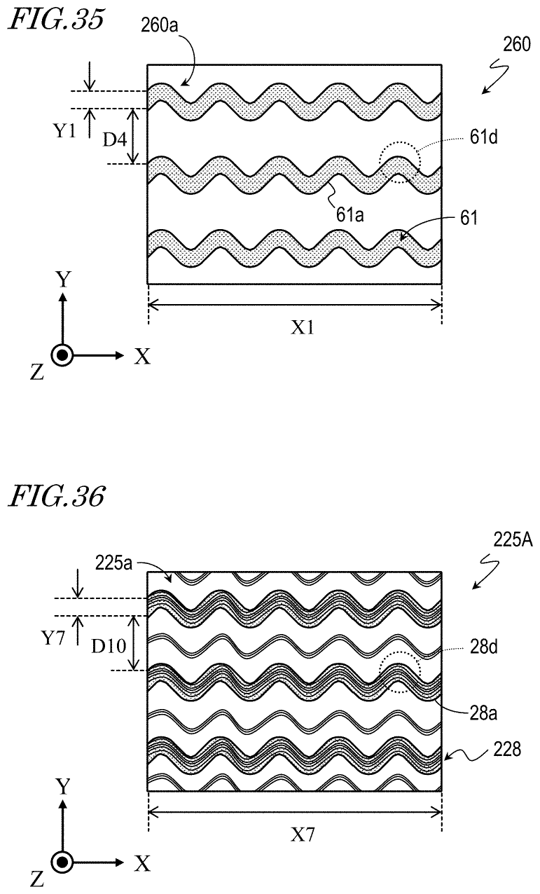

FIG. 36 schematically shows an example of the shape of a plurality of recessed portions which can be formed in a composite film connected with a lead which has the recessed portions shown in FIG. 35 in the upper surface. In the configuration illustrated in FIG. 36, the openings 28a of the recessed portions 228 partially include crooked portions 28d and have a shape meandering in the XY plane of the drawing. In the example shown in FIG. 36, between the width Y7 in Y direction of the openings 28a of the recessed portions 228 and the distance D10 between the openings 28a of two recessed portions 228 adjacent each other in Y direction of the drawing, the relationship of D10>Y7 holds. The relationship of D10<Y7 may hold. Further, in this example, the width X7 in X direction of the openings 28a of the recessed portions 228 is greater than the width Y7 in Y direction of the openings 28a.

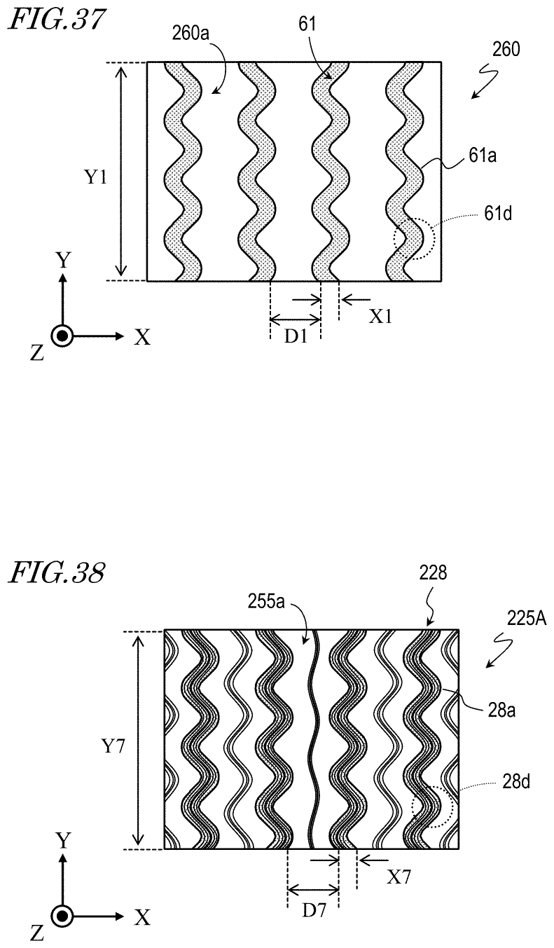

FIG. 37 schematically shows still another example of the shape and arrangement of the recessed portions formed in the upper surface of the lead. In the configuration illustrated in FIG. 37, the openings 61a of the recessed portions 61 have a shape meandering in the XY plane of the drawing and partially include crooked portions 61d likewise as in the example described with reference to FIG. 35. Note that, however, in this example, the width Y1 in Y direction of the openings 61a of the recessed portions 61 is greater than the width X1 in X direction of the openings 61a. That is, herein, Y1>X1.

In the example shown in FIG. 37, between the width X1 in X direction of the openings 61a of the recessed portions 61 and the distance D1 between the openings 61a of two recessed portions 61 adjacent each other in X direction of the drawing, the relationship of D1>X1 holds. The relationship of D1<X1 may hold.

FIG. 38 schematically shows an example of the shape of a plurality of recessed portions which can be formed in a composite film connected with a lead which has the recessed portions shown in FIG. 37 in the upper surface. In the configuration illustrated in FIG. 38, the openings 28a of the recessed portions 228 partially include crooked portions 28d and have a shape meandering in the XY plane of the drawing. In the example shown in FIG. 38, the meandering shape of the opening 28a of each of the recessed portions 228 is elongated in Y direction as compared with X direction of the drawing. That is, herein, between the width Y7 in Y direction of the openings 28a of the recessed portions 228 and the width X7 in X direction of the openings 28a, the relationship of Y7>X7 holds.

In the example shown in FIG. 38, between the width X7 in X direction of the openings 28a of the recessed portions 228 and the distance D7 between the openings 28a of two recessed portions 228 adjacent each other in X direction of the drawing, the relationship of D7>X7 holds. The relationship of D7<X7 may hold.

Thus, the shape of the openings 61a of the recessed portions 61 in the upper surface 260a of the lead 260 is not limited to dot shapes and linear shapes but may be a curved shape or may be a shape realized by combination of lines and curves. The shape of the openings 28a of the recessed portions 228 formed in the multilayer structure of the composite films 225A is also not limited to dot shapes and linear shapes. The shape of the openings 28a of the recessed portions 228 may be a curved shape or may be a shape realized by combination of lines and curves. For example, the bonded portions 25 are formed in a meandering shape, whereby the bond interface between the lead and the composite film is enlarged, and the bonding strength between these components can be further improved.

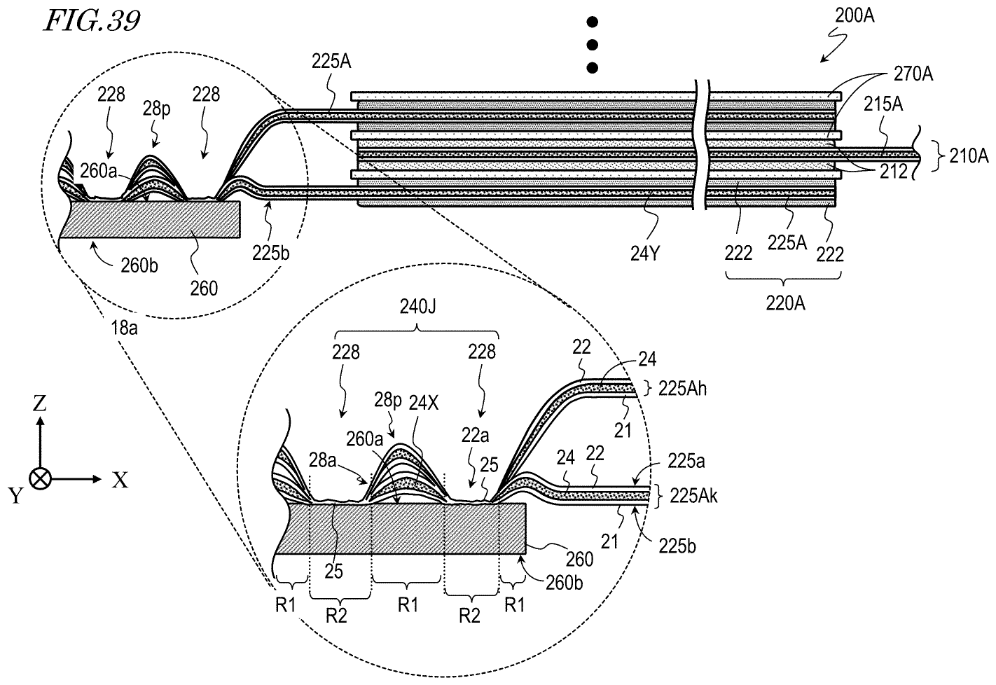

FIG. 39 schematically shows another example of the connection between the second electrode and the lead in the cell. For the sake of simplicity, FIG. 39 shows two of the composite films 225A included in the cell 200A, a composite film 225Ak in the lowermost layer of the multilayer structure of the first electrodes 210A and the second electrodes 220A and a composite film 225Ah provided in a layer overlying the lowermost layer, which are taken out for illustration, as does FIG. 7.

In the configuration illustrated in FIG. 39, the composite films 225A are connected with the second regions R2 of the upper surface 260a of the lead 260. Herein, the upper surface 260a of the lead 260 which includes the first region R1 and the second regions R2 is a flat surface as a whole. Thus, the upper surface 260a of the lead 260 connected with the multilayer structure of the tab regions 210t of the composite films 225A may be a flat surface. In other words, the upper surface 260a of the lead 260 connected with the multilayer structure of the tab regions 210t does not have the above-described recessed portions 61 in some cases.

As enlargedly shown in FIG. 39, in this example, the third portion 240J includes a plurality of bonded portions 25. Each of these bonded portions 25 is located at a position overlapping the second region R2 of the upper surface 260a of the lead 260 as viewed in Z direction of the drawing. As will be described later, the bonded portions 25 are portions in which solid-phase bonding is formed between the first electrically-conductive layers 21 and the second electrically-conductive layers 22 of the composite films 225A. Solid-phase bonding is also formed between the bonded portions 25 and the lead 260. Note that, for example, when the composite films 225A and the lead 260 are connected at the lattice points of a rectangular lattice as in the example described with reference to FIG. 16, the first region R1 can be formed in the form of a grid across the upper surface 260a of the lead 260.

The bonded portions 25 can have a smaller thickness than the other part of the composite films 225A, for example, a part of the composite films 225A overlapping the second material layer 222 in the stacking direction. Meanwhile, another part of the composite films 225A located on a part of the upper surface 260a of the lead 260 extending between two adjacent second regions R2 can have a shape bulged in a direction away from the lead 260 as schematically shown in FIG. 39. Now, attention is paid to the distance in Z direction of the drawing from the upper surface 22a of the second electrically-conductive layer 22 of one of the composite films 225A included in the multilayer structure, for example, the composite film 225Ak, to the lead 260. Herein, the distance from a part of the upper surface 22a of the second electrically-conductive layer 22 which overlaps the first region R1 as viewed in Z direction of the drawing and which is most distant from the lead 260 to the lead 260 is greater than the thickness of the portions overlapping the second regions R2 as viewed in Z direction of the drawing. Also in this example, it can be said that a plurality of recessed portions 228 are formed in the multilayer structure of the composite films 225A at positions corresponding to the second regions R2 of the upper surface 260a of the lead 260 as viewed in Z direction of the drawing.

Thus, it is possible that a recessed portion 61 is not formed in a part of the upper surface 260a of the lead 260 which is connected with the composite films 225A. A second region R2 which partially includes a recessed portion 61 and a second region R2 which does not include a recessed portion 61 may be provided together in the upper surface 260a of the lead 260. As a matter of course, the same bonding structure as that shown in FIG. 39 may be applied to the structure between the first electrodes 210A and the lead 250 in the cell 200A.

### Variation Example 1

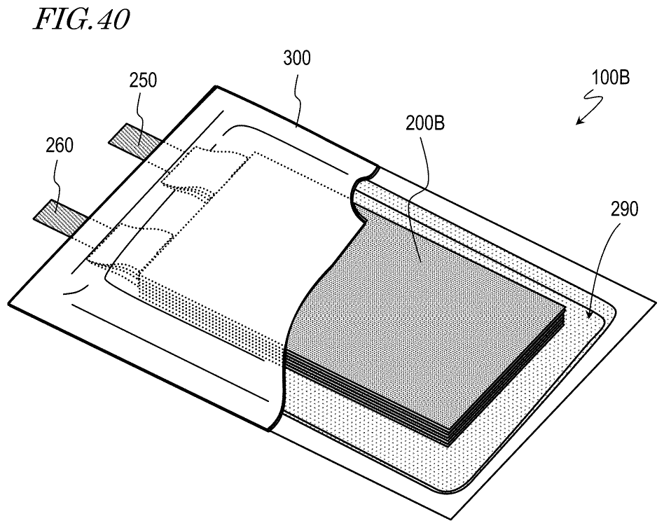

FIG. 40 shows a variation example of a power storage device of an embodiment of the present disclosure. The configuration shown in FIG. 40 is another example of the laminated-type lithium ion secondary battery. The lithium ion secondary battery 100B shown in FIG. 40 includes a cell 200B which includes one or more sets of a positive electrode and a negative electrode, a pair of leads 250 and 260 which are connected with the cell 200B, an enclosure 300 which covers the cell 200B, and an electrolyte 290.

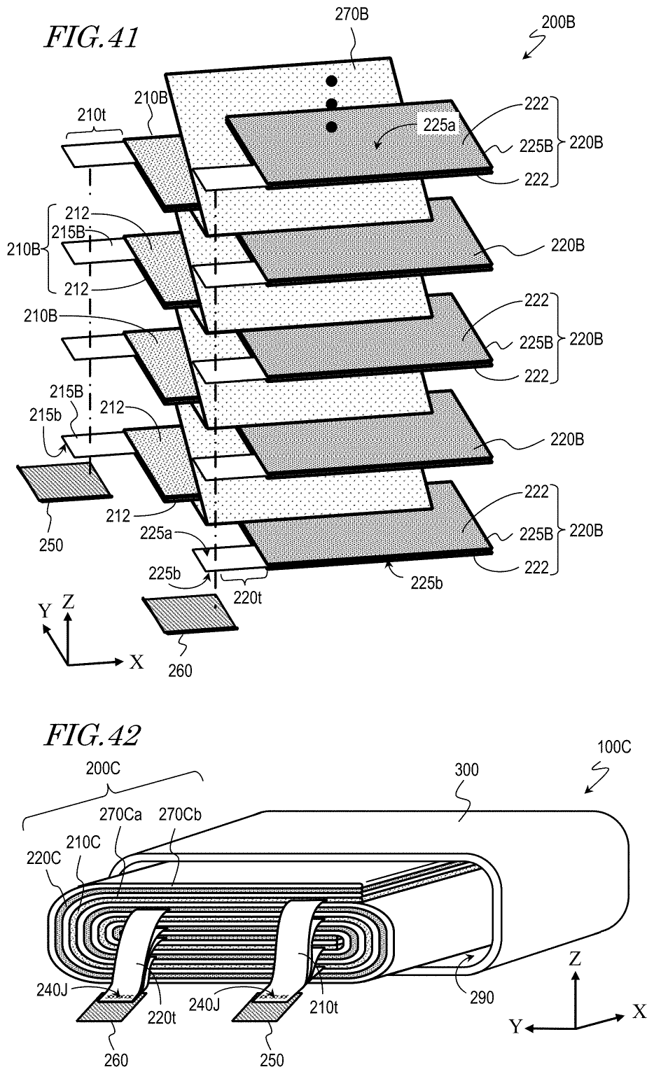

FIG. 41 schematically shows the configuration of the cell 200B taken out of the power storage device shown in FIG. 40. The cell 200B includes one or more first electrodes 210B, one or more second electrodes 220B, and a third layer 270B for preventing direct contact between the first and second electrodes, as does the cell 200A shown in FIG. 2. The composite film 215B of each of the first electrodes 210B includes a tab region 210t which is realized by not providing a first material layer 212 on the surface of the composite film 215B. Likewise, the composite film 225B of each of the second electrodes 220B also includes a tab region 220t which is realized by not providing a second material layer 222 on the surface of the composite film 225B.

The tab regions 210t on the first electrode 210B side are provided at a position where they overlap one another between the first electrodes 210B as viewed in Z direction of the drawing and connected with the lead 250 on the first electrode 210B side. In this example, the lead 250 is connected on the second surface 215b side of the composite film 215B of the first electrode 210B located in the lowermost layer. Likewise, the tab regions 220t on the second electrode 220B side are also provided at a position where they overlap one another between the second electrodes 220B as viewed in Z direction of the drawing, and the lead 260 is connected with the multilayer structure of the tab regions 220t. In this example, the lead 260 is connected on the fourth surface 225b side of the composite film 225B of the second electrode 220B located in the lowermost layer.

In the example shown in FIG. 41, both the tab regions 210t and the tab regions 220t extend out on the same side in terms of X direction of the drawing (herein, the negative side in X direction) of the multilayer structure of the first electrodes 210B and the second electrodes 220B, as compared with the example described with reference to FIG. 2. The tab regions 210t on the first electrode 210B side and the tab regions 220t on the second electrode 220B side may be located on opposite sides in a direction perpendicular to the stacking direction of the first electrodes 210B and the second electrodes 220B as in the example shown in FIG. 2 or may extend out in the same direction as in the example shown in FIG. 41.

In the example shown in FIG. 41, the third layer 270B is a single sheet. The third layer 270B has a shape folded zigzag in the cell 200B. The third layer 270B includes a plurality of parts each located between the first material layer 212 of the first electrode 210B and the second material layer 222 of the second electrode 220B. Each of the first electrodes 210B is located on the side of one of the surfaces of the third layer 270B, and each of the second electrodes 220B is located on the side of the other surface of the third layer 270B.

Thus, the separator may be provided in the form of a single sheet in the cell. Alternatively, the separator may include a plurality of sheets each located between a positive electrode and a negative electrode likewise as in the example shown in FIG. 2. Note that a cross section of the cell 200B taken along a plane parallel to the ZX plane of the drawing is basically the same as the cross section shown in FIG. 7 or FIG. 39 except for the arrangement of the tab regions. Therefore, the cross section of the cell 200B is not shown herein.

### Variation Example 2

FIG. 42 shows another variation example of a power storage device of an embodiment of the present disclosure. FIG. 42 shows still another example of the laminated-type lithium ion secondary battery as a power storage device. The lithium ion secondary battery 100C shown in FIG. 42 includes a cell 200C which includes a set of a positive electrode and a negative electrode, a pair of leads 250 and 260 which are connected with the cell 200C, an enclosure 300 which covers the cell 200C, and an electrolyte 290.

The cell 200C shown in FIG. 42 includes a first electrode 210C, a second electrode 220C, and two third layers 270Ca and 270Cb. The cell 200C has a so-called wound-type configuration which is realized by sequentially stacking up the first electrode 210C, the third layer 270Ca, the second electrode 220C and the third layer 270Cb and thereafter winding up the resultant multilayer structure. Note that, in the example shown in FIG. 42, the cell 200C has a flattened shape as a whole but, as a matter of course, is not limited to this example. The cell 200C may have a cylindrical shape or the like.

In the configuration illustrated in FIG. 42, the first electrode 210C includes four tab regions 210t, while in each of the above-described examples (for example, see FIG. 41) a single tab region 210t is provided for each positive electrode. Further, in the configuration illustrated in FIG. 42, the second electrode 220C also includes four tab regions 210t. The tab regions 210t on the first electrode 210C side are stacked up in Z direction of the drawing and connected with the lead 250. Likewise, the tab regions 220t on the second electrode 220C side are stacked up in Z direction of the drawing and connected with the lead 260. As shown in FIG. 42, third portions 240J are provided in the tab regions 210t and the tab regions 220t.

FIG. 43 shows the configuration of the stack of the first electrode, the second electrode and the separator in the cell shown in FIG. 42. FIG. 43 schematically shows the state of the first electrode 210C, the third layer 270Ca, the second electrode 220C and the third layer 270Cb before they are wound up. Each of the third layers 270Ca and 270Cb is a sheet in the shape of an oblong square which is longer in Y direction as compared with X direction of the drawing. Each of the first electrode 210C and the second electrode 220C also has a shape of an oblong square elongated in Y direction of the drawing except for the tab regions. These sheet members are stacked up and wound up, whereby a structure is realized in which the first electrode 210C and the second electrode 220C are alternately layered in Z direction of the drawing with the third layer 270Ca or 270Cb interposed therebetween.

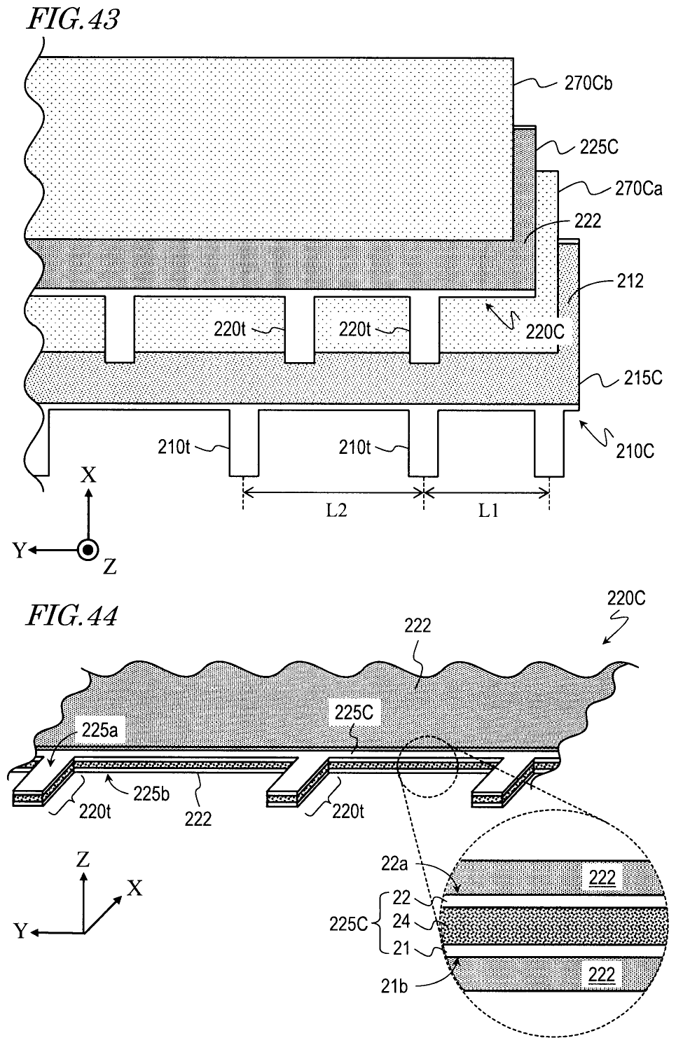

FIG. 44 shows the second electrode taken out of the cell shown in FIG. 42. The second electrode 220C of the cell 200C includes second material layers 222 and a composite film 225C that supports the second material layers 222. In this example, the second material layers 222 are provided on opposite sides of the composite film 225C in the form of a sheet.

The basic configuration of the composite film 225C is the same as that of the above-described composite film 225A, 225B except that the composite film 225C includes a plurality of tab regions 220t instead of the single tab region 220t. As enlargedly shown in FIG. 44, the composite film 225C includes a first electrically-conductive layer 21, a second electrically-conductive layer 22, and a first layer 24 provided between the first electrically-conductive layer 21 and the second electrically-conductive layer 22.

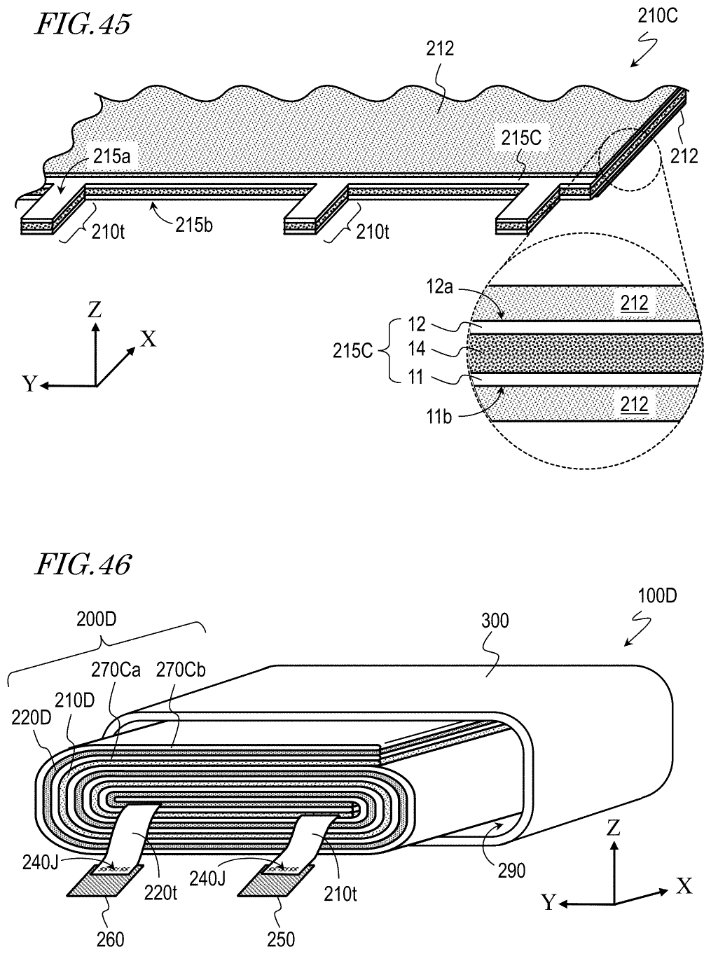

FIG. 45 shows the first electrode taken out of the cell shown in FIG. 42. As shown in FIG. 45, the first electrode 210C includes first material layers 212 and a composite film 215C that supports the first material layers 212. The basic configuration of the composite film 215C is also the same as that of the above-described composite film 215A, 215B except that the composite film 215C includes a plurality of tab regions 210t instead of the single tab region 210t. The composite film 215C includes a first electrically-conductive layer 11, a second electrically-conductive layer 12, and a first layer 14 provided between the first electrically-conductive layer 11 and the second electrically-conductive layer 12 likewise as in the previously-described examples.

The first material layers 212 on the first electrode 210C side are formed in a tape-like shape on the composite film 215C but are not provided on the tab regions 210t. Likewise, the second material layers 222 on the second electrode 220C side are formed in a tape-like shape on the composite film 225C but are not provided on the tab regions 220t.

Refer again to FIG. 43. The composite film 215C of the first electrode 210C includes a plurality of tab regions 210t each extending out from one side of the oblong square to the negative side in X direction of the drawing. These tab regions 210t are provided at such positions in the composite film 215C that, when the first electrode 210C, the third layer 270Ca, the second electrode 220C and the third layer 270Cb are stacked up and wound up, the tab regions 210t overlap one another as viewed in Z direction of the drawing. Thus, when the first electrode 210C is laid out flat, the tab regions 210t do not need to be arranged with equal intervals in Y direction of the drawing. That is, between the distances between two adjacent tab regions 210t which are indicated by double-headed arrows L1 and L2 in FIG. 43, the relationship of L1≠L2 may hold.

The composite film 225C of the second electrode 220C also includes a plurality of tab regions 220t each extending out from one side of the oblong square to the negative side in X direction of the drawing. These tab regions 220t are also not arranged with equal intervals in Y direction of the drawing typically when the second electrode 220C is laid out flat such that, when the first electrode 210C, the third layer 270Ca, the second electrode 220C and the third layer 270Cb are stacked up and wound up, the tab regions 220t overlap one another as viewed in Z direction of the drawing.

Thus, instead of providing a single tab region for each electrode (positive electrode or negative electrode), a plurality of tab regions may be provided for a composite film of a single electrode. When tab regions are arranged at a plurality of locations in a single electrode, the electric current can be dispersed to respective ones of the tab regions in charging/discharging the power storage device. That is, in charging/discharging the power storage device, concentration of the electric current on a single tab region can be avoided, and local excessive temperature increase due to the concentration of the electric current can be suppressed. Such a configuration including a plurality of tab regions is advantageous in improving the reliability of the power storage device. The number and arrangement of tab regions in a composite film can be appropriately changed depending on the size of the power storage device, the number of turns of electrodes, etc.

### Variation Example 3

FIG. 46 shows still another variation example of a power storage device of an embodiment of the present disclosure. FIG. 46 has a flattened wound-type configuration as does the lithium ion secondary battery 100C shown in FIG. 42. Compared with the lithium ion secondary battery 100C, the lithium ion battery 100D shown in FIG. 46 includes a cell 200D in place of the cell 200C. Compared with the cell 200C of the lithium ion secondary battery 100C, the cell 200D includes a set of a first electrode 210D and a second electrode 220D in place of the set of the first electrode 210C and the second electrode 220C. The cell 200D with a pair of leads 250 and 260 connected thereto is stored together with the electrolyte 290 in the space inside the enclosure 300.

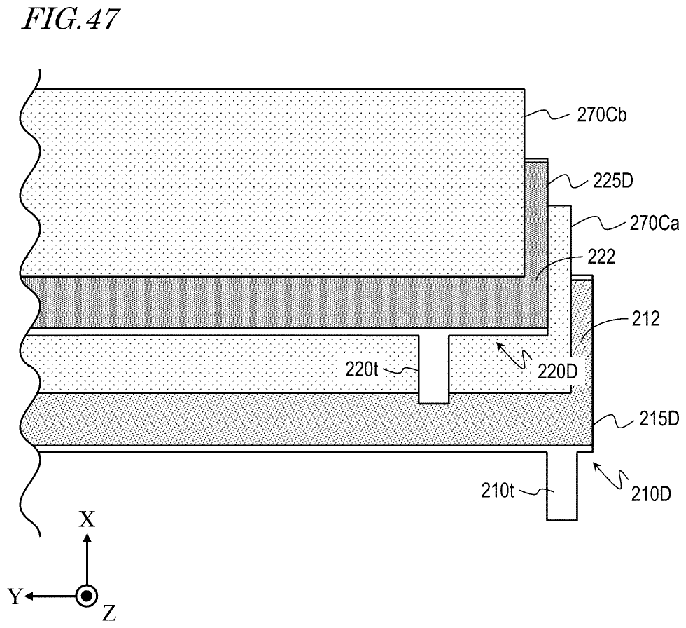

FIG. 47 schematically shows the state of the first electrode, the second electrode and the separator in the cell shown in FIG. 46 before they are wound up. As shown in FIG. 47, the first electrode 210D includes a first material layer 212 and a composite film 215D that supports the first material layer 212. The composite film 215D includes a single tab region 210t. The basic configuration of the composite film 215D is the same as that of the composite film 215C that has previously been described with reference to FIG. 45 except that the number of tab regions 210t is different.

Specifically, the composite film 215D includes a first electrically-conductive layer 11, a second electrically-conductive layer 12, and a first layer 14 provided between the first electrically-conductive layer 11 and the second electrically-conductive layer 12.

The second electrode 220D includes a second material layer 222 and a composite film 225D that supports the second material layer 222. The basic configuration of the composite film 225D is the same as that of the composite film 225C that has previously been described with reference to FIG. 44 except that the number of tab regions 220t is one. Specifically, the composite film 225D includes a first electrically-conductive layer 21, a second electrically-conductive layer 22, and a first layer 24 provided between the first electrically-conductive layer 21 and the second electrically-conductive layer 22.

The first electrode 210D, the third layer 270Ca, the second electrode 220D and the third layer 270Cb are sequentially stacked up and, thereafter, the multilayer structure of these components is wound up, whereby the cell 200D shown in FIG. 46 is realized. The shape of the cell 200D is not limited to a flattened shape but may be a cylindrical shape or the like.

Hereinafter, the lithium ion secondary battery 100A shown in FIG. 2 is described as an example for describing in more detail respective components of the power storage device of Embodiment 1 of the present disclosure.

(Composite Film 215A, 225A)

As previously described with reference to FIG. 3 and FIG. 4, in an embodiment of the present disclosure, a composite material including a supporting layer containing a resin or the like and electrically-conductive layers on opposite surfaces of the supporting layer is employed as the composite film 215A, 225A that supports an active material layer. The composite film 215A includes the first electrically-conductive layer 11 on one of the surfaces of the first layer 14 and the second electrically-conductive layer 12 on the other surface, so that the composite film 215A serves as the current collector of the first electrode 210A. The composite film 225A includes the first electrically-conductive layer 21 on one of the surfaces of the first layer 24 and the second electrically-conductive layer 22 on the other surface, so that the composite film 225A serves as the current collector of the second electrodes 220A.

An example of the first layer 14 of the composite film 215A and the first layer 24 of the composite film 225A is a sheet whose base material is a thermoplastic resin. As the base material of the first layer 14 and the first layer 24, a polyester-based resin, a polyamide-based resin, a polyethylene-based resin, a polypropylene-based resin, a polyolefin-based resin, a polystyrene-based resin, a polyurethane-based resin, an acetal-based resin, cellophane and ethylene-vinyl alcohol copolymer (EVOH), polyimide, polyvinyl chloride, or the like, can be used. Examples of the polyolefin-based resin include polyethylene (PE) and polypropylene (PP). The polyolefin-based resin may be an acid-modified polyolefin-based resin. Examples of the polyester-based resin include polybutylene terephthalate (PBT) and polyethylene naphthalate. Examples of the polyamide-based resin include Nylon 6, Nylon 66, and polymetaxylene adipamide (MXD6). Examples of the polystyrene-based resin include polystyrene (PS). For example, a uniaxially or biaxially stretched sheet of polyethylene terephthalate or a biaxially stretched sheet of polypropylene can be suitably used for the first layer 14 and/or the first layer 24.

The same material as that of the separator can be employed as the base material of the first layer 14 and the first layer 24. The material of the first layer 14 of the composite film 215A and the material of the first layer 24 of the composite film 225A may be common or may be different from each other. The first layer 14 and/or the first layer 24 may be provided in the form of a laminate film which contains two or more types of the aforementioned materials. The first layer 14 and/or the first layer 24 may further contain a flame retardant additive or the like.

The first layer 14 and the first layer 24 have a thickness in the range of, for example, not less than 3 μm and not more than 12 μm in consideration of improvement in energy density and strength as the current collector. The first layer 14 and the first layer 24 preferably have a thickness in the range of not less than 3 μm and not more than 6 μm. Note that the first layer 14 and the first layer 24 are not limited to the form of a resin film. Either or both of the first layer 14 and the first layer 24 may be provided in the form of nonwoven cloth or porous film containing a thermoplastic resin. Either or both of the first layer 14 and the first layer 24 may have a single-layer structure or may have a multilayer structure consisting of a plurality of layers.

The composite film 215A on the first electrode 210A side includes the first electrically-conductive layer 11 and the second electrically-conductive layer 12 which are supported by the first layer 14. As previously described with reference to FIG. 3, in application to the positive electrode of a lithium ion secondary battery, a typical example of the first electrically-conductive layer 11 and the second electrically-conductive layer 12 is an electrically-conductive film which contains aluminum (aluminum film or aluminum alloy film). As the material of the first electrically-conductive layer 11 and/or the second electrically-conductive layer 12, titanium, chromium, stainless steel or nickel, or an alloy which contains one or more of these materials may be employed.

The first electrically-conductive layer 11 and the second electrically-conductive layer 12 can be formed through a known semiconductor process. For example, deposition, sputtering, electroplating, electroless plating, etc., may be used. A seed layer of nickel-chromium or the like is formed by sputtering on a surface of the first layer 14 and, thereafter, an aluminum film is formed on the seed layer by electroplating, electroless plating, deposition, or the like, whereby the first electrically-conductive layer 11 and the second electrically-conductive layer 12 can be formed. The thickness of each of the first electrically-conductive layer 11 and the second electrically-conductive layer 12 can be in the range of not less than 50 nm and not more than 5 μm, preferably in the range of not less than 100 nm and not more than 2 μm (e.g., about 0.5 μm). The first electrically-conductive layer 11 and the second electrically-conductive layer 12 are not limited to a single-layer film. Either or both of the first electrically-conductive layer 11 and the second electrically-conductive layer 12 may include a plurality of layers. On the surfaces of the first electrically-conductive layer 11 and the second electrically-conductive layer 12, a protection layer for suppressing oxidation or the like may be provided.

In FIG. 3, each of the first electrically-conductive layer 11 and the second electrically-conductive layer 12 is illustrated as being in direct contact with the first layer 14, although it is possible that any other function layer is interposed between the first electrically-conductive layer 11 and the first layer 14 and/or between the second electrically-conductive layer 12 and the first layer 14. For example, it is possible that an undercoat layer or the like is provided between the first electrically-conductive layer 11 and the first layer 14 and between the second electrically-conductive layer 12 and the first layer 14. The undercoat layer can be a layer made of an organic material such as an acrylic resin, a polyolefin resin, or the like, or a layer formed by sputtering which contains a metal. By providing the undercoat layer, the effect of strengthening the bond of the electrically-conductive layers (the first electrically-conductive layer 11 and the second electrically-conductive layer 12) to the first layer 14 and/or the effect of suppressing formation of pinholes in the electrically-conductive layer(s) can be achieved.

The composite film 225A on the second electrode 220A side includes the first electrically-conductive layer 21 and the second electrically-conductive layer 22 supported by the first layer 24 likewise as does the composite film 215A. As previously described with reference to FIG. 4, in application to the negative electrode of a lithium ion secondary battery, a typical example of the first electrically-conductive layer 21 and the second electrically-conductive layer 22 is an electrically-conductive film which contains copper (copper film or copper alloy film).

The first electrically-conductive layer 21 and the second electrically-conductive layer 22 can be formed through a known semiconductor process. For example, a seed layer of nickel-chromium (NiCr) is formed by sputtering on a surface of the first layer 24 and, thereafter, a copper film is formed on the seed layer by electroplating, whereby the first electrically-conductive layer 21 and the second electrically-conductive layer 22 can be formed. The first electrically-conductive layer 21 and the second electrically-conductive layer 22 are also not limited to a form of a single-layer film. The thickness of each of the first electrically-conductive layer 21 and the second electrically-conductive layer 22 can also be in the range of not less than 50 nm and not more than 5 μm, preferably in the range of not less than 100 nm and not more than 2 μm (e.g., about 0.5 μm) likewise as do the first electrically-conductive layer 11 and the second electrically-conductive layer 12 on the first electrode 210A side.

An undercoat layer may be interposed between the first electrically-conductive layer 21 and the first layer 24 and between the second electrically-conductive layer 22 and the first layer 24 likewise as in the composite film 215A on the first electrode 210A side. Each of the first electrically-conductive layer 21 and the second electrically-conductive layer 22 may have a protection layer on its surface.

(First Material Layer 212)

In application to the positive electrode of a lithium ion secondary battery, the first material layer 212 of the first electrode 210A contains at least a material capable of intercalating and deintercalating lithium ions as the positive electrode active material. The first material layer 212 can further contain a binder, a conductive assistant, etc. An undercoat layer containing carbon may be interposed between the composite film 215A and the first material layer 212.

An example of the material capable of intercalating and deintercalating lithium ions is a composite metal oxide containing lithium. Example of the composite metal oxide include lithium cobaltate (LiCoO₂), lithium nickelate (LiNiO₂), lithium manganate (LiMnO₂), lithium manganese spinel (LiMn₂O₄), lithium vanadium compounds (LiV₂O₅), olivine-type LiMPO₄ (where M is one or more elements selected from the group consisting of Co, Ni, Mn, Fe, Mg, Nb, Ti, Al and Zr or vanadium oxide), lithium titanate (Li₄Ti₅O₁₂), a composite metal oxide represented by the general formula: LiNiₓCo_{y}Mn_{z}MₐO₂ (x+y+z+a=1, 0≤x<1, 0≤y<1, 0≤z<1, 0≤a<1, where M is one or more elements selected from the group consisting of Al, Mg, Nb, Ti, Cu, Zn and Cr), and a composite metal oxide represented by the general formula: LiNiₓCo_{y}Al_{z}O₂ (0.9<x+y+z<1.1). The first material layer 212 may sometimes contain polyacetylene, polyaniline, polypyrrole, polythiophene, polyacene, or the like, as the material capable of intercalating and deintercalating lithium ions.

For the binder in the first material layer 212, known various materials can be used. As the binder in the first material layer 212, a fluoric resin, such as polyvinylidene fluoride (PVDF), polytetrafluoroethylene (PTFE), tetrafluoroethylene-hexafluoropropylene copolymer (FEP), tetrafluoroethylene-perfluoroalkyl vinyl ether copolymer (PFA), ethylene-tetrafluoroethylene copolymer (ETFE), polychlorotrifluoroethylene (PCTFE), ethylene-chlorotrifluoroethylene copolymer (ECTFE) and polyvinyl fluoride (PVF), can be used.

As the binder in the first material layer 212, a vinylidene fluoride based fluorine rubber may be used. For example, vinylidenefluoride-hexafluoropropylene based fluorine rubber (VDF-HFP based fluorine rubber), vinylidenefluoride-hexafluoropropylene-tetrafluoroethylene based fluorine rubber (VDF-HFP-TFE based fluorine rubber), vinylidenefluoride-pentafluoropropylene based fluorine rubber (VDF-PFP based fluorine rubber), vinylidenefluoride-pentafluoropropylene-tetrafluoroethylene based fluorine rubber (VDF-PFP-TFE based fluorine rubber), vinylidenefluoride-perfluoromethylvinylether-tetrafluoroethylene based fluorine rubber (VDF-PFMVE-TFE based fluorine rubber), vinylidenefluoride-chlorotrifluoroethylene based fluorine rubber (VDF-CTFE based fluorine rubber), or the like, may be employed as the binder in the first material layer 212.

An example of the conductive assistant in the first material layer 212 is a carbon material, such as carbon powder, carbon nanotubes, etc. The carbon powder can be carbon black or the like. The other examples of the conductive assistant in the first material layer 212 include metal powder of nickel, stainless steel, iron, or the like, and powder of a conductive oxide such as ITO. A mixture of two or more of the aforementioned materials may be contained in the first material layer 212.

(Second Material Layer 222)

In application to the negative electrode of a lithium ion secondary battery, the second material layer 222 of the second electrode 220A contains at least a material capable of intercalating and deintercalating lithium ions as the negative electrode active material. The second material layer 222 may further contain a binder, a conductive assistant, etc., as does the first material layer 212 on the first electrode 210A side. An undercoat layer containing carbon may be interposed between the composite film 225A and the second material layer 222.

In application to a lithium ion secondary battery, examples of the material which can be employed for the second material layer 222 include carbon materials, such as natural or artificial graphite, carbon nanotubes, non-graphitizable carbon, graphitizable carbon (soft carbon), low temperature baked carbon, and the like. The other examples of the material which can be employed for the second material layer 222 include alkali metals such as lithium metal and alkaline earth metals, and metals such as tin or silicon, which can form a compound with a metal such as lithium. A silicon-carbon composites may be employed for the second material layer 222. The second material layer 222 may contain particles of an amorphous compound whose major constituent is an oxide (SiOₓ (0<x<2), e.g., tin dioxide), lithium titanate (Li₄Ti₅O₁₂), or the like, as the material capable of intercalating and deintercalating lithium ions.

As the binder and the conductive assistant for the second material layer 222, the materials respectively mentioned above as the binder and the conductive assistant which can be employed for the first material layer 212 on the first electrode 210A side can be employed. As the binder in the second material layer 222 on the second electrode 220A side, cellulose, styrene-butadiene rubber, ethylene-propylene rubber, polyimide resin, polyamide-imide resin, acrylic resin, etc., can also be used as well as the aforementioned materials.

(Lead 250, 260)

The lead 250 and the lead 260 are plate-like members which are made of an electrically-conductive material. Examples of the material of the lead 250 on the first electrode 210A side include aluminum and aluminum alloy. Typical examples of the material of the lead 260 on the second electrode 220A side include nickel and nickel alloy. The lead 260 may include a copper-plated layer at its surface.

In each of the above-described examples, each of the lead 250 and the lead 260 is a rectangular conductor plate. As a matter of course, the shape of the lead 250 and the lead 260 is not limited to the shape of a rectangular plate. Various shapes such as a shape bent in a L-shape as viewed perpendicular to the XY plane, a shape which has a through hole, a shape bent in Z direction, etc., can be employed.

(Third Layer 270A)

The third layer 270A is an insulative member provided between a first material layer 212 and a second material layer 222 which is closest to that first material layer 212 in the cell 200A so that electrical short circuit between the first electrode 210A and the second electrode 220A can be prevented while passage of lithium ions is allowed. The third layer 270A may have a ceramic coat layer at its surface. The thickness of the ceramic coat layer is in the range of, for example, not less than 2 μm and not more than 5 μm. The third layer 270A as a whole has a thickness in the range of, for example, not less than 5 μm and not more than 30 μm. The thickness of the third layer 270A is preferably in the range of not less than 8 μm and not more than 20 μm.

When an electrolytic solution is employed as the electrolyte 290, an insulative porous material is used for the third layer 270A. A typical example of such a porous material is a single-layer film or multilayer film of polyolefin such as polyethylene, polypropylene, or the like, or nonwoven cloth of at least one selected from the group consisting of cellulose, polyester, polyacrylonitrile, polyimide, polyamide (e.g., aromatic polyamide), polyethylene and polypropylene. Alternatively, the third layer 270A may be a porous film. The electrolytic solution is provided not only between the first material layer 212 on the first electrode 210A side and the third layer 270A and between the second material layer 222 on the second electrode 220A side and the third layer 270A but also in the pores of the third layer 270A.

(Electrolyte 290)

As the electrolyte 290, for example, a non-aqueous electrolytic solution containing a metallic salt such as lithium salt and an organic solvent can be used. For the lithium salt, for example, LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, or the like, can be used. One of these lithium salts may be solely used. A mixture of two or more of these lithium salts may be used. From the viewpoint of the degree of ionization, the electrolyte 290 preferably contains LiPF₆.

As the solvent for the electrolyte 290, for example, an organic solvent containing a cyclic carbonate and a chain carbonate can be employed. Examples of the cyclic carbonate which can be employed for the electrolyte 290 include ethylene carbonate, propylene carbonate, butylene carbonate, etc. It is beneficial that the organic solvent contains at least propylene carbonate as the cyclic carbonate. Addition of the chain carbonate decreases the kinematic viscosity of the organic solvent. As the chain carbonate, diethyl carbonate, dimethyl carbonate or ethyl methyl carbonate can be used. The volume ratio between the cyclic carbonate and the chain carbonate in a non-aqueous solvent is preferably in the range of 1:9 to 1:1. The organic solvent may further contain methyl acetate, ethyl acetate, methyl propionate, ethyl propionate, propyl propionate, γ-butyrolactone, 1,2-dimethoxyethane, 1,2-diethoxyethane, etc.

It is beneficial that the concentration of the electrolyte in the non-aqueous electrolytic solution is in the range of not less than 0.5 mol/L and not more than 2.0 mol/L. When the concentration of the electrolyte is not less than 0.5 mol/L, the lithium ion concentration of the non-aqueous electrolytic solution is secured so that a sufficient capacity can easily be achieved in charging and discharging. When the concentration of the electrolyte is not more than 2.0 mol/L, decrease in the mobility of lithium ions of the non-aqueous electrolytic solution is suppressed so that a sufficient capacity can easily be achieved in charging and discharging.

As the electrolyte 290, a solid electrolyte layer can also be employed. As the material of the solid electrolyte layer, at least one selected from the group consisting of perovskite-type compounds such as La_{0.5}Li_{0.5}TiO₃, LISICON-type compounds such as Li₁₄Zn(GeO₄)₄, garnet-type compounds such as Li₇La₃Zr₂O₁₂, NASICON-type compounds such as LiZr₂(PO₄)₃, Li_{1.3}Al_{0.3}Ti_{1.7}(PO₄)₃, Li_{1.5}Al_{0.5}Ge_{1.5}(PO₄)₃, thio-LISICON-type compounds such as Li_{3.25}Ge_{0.25}P_{0.75}S₄, Li₃PS₄, glass compounds such as Li₂S—P₂S₅, Li₂O—V₂O₅—SiO₂, and phosphate compounds such as Li₃PO₄, Li_{3.5}Si_{0.5}P_{0.5}O₄, Li_{2.9}PO_{3.3}N_{0.46} can be used.

(Enclosure 300)

The enclosure 300 is a cover member in which the cell 200A and the electrolyte 290 are stored. The enclosure 300 has the function of protecting the cell 200A and the electrolyte 290 from external moisture or the like. In a configuration where an electrolytic solution is used for the electrolyte 290, the enclosure 300 also has the function of preventing leakage of the electrolytic solution to the outside.

The enclosure 300 is, for example, a multilayer film realized by forming a resin film on opposite surfaces of metal foil. A representative example of the metal foil used in a multilayer film as the enclosure 300 is aluminum foil. For the resin covering the metal foil, for example, a polymer such as polypropylene can be employed. The material of the resin film covering a surface on the cell 200A side of the metal foil (the inner surface of the enclosure 300) and the material of a resin film covering the surface on a side opposite to the cell 200A may be identical or may be different. For example, one of the surfaces of the metal foil on the cell 200A side is covered with polyethylene, polypropylene, or the like, while the surface on the opposite side may be covered with a resin material which has a higher melting point, e.g., polyethylene terephthalate, polyamide (PA), or the like.

As the enclosure 300, a can of metal or the like can be employed instead of the multilayer film. When a metal can is employed as the enclosure 300, the can may have a valve for discharging a gas produced inside the can in some cases. Also, an active material layer may be provided, together with the positive electrode and the negative electrode, on opposite surfaces of a composite film as the current collector in some cases. In such a configuration, the active material layer is located in the outermost part of the cell 200A, and an insulative protection member for securing electrical insulation may be provided between the can as the enclosure 300 and the cell 200A in some cases. As the material of such a protection member, the same material as that of the third layer 270 can be employed.

The enclosure 300 may be a resin cover member formed by curing an epoxy resin or the like. In other words, the enclosure 300 may be a resin as formed by potting.

[Manufacturing Method of Power Storage Device]

Hereinafter, an exemplary manufacturing method of a power storage device is described with reference to the drawings. Herein, the manufacturing method of the power storage device is described based on the example of the lithium ion secondary battery 100A that includes the cell 200A shown in FIG. 2.

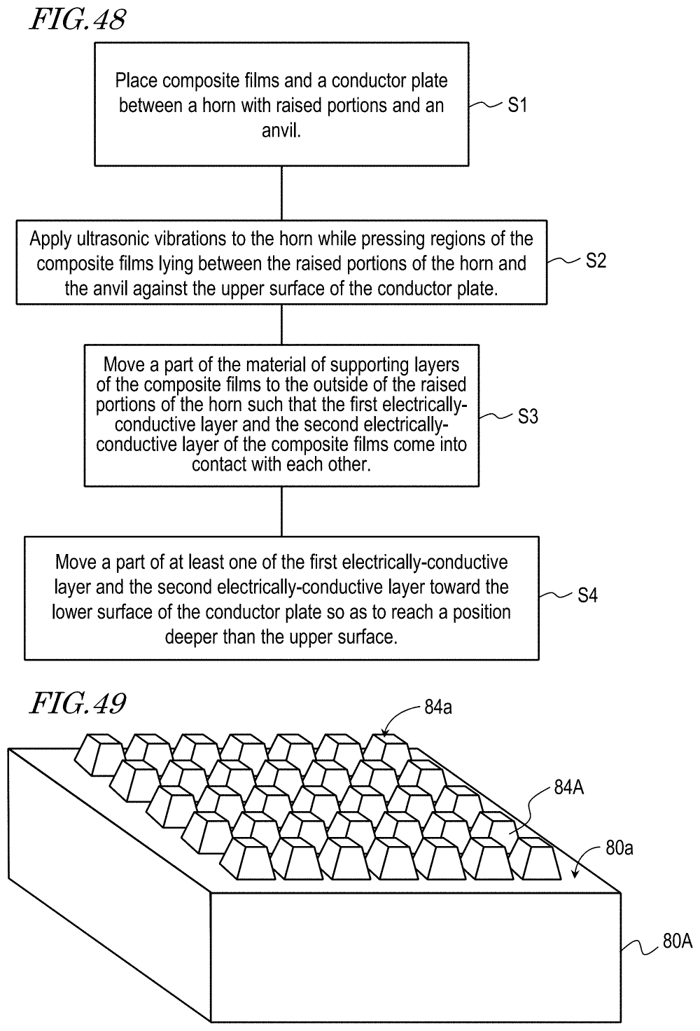

FIG. 48 shows the outline of an exemplary manufacturing method of a power storage device of another embodiment of the present disclosure. The manufacturing method of the power storage device illustrated in FIG. 48 generally includes placing composite films and a conductor plate between a horn with raised portions and an anvil (step S1), applying ultrasonic vibrations to the horn while pressing regions of the composite films lying between the raised portions of the horn and the anvil against the upper surface of the conductor plate (step S2), moving a part of the material of supporting layers of the composite films to the outside of the raised portions of the horn such that the first electrically-conductive layer and the second electrically-conductive layer of the composite films come into contact with each other (step S3), and moving a part of at least one of the first electrically-conductive layer and the second electrically-conductive layer of the composite films toward the lower surface of the conductor plate so as to reach a position deeper than the upper surface (step S4).

Firstly, a lead 250, a plurality of first electrodes 210A, a lead 260, and a plurality of second electrodes 220A are provided. Each of the plurality of first electrodes 210A and each of the plurality of second electrodes 220A can be formed by, for example, providing a resin sheet which includes a resin layer and electrically-conductive films on opposite surfaces of the resin layer, thereafter forming a first material layer 212 or a second material layer 222 as an active material layer on each of the upper surface and the lower surface of the resin sheet, and cutting the resin sheet into a predetermined shape.

The formation of the first material layer 212 and the second material layer 222 includes, firstly, preparing a slurry which contains an active material, a binder and a solvent and applying the slurry to the surfaces of the resin sheet. The solvent can be an organic solvent such as methanol, ethanol, propanol, N-methyl-2-pyrrolidone, N,N-dimethylformamide, or water. In the application of the slurry, a doctor blade coater, a slit die coater, a bar coater, or the like, may be employed. Alternatively, in the application of the slurry, screen printing or gravure printing may be employed. In this case, the slurry is not applied to the entire surfaces of the resin sheet such that a region provided with no slurry remains. After the application of the slurry to the resin sheet, the solvent is removed from the slurry by drying.

After the slurry layer is dried, the thickness of the slurry layer is adjusted by a roll press machine or the like. By pressing pressure, the density of the active material in the first material layer 212 and the density of the active material in the second material layer 222 can be controlled. Thereafter, the resin sheet is cut out into a predetermined shape. The resin sheet is cut out so as to include a region provided with no slurry, whereby an electrode (positive electrode or negative electrode) is formed which includes a composite film with tab regions and an active material layer on the composite film (the first material layer 212 or the second material layer 222).

Herein, a resin sheet which includes a resin layer and aluminum films on opposite surfaces of the resin layer is used for formation of the first electrodes 210A, and a slurry containing a positive electrode active material is applied to the resin sheet. Meanwhile, for formation of the second electrodes 220A, a resin sheet is used which includes a resin layer and copper films on opposite surfaces of the resin layer, and a slurry containing a negative electrode active material is applied to the resin sheet. As the lead on the first electrode 210A side, an aluminum plate having a thickness of about 150 μm can be employed. As the lead on the second electrode 220A side, a nickel plate having a thickness of about 150 μm can be employed.

Then, as shown in FIG. 2, the first electrodes 210A and the second electrodes 220A are alternately stacked up with the third layers 270A as separators interposed therebetween, whereby the cell 200A is assembled. In this step, the plurality of first electrodes 210A and the plurality of second electrodes 220A are stacked up such that the tab regions 210t on the first electrode 210A side overlap one another and the tab regions 220t on the second electrode 220A side overlap one another.

Thereafter, the lead 250 is connected with the tab regions 210t of the plurality of first electrodes 210A included in the cell 200A, and the lead 260 is connected with the tab regions 220t of the plurality of second electrodes 220A. A specific method of connecting the lead is generally common between the first electrode 210A side and on the second electrode 220A side. Therefore, herein, the connection between the tab regions 220t of the plurality of second electrodes 220A and the lead 260 is described while illustration and description regarding the connection between the tab regions 210t of the plurality of first electrodes 210A and the lead 250 are omitted.

In the present embodiment, a lead and a multilayer structure of a plurality of composite films are placed between an anvil and a horn which has one or more raised portions on the surface, and the plurality of composite films are connected with the lead by ultrasonic bonding. Herein, the connection between the lead and the electrode is realized by ultrasonic bonding with the use of transverse ultrasonic vibrations.

FIG. 49 shows an exemplary tip end shape of a horn applicable to ultrasonic bonding between the lead and the composite films. The upper surface 80a of a horn 80A illustrated in FIG. 49 has a plurality of raised portions 84A, each of which has the shape of a truncated pyramid. In the example shown in FIG. 49, the truncated pyramid shape of each of the raised portions 84A has a rectangular top surface 84a. Examples of the material of the horn 80A include titanium and iron.

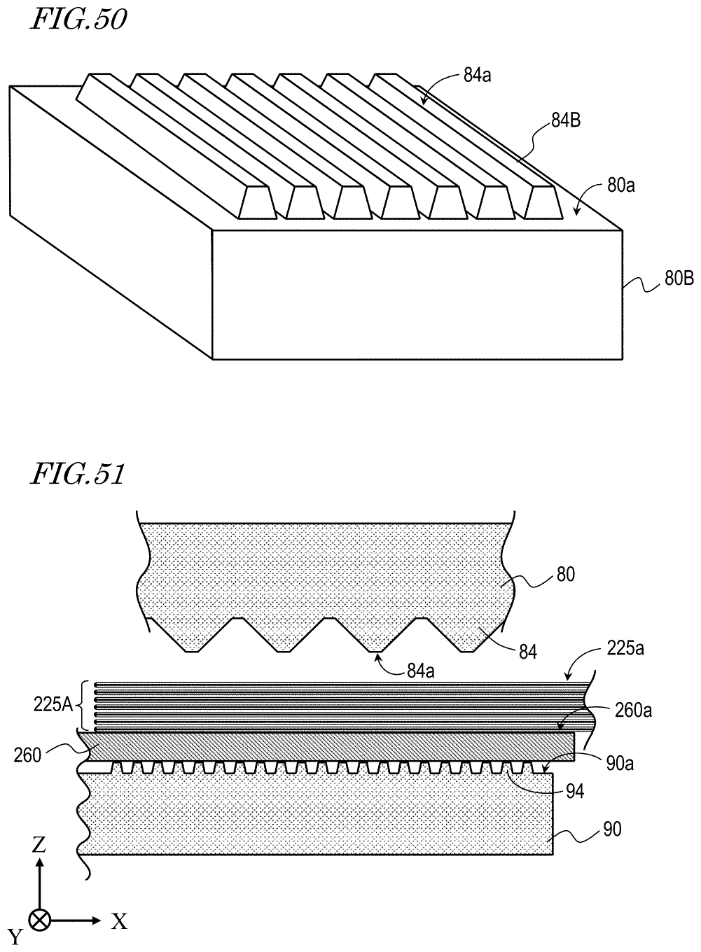

The shape of each of the raised portions of the horn is not limited to the shape shown in FIG. 49. FIG. 50 shows another example of the tip end shape of a horn applicable to ultrasonic bonding between the lead and the composite films. The horn 80B shown in FIG. 50 has a plurality of raised portions 84B at its upper surface 80a. Each of the plurality of raised portions 84B has the shape of a bar extending in a single direction across the upper surface 80a. In this example, the top surface 84a of each of the raised portions 84B has the shape of an oblong square.

In the configuration illustrated in FIG. 49 and FIG. 50, each of the raised portions 84A and each of the raised portions 84B have a trapezoidal cross-sectional shape. The shape of each of the raised portions of the horn shown in FIG. 49 and FIG. 50 is merely exemplary. As a matter of course, the shape of each of the raised portions of the horn is not limited to these examples.

In connecting the plurality of tab regions 220t with the lead 260, firstly, the lead 260 and the plurality of composite films 225A are provided between the horn 80 and the anvil 90 as shown in FIG. 51. In this step, the horn 80 used has a plurality of raised portions 84, and the lead 260 and the plurality of composite films 225A are provided between the horn 80 and the anvil 90 such that the plurality of raised portions 84 face the tab regions 220t of the composite films 225A. As the horn 80, for example, the horn 80A that has the shape illustrated in FIG. 49 or the horn 80B that has the shape illustrated in FIG. 50 can be used.

As shown in FIG. 51, the lead 260 is supported by the upper surface 90a of the anvil 90, and the plurality of composite films 225A are located on the upper surface 260a of the lead 260. As shown in FIG. 51, the upper surface 90a of the anvil 90 may have a plurality of raised portions 94. The plurality of raised portions 94 are provided for preventing dislocation of the lead 260 in the process of ultrasonic bonding. In other words, employing an anvil 90 which is shaped so as to have irregularities at its surface can reduce misalignment of the lead 260 with respect to the multilayer structure of the composite films 225A which is attributed to movement of the lead 260 on the anvil 90 in the presence of applied ultrasonic vibrations. In the example shown in FIG. 51, the size of each of the raised portions 94 of the anvil 90 is smaller than the size of the raised portions 84 of the horn 80.

Then, the raised portions 84 of the horn 80 are brought into contact with the third surface 225a of the composite film 225A of the uppermost layer, and ultrasonic bonding is performed. In this step, firstly, the horn 80 is lowered toward the anvil 90 such that the raised portions 84 of the horn 80 depress the multilayer structure of the composite films 225A and, thereafter, ultrasonic vibrations are applied to the horn 80. Since ultrasonic vibrations are applied to the horn 80 after the horn 80 depresses the multilayer structure of the composite films 225A, occurrence of misalignment of the composite films 225A between the horn 80 and the anvil 90 can be suppressed.

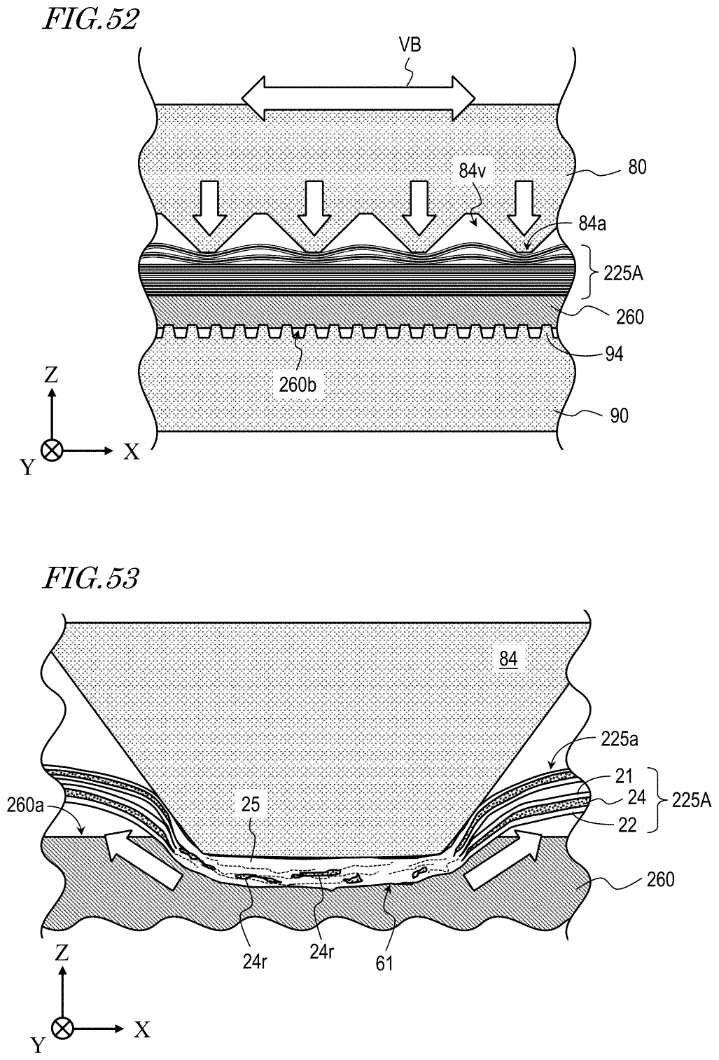

As schematically represented by thick double-headed arrow VB in FIG. 52, in the present embodiment, transverse vibrations in a direction perpendicular to Z direction of the drawing, i.e., the stacking direction of the plurality of composite films 225A, are employed in the ultrasonic bonding. Herein, the horn 80 is caused to make a reciprocal movement along X direction of the drawing. The amplitude of the transverse vibrations is, for example, about 10-50 μm. It is not essential that the ultrasonic vibrations applied to the horn 80 is a linear reciprocal movement. Complex vibrations realized by combining vibrations in two directions perpendicular to the stacking direction of the composite films 225A may be applied to the horn 80. For example, the ultrasonic bonding may be performed by applying to the horn 80 elliptical vibrations in a plane perpendicular to the stacking direction of the composite films 225A.

Herein, each of the raised portions 84 of the horn 80 has a trapezoidal shape including the top surface 84a as viewed in cross section. Therefore, as the horn 80 is lowered, the top surfaces 84a of the raised portions 84 firstly come into contact with the third surface 225a of the composite film 225A of the uppermost layer. In the process of the ultrasonic bonding, the horn 80 depresses the composite films 225A on the anvil 90, and ultrasonic vibrations are applied to the horn 80, whereby regions of the composite films 225A sandwiched between the raised portions 84 of the horn 80 and the anvil 90 are pushed toward the anvil 90 and compressed in the stacking direction.

In this step, the resin material in the first layers 24 of the composite films 225A is partially melted by the ultrasonic vibrations and, furthermore, the composite films 225A are vertically compressed. Due to these causes, a part of the resin material moves toward the outside of the raised portions 84 of the horn 80 between the first electrically-conductive layer 21 and the second electrically-conductive layer 22. As a result, in the regions between the raised portions 84 of the horn 80, the first layers 24 are horizontally compressed so that the composite films 225A deform as schematically shown in FIG. 52. In the example shown in FIG. 52, a part of the composite films 225A lying between two raised portions 84 of the horn 80 deforms so as to bulge toward the bottom of a valley 84v formed between the raised portions 84.

That is, by applying ultrasonic vibrations to the horn 80 while the raised portions 84 of the horn 80 depress the composite films 225A, the resin in the first layer 24 can be pushed to the outside of the raised portions 84 of the horn 80 with the use of transverse vibrations and pressure. Particularly when the horn 80 has a plurality of raised portions 84, the melted resin moves between the first electrically-conductive layer 21 and the second electrically-conductive layer 22 and, as a result, a part of the composite films 225A lying between two adjacent raised portions 84 of the horn 80 is subjected to horizontal pressure so that the first layer 24 partially has an increased thickness. Specifically, by performing bonding between the lead 260 and the composite films 225A with the use of the horn 80 that has the plurality of raised portions 84, the first layer 24 is caused to have portions of a different thickness as compared with the original thickness before the bonding step. For example, in the process of the ultrasonic bonding, the resin material horizontally flows into a part of the first layer 24 lying between two raised portions 84, whereby a region of an increased thickness as compared with the original thickness before the ultrasonic bonding can be formed. In other words, using the horn 80 that has the plurality of raised portions 84 enables formation of the first portion 24X, which has previously been described with reference to FIG. 8, in the first layer 24 of the composite film 225A.

Meanwhile, the thickness of a part of the first layer 24 of the composite film 225A overlapping the second material layer 222 as viewed in Z direction of the drawing (i.e., the stacking direction of the composite films 225A) does not change after the bonding step as compared with the thickness before the bonding step. The second portion 24Y shown in FIG. 7 is a portion of the first layer 24 lying outside the region sandwiched between the horn 80 and the anvil 90 in the bonding step.

Now, attention is paid to regions of the composite films 225A and the lead 260 sandwiched between the anvil 90 and the top surfaces 84a of the raised portions 84 of the horn 80. In the first electrically-conductive layer 21 and the second electrically-conductive layer 22 of the composite films 225A, the resin material is not melted by the ultrasonic vibrations, whereas the resin material in the first layer 24 is melted. In regions of the first layer 24 of the composite films 225A sandwiched between the raised portions 84 of the horn 80 and the anvil 90, the compression between the anvil 90 and the raised portions 84 of the horn 80 causes a part of the resin material in the first layer 24 to be pushed toward the outside of the raised portions 84, while tensile stress toward these regions arises in the first electrically-conductive layer 21 and the second electrically-conductive layer 22.

FIG. 53 enlargedly shows one of the raised portions 84 of the horn 80 and its surroundings. FIG. 53 schematically shows one of the plurality of composite films 225A on the lead 260 which is in the lowermost layer that is closest to the lead 260 and another composite film 225A which is provided above the lowermost composite film 225A, which are taken out for illustration. In the example shown in FIG. 53, the raised portion 84 of the horn 80 depresses the multilayer structure of the composite films 225A toward the lead 260 supported by the anvil 90, whereby a recessed portion 61 is formed in the upper surface 260a of the lead 260. A part of the two composite films 225A shown in FIG. 53 is present in this recessed portion 61.

As described above, by application of ultrasonic vibrations and pressure, a part of the material in a region of the first layer 24 of the composite films 225A sandwiched between the raised portion 84 of the horn 80 and the anvil 90 is moved to the outside of that region. When a part of the material that forms the first layer 24 is pushed toward the outside from the region sandwiched between the raised portion 84 of the horn 80 and the anvil 90, at least part of the first electrically-conductive layer 21 that is spatially separated by the first layer 24 and the second electrically-conductive layer 22 come into contact with each other. Further, solid-phase bonding occurs between the first electrically-conductive layer 21 and the second electrically-conductive layer 22, and a channel of electrical conduction is formed between the first electrically-conductive layer 21 and the second electrically-conductive layer 22. That is, by application of ultrasonic vibrations and pressure, the first electrically-conductive layer 21 and the second electrically-conductive layer 22 are electrically connected with each other in the region sandwiched between the raised portion 84 of the horn 80 and the anvil 90.

Solid-phase bonding also occurs between the first electrically-conductive layer 21 of one of two adjacent composite films 225A and the second electrically-conductive layer 22 of the other composite film 225A. That is, a channel of electrical conduction is also formed between the first electrically-conductive layer 21 and the second electrically-conductive layer 22 that faces each other between two composite films 225A and, as a result, the plurality of composite films 225A are electrically connected together. Also, by application of ultrasonic vibrations and pressure, solid-phase bonding occurs between the first electrically-conductive layer 21 of the composite film 225A of the lowermost layer and the lead 260, and a channel of electrical conduction is formed between these components. That is, a channel of electrical conduction can be formed subsequently between the first electrically-conductive layer 21 and the second electrically-conductive layer 22 in the composite films 225A of each of the second electrodes 220A, and the first electrically-conductive layer 21 and the second electrically-conductive layer 22 in the composite films 225A of the plurality of second electrodes 220A included in the cell 200A can be electrically connected at once with the lead 260.

Thus, the lead 260 can be mechanically and electrically connected with the tab regions 220t of the second electrodes 220A in the cell 200A using ultrasonic bonding. In this sense, the term “bond” used in this specification basically refers to the form of “weld”. By ultrasonic bonding, a channel of electrical conduction is formed not only between, for example, the composite film 225A of the second electrode 220A in the lowermost layer of the cell 200A and the lead 260, but also between the composite films 225A of adjacent second electrodes 220A. Further, employing ultrasonic bonding also enables formation of a channel of electrical conduction between the first electrically-conductive layer 21 and the second electrically-conductive layer 22 in the composite film 225A of each of the second electrodes 220A.

In general, in ultrasonic bonding of resin members, ultrasonic vibrations applied to the horn are parallel to the direction of pressure applied by the horn (also referred to as sonotrode), i.e., so-called longitudinal vibrations are employed. In contrast, the present embodiment employs ultrasonic vibrations which are perpendicular to the direction of pressure applied by the horn (transverse vibrations). Employing such transverse vibrations facilitates pushing outward a resin contained in a region of the supporting layer of the composite film sandwiched between the raised portions of the horn and the anvil. In other words, a channel of electrical conduction can be easily formed between two electrically-conductive layers in a composite film which are separated by a supporting layer containing an insulative material as compared with the case of employing longitudinal vibrations.

By application of pressure and ultrasonic vibrations, the resin material contained in the first layer 24 is pushed outward from a region of the first layer 24 of the composite film 225A lying between the raised portions 84 of the horn 80 and the anvil 90, and solid-phase bonding occurs between the lead 260 and the electrically-conductive layers on opposite surfaces of each of the composite films 225A (the first electrically-conductive layer 21 and the second electrically-conductive layer 22). By strongly decompressing the composite films with the raised portions 84 toward the anvil 90, the recessed portions 61 corresponding to the raised portions 84 of the horn 80 can be formed in a surface of the lead facing the composite films. That is, according to an embodiment of the present disclosure, even when composite films are used which include electrically-conductive layers separated by an insulative material, such as resin, channels of electrical conduction can be formed between these electrically-conductive layers and between these electrically-conductive layers and the lead, for example, at positions overlapping the recessed portions of the lead in the stacking direction of the composite films.

Preferred conditions of the ultrasonic bonding can vary depending on the material of the lead, the material and thickness of the electrically-conductive layers in the composite films, the thickness of the multilayer structure of the composite films, the shape and arrangement pitch of the horn, etc. When employing transverse vibrations, the conditions of the ultrasonic bonding can be set in the ranges shown below, for example. Note that the ranges shown below are exemplary and do not limit the conditions of the ultrasonic bonding of the present embodiment. The amplitude is represented in a proportion with respect to the machine power (e.g., 800 W).

Pressing pressure: 0.05 MPa to 0.5 MPa

Amplitude: 50% to 100%

Duration of application of vibrations: 0.2 s to 1.0 s

Oscillation frequency: 10 kHz to 40 kHz (e.g., 20 kHz or 40 kHz)

In parts of the multilayer structure of the composite films 225A overlapping the recessed portions 61 as viewed in Z direction of the drawing, a large part of the resin contained in the first layer 24 of each of the composite films 225A is expelled in the process of the ultrasonic bonding and, accordingly, the entire thickness of the multilayer structure decreases. Further, a bonded portion 25 is formed by solid-phase bonding between the material of the first electrically-conductive layer 21 and the material of the second electrically-conductive layer 22 of the plurality of composite films 225A. By compression between the raised portions 84 of the horn 80 and the anvil 90, the thickness of the bonded portion 25 formed in the composite films 225A can be reduced as compared with the other part of the composite films 225A (for example, a portion overlapping the second material layer 222 in the stacking direction). Note that the decrease of the entire thickness of the multilayer structure which occurs when a large part of the resin contained in the first layer 24 of each of the composite films 225A is expelled in the process of the ultrasonic bonding also applies to a case where no recessed portion is formed in the upper surface of the lead as in the example previously described with reference to FIG. 39.

As schematically shown in FIG. 53, a large part of the bonded portion 25 can reside in the recessed portion 61 of the lead 260 as viewed in Z direction of the drawing. Note that, however, as previously described with reference to FIG. 9, a part of the resin material in the first layer 24 can remain in a region of the first layer 24 sandwiched between the raised portion 84 of the horn 80 and the anvil 90.

In the example shown in FIG. 53, a resin 24r derived from the resin material of the first layer 24 of the composite film 225A of the lowermost layer and a resin 24r derived from the resin material of the first layer 24 of another composite film 225A which is one layer above the lowermost composite film 225A are present inside the bonded portion 25. In this example, these resins 24r are present at deeper positions than a part of the upper surface 260a of the lead 260 residing in the first region R1, and a part of the third surface 225a of the composite films 225A is present at a deeper position than the upper surface 260a. This means that, due to depression by the horn 80 in the ultrasonic bonding, the first electrically-conductive layer 21 and the second electrically-conductive layer 22 of the composite film 225A moved toward the lower surface 260b to positions deeper than the upper surface 260a of the lead 260.

When the bonded portion 25 is formed so as to include the resins 24r as in the example shown in FIG. 55, the bonding duration and the bonding conditions can be eased and it is therefore advantageous in production cost as compared with the case of forming a bonded portion in which no resin is included. Further, in the step of forming the bonded portion 25, it is not necessary to impose excessive stress on the composite films 225A and, therefore, decrease in the electrical conductivity of the composite films 225A can be suppressed.

As previously described, solid-phase bonding also occurs between the material of the first electrically-conductive layer 21 of the composite films 225A and the material of the lead 260. The position of the boundary between the first region R1 and the second region R2 of the upper surface 260a of the lead 260 can be determined from the viewpoint of whether or not a bond interface is formed between the material of the first electrically-conductive layer 21 of the composite films 225A and the material of the lead 260. When the second region R2 is viewed in Z direction of the drawing, it is possible that the bond interface between the material of the first electrically-conductive layer 21 of the composite films 225A and the material of the lead 260 extends to the outside of the recessed portion 61 included in the second region R2. That is, it is possible that, in plan view, the extent of the second region R2 and the extent of the recessed portion 61 in that second region R2 are not identical.

The shape of each of the recessed portions 61 on the lead 260 and the arrangement of these recessed portions 61 can be adjusted according to the shape of each of the raised portions 84 of the horn 80 and the arrangement of these raised portions 84. For example, by employing a horn 80A which has at the upper surface 80a a plurality of raised portions 84A each having the shape of a truncated pyramid such as shown in FIG. 49, recessed portions 61 can be formed in the lead 260 in the arrangement such as shown in FIG. 16 or in the arrangement such as shown in FIG. 17. The relationship in largeness between the width X1 of the openings 61a of the recessed portions 61 and the distance D1 between the opening 61a can be changed by, for example, adjusting the arrangement of the raised portions 84A of the horn 80A and/or the shape of each of the raised portions 84A.

When employing the horn 80A which has the raised portions 84A in the shape of a truncated pyramid, recessed portions in the shape of an inverted truncated pyramid defined by four inner walls, which correspond to the truncated pyramid shape of the raised portions 84A, can be formed in the multilayer structure of the composite films 225A. For example, by adjusting the arrangement of the raised portions 84A and/or the shape of each of the raised portions 84A, the relationship in largeness between the width X7 of the openings 28a of the recessed portions 228 and the distance D5 between the openings 28a can be changed.

The shape of the recessed portions 228 can vary depending on the number of composite films 225A connected with the lead 260 even when a common horn 80A is used. When the number of composite films 225A connected with the lead 260 is large, it is beneficial that the arrangement of the raised portions 84A arranged across the upper surface 80a of the horn 80A is relatively disperse. This is because a space for receiving the composite films 225A deformed by compression between the raised portions 84A of the horn 80A and the anvil 90 can be easily secured in the valleys between the raised portions 84A. The arrangement of the recessed portions 228 illustrated in FIG. 19 in which the relationship of X7<D5 holds is advantageous when the number of composite films 225A connected with the lead 260 is large.

The arrangement of the raised portions 84 across the upper surface 80a of the horn 80 is not limited to an even arrangement such as the example shown in FIG. 49. The raised portions 84 may be arranged with irregular intervals across the upper surface 80a of the horn 80 or may not be provided in some regions of the upper surface 80a. When the raised portions 84 are arranged with irregular intervals across the upper surface 80a of the horn 80 or the raised portions 84 of different shapes are provided together, a single horn 80 can be applied to connection of various numbers of composite films. For example, when the raised portions 84 are arranged with irregular intervals, the arrangement of the recessed portions 228 such as described with reference to FIG. 18, i.e., the arrangement of the recessed portions 228 which meets D5≠D6 or D5≠D7 where D5, D6 and D7 are the distances between the openings 28a in different sets each including two recessed portions 228, can be realized. Alternatively, the arrangement of the recessed portions 61 such as described with reference to FIG. 16, i.e., the arrangement of the recessed portions 61 which meets D1≠D2 or D1≠D3 where D1, D2 and D3 are the distances between the opening 61a in different sets each including two recessed portions 61, can be realized.

By employing in the ultrasonic bonding the horn 80B that has the raised portions 84B with an oblong square top surface 84a such as shown in FIG. 50 instead of the horn 80A shown in FIG. 49, recessed portions 61 which have a shape such as shown in FIG. 24, FIG. 27, FIG. 29 or FIG. 31 can be formed in the upper surface 260a of the lead 260. Thus, according to an embodiment of the present disclosure, the arrangement and shape of the recessed portions formed in the upper surface of the lead and/or the recessed portions formed in the multilayer structure of the composite films can be adjusted according to the shape of the tip end of the horn. The shape of each of the raised portions 84 of the horn 80 is not limited to the shape of a truncated pyramid or a quadrangular prism but may be a conical shape or the like. The height of each of the raised portions and the distance between the centers of two adjacent raised portions can be appropriately changed according to the number of composite films connected with the lead.

As described above, according to the present embodiment, by employing ultrasonic bonding with the use of a combination of a horn 80 and an anvil 90 whose shapes conform to the structure of the composite films 225A including the first electrically-conductive layer 21 and the second electrically-conductive layer 22 spatially separated by the first layer 24, a large part of the resin residing between the first electrically-conductive layer 21 and the second electrically-conductive layer 22 can be expelled from some regions of the composite films 225A. In this step, the first electrically-conductive layer 21 and the second electrically-conductive layer 22 in the composite films 225A are drawn toward the recessed portions 61, while a part of the first layer 24 lying between two recessed portions 61 of the lead 260 is horizontally compressed. Accordingly, as in the example shown in FIG. 8, a portion of an increased thickness can be formed in a part of the first layer 24 lying between two recessed portions 61 as viewed in cross section. Alternatively, as in the example shown in FIG. 39, a portion of an increased thickness can be formed in a part of the first layer 24 lying between two second regions as viewed in cross section. Instead or in addition, by deforming the composite films 225A between the raised portions 84 of the horn 80, the entire thickness of the multilayer structure of the composite films 225A may be increased at a position overlapping the first region R1 of the lead 260 as viewed in Z direction of the drawing as compared with the original thickness before the ultrasonic bonding.

At a position between two adjacent recessed portions 61 (or second regions R2), particularly one of the plurality of composite films 225A provided on the lead 260 that is in the uppermost layer is horizontally compressed between the raised portions 84 of the horn 80, and is likely to be deformed into a shape which follows the shape of the surface of the raised portions 84 of the horn 80 (in other words, the shape of the valleys formed between the raised portions 84). In other words, after execution of the ultrasonic bonding, a cross-sectional shape of the composite film 225A exhibits a shape of moderate curves in many cases.

On the other hand, when horizontally compressed, in many cases, one of the plurality of composite films 225A which is close to the lead 260 cannot have a sufficient space for receiving its deformation between a composite film 225A of an upper layer and the lead 260. Therefore, as illustrated in FIG. 9 and FIG. 10, it is likely to have a complicated cross-sectional shape between two recessed portions 61. In other words, using the horn 80 that has the plurality of raised portions 84 enables, in the process of the ultrasonic bonding, a part of the composite film 225A lying between two recessed portions 61 (or second regions R2) of the lead 260 to have a complicated shape such as in the examples shown in FIG. 11 to FIG. 14.

Between two recessed portions (or second regions R2) of the lead, an electrically-conductive layer of a composite film or the composite film itself is caused to have a curvature, whereby the same effect as that achieved by stacking up a plurality of electrically-conductive layers along a direction perpendicular to the first region of the upper surface of the lead or the same effect as that achieved by locally increasing the substantial thickness of the insulating layer can be achieved, so that a tear in the composite films 225A in the presence of shear stress can be suppressed. As compared with the case of simply applying heat and pressure on the composite films, using ultrasonic vibrations facilitates formation of a complicated shape in a portion of an electrically-conductive layer of a composite film or the composite film itself lying between two recessed portions (or second regions R2) of the lead as viewed in cross section such as in the examples shown in FIG. 11 to FIG. 14.

Through the above-described process, the third portions 240J (for example, see FIG. 5) can be formed in the tab regions 220t of the composite films 225A. The third portions 240J may be formed at a plurality of locations in the tab regions 220t by repeating ultrasonic bonding while changing the position with which the horn 80 comes into contact.

According to an embodiment of the present disclosure, furthermore, the proportion of a region of the third portions 240J in which a bond occurs between the lead and the composite films can be adjusted according to the shape of the tip end of the horn. For example, by increasing the area ratio of the entire second regions R2 to the first region R1, the effect of reducing the connection resistance between the lead and the electrically-conductive layers of the composite films is achieved. Note that, however, when the area of the top surface of each of the raised portions of the horn is only simply increased, it can be more difficult to move the resin in the supporting layers to the outside from a region of the supporting layers of the composite films sandwiched between the raised portions of the horn and the anvil as the area of the top surface increases.

However, by adjusting the number and arrangement of the raised portions of the horn, the area ratio of the entire second regions R2 to the first region R1 can be increased while increase of the area of the top surface of each of the raised portions is avoided. For example, by dispersedly arranging the raised portions of the horn or expanding the intervals between the raised portions, the space between the raised portions can be enlarged. That is, a space which is capable of receiving deformation of the composite films can be secured between the raised portions of the horn. Note that when the area of the top surface of each of the raised portions is simply reduced, the connection resistance can increase at each of the locations where the bonded portions 25 are formed. However, the increase of the connection resistance can be avoided by increasing the number of raised portions of the horn. By increasing the number of raised portions of the horn, the effect of avoiding local concentration of an electric current in the use of the power storage device is achieved.

A surface of the anvil which supports the lead may be a flat surface or may be a surface having irregularities. For example, by employing an anvil which has irregularities at the surface, one or more recessed portions can be provided on the lower surface 260b side of the lead 260. As shown in FIG. 51 and FIG. 52, the anvil 90 used herein has a plurality of raised portions 94 at the upper surface 90a. When such an anvil 90 is used, the composite films 225A and the lead 260 are pressed against the anvil 90 by the horn 80, whereby a plurality of recessed portions can be formed in the lower surface 260b of the lead 260 as shown in FIG. 9 and FIG. 10 (the recessed portion 62A in FIG. 9 and the recessed portion 62B in FIG. 10).

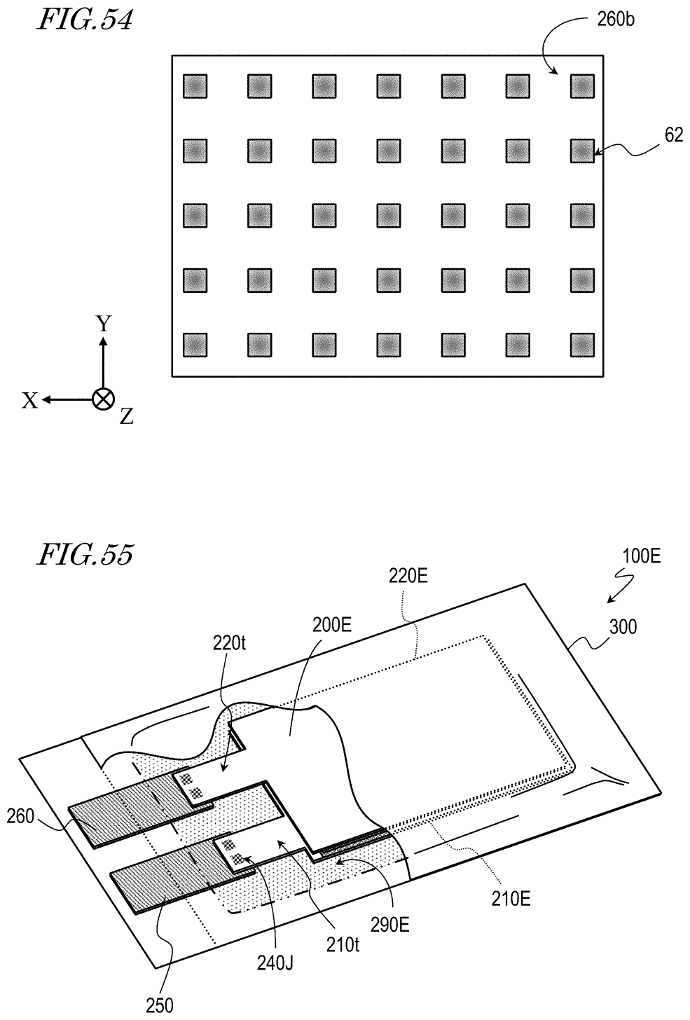

FIG. 54 shows an example of the appearance of the lower surface of the lead after execution of the ultrasonic bonding. In the example shown in FIG. 54, the lower surface 260b of the lead 260 has a plurality of recessed portions 62. These recessed portions 62 are formed at positions corresponding to the raised portions 94 of the anvil 90. The shape of the recessed portions on the lower surface side of the lead and the arrangement of the recessed portions can variously change according to the shape of the surface of the anvil.

According to the techniques disclosed in Patent Document No. 1, a lead and a current collector are sandwiched between an anvil which has raised portions at the surface and a horn which has a flat surface, and ultrasonic vibrations are applied to the horn such that a bond between these members is realized. Herein, as the current collector, a film is used which includes a resin layer and metal films on opposite surfaces of the resin layer. As a result of the ultrasonic bonding, recessed portions are formed in a surface on the anvil side of the lead, and the opposite surface of the lead is buried into the film (FIG. 25 of Patent Document No. 1). According to the techniques disclosed in Patent Document No. 1, the surface on the film side of the lead protrudes into the film such that the metal film on the upper surface side of the film and the metal film on the lower surface side of the film come into contact with each other.

However, the connection between the metal films of the film is realized by deformation of the lead, contact between the metal films can require higher pressure. Particularly, selection of the material of the lead sometimes makes it difficult for the surface of the lead to protrude into the film, and there is a probability that the film will be ruptured in the process of the ultrasonic bonding. For example, in application to a lithium ion secondary battery, a combination of a resin film which has copper films on opposite surfaces and a lead which is made of nickel can be employed. In this case, a high pressure is required for deformation of the lead because nickel is hard and, particularly when the surface of the anvil has relatively large raised portions, there is a probability that the film will be ruptured at positions of contact with these raised portions.

In contrast, according to the present embodiment, a plurality of raised portions are provided on the horn side where ultrasonic vibrations are applied, and these raised portions face the composite films. Therefore, the ultrasonic vibrations can be efficiently applied to the composite films while excessive depression is avoided. According to the present embodiment, the composite films can be connected to the lead without deteriorating the function of the composite films as the current collector. Since the plurality of raised portions are provided on the horn side, a part of the composite films deformed by application of pressure can be stored in the valleys between the raised portions. Thus, parts of the composite films lying between the raised portions of the horn bulge to a side opposite to the lead as compared with the structure before execution of the ultrasonic bonding, and a complicated shape such as previously described with reference to FIG. 9 to FIG. 14 can be realized in these parts. Thus, for example, a mechanically entangled structure can be introduced between mutually stacked up composite films, and the effect of avoiding a failure such as rupture of the composite films by external force or falling off of the composite films from the lead can be achieved.

After execution of the step of the ultrasonic bonding, the cell 200A with the leads 250, 260 connected thereto is stored in the enclosure 300, and the electrolyte 290 is provided in the inner space of the enclosure 300. Thereafter, the perimeter of the enclosure 300 is sealed such that a part of each of the leads 250, 260 is located outside the enclosure 300. Through the above-described process, the secondary battery 100A shown in FIG. 1 is produced.

### Embodiment 2 of Power Storage Device

FIG. 55 shows an example of a power storage device of still another embodiment of the present disclosure. FIG. 55 shows the configuration of an electric double layer capacitor as the power storage device.

The electric double layer capacitor 100E shown in FIG. 55 includes a cell 200E which includes one or more sets of a positive electrode and a negative electrode, a pair of leads 250 and 260 connected with the cell 200E, an enclosure 300 covering the cell 200E, and an electrolyte 290E. In this example, the cell 200E includes a pair of a first electrode 210E and a second electrode 220E. As will be described later, each of the first electrode 210E and the second electrode 220E includes a composite film 215 and a composite film 225 which have electrically-conductive layers on opposite surfaces. The composite film 215 includes a tab region 210t, and the lead 250 is connected with the tab region 210t via the third portions 240J. Likewise, the composite film 225 includes a tab region 220t, and the lead 260 is connected with the tab region 220t via the third portions 240J.

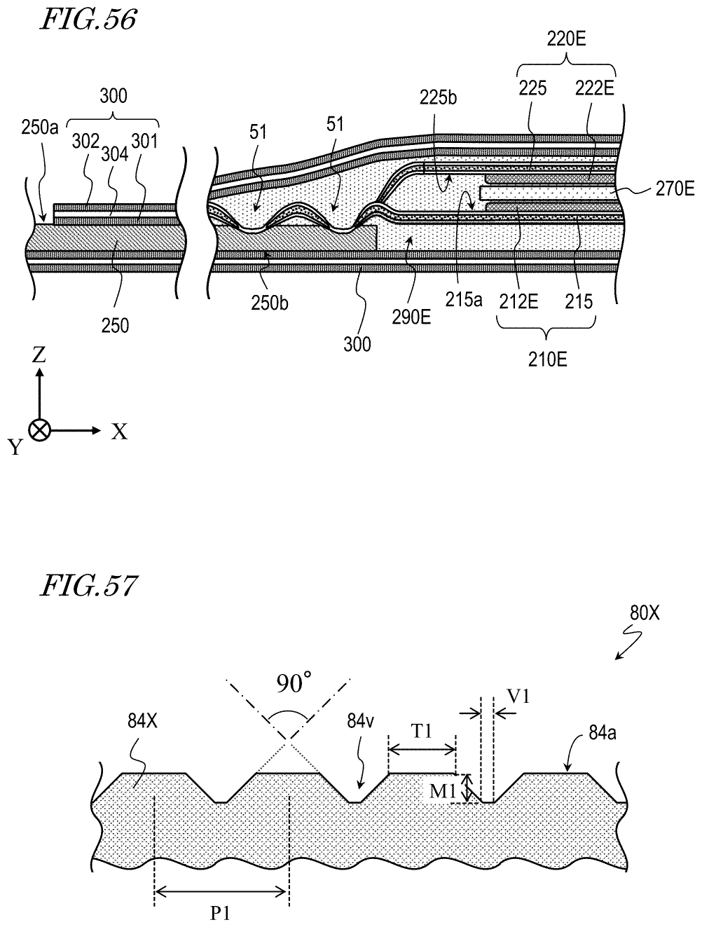

FIG. 56 schematically shows a cross section of the electric double layer capacitor 100E shown in FIG. 55. FIG. 56 corresponds to a cross-sectional view of the electric double layer capacitor 100E which is parallel to a plane including the stacking direction (Z direction of the drawing) of the first electrode 210E and the second electrode 220E in the cell 200E.

As schematically shown in FIG. 56, the cell 200E of the electric double layer capacitor 100E is encapsulated together with the electrolyte 290E in the inner space of the enclosure 300. In this example, the enclosure 300 includes a first resin film 301 and a second resin film 302, and metal foil 304 interposed between these resin films. A part of the lead 250 and a part of the lead 260 are present outside the enclosure 300 and serve as the positive electrode side terminal and the negative electrode side terminal, respectively.

In the configuration illustrated in FIG. 56, the cell 200E includes a pair of the first electrode 210E and the second electrode 220E and a third layer 270E provided between the first electrode 210E and the second electrode 220E. The first electrode 210E includes a first material layer 212E provided on the composite film 215, and the second electrode 220E includes a second material layer 222E provided on the composite film 225. Note that, in application of an embodiment of the present disclosure to an electric double layer capacitor, it is not essential that the material of the electrically-conductive layers is different between the composite film 215 on the first electrode 210E side and the composite film 225 on the second electrode 220E side. It is possible that the composite film 215 is employed for both the current collector of the first electrode 210E and the current collector of the second electrode 220E. The composite film 225 may be employed for the current collector of the first electrode 210E and the current collector of the second electrode 220E.

In this example, the first material layer 212E of the first electrode 210E is provided on some regions of the first surface 215a of the composite film 215, and the second material layer 222E of the second electrode 220E is provided on some regions of the fourth surface 225b of the composite film 225. The third layer 270E is provided between the first material layer 212E of the first electrode 210E and the second material layer 222E of the second electrode 220E. In application to an electric double layer capacitor, the material that forms the first material layer 212E of the first electrode 210E and the material that forms the second material layer 222E of the second electrode 220E can be common.

As schematically shown in FIG. 56, the upper surface 250a of the lead 250 on the first electrode 210E side has a plurality of recessed portions 51, and the composite film 215 of the first electrode 210E is connected with the lead 250 at the positions of these recessed portions 51. Further, the first electrically-conductive layer 11 and the second electrically-conductive layer 12 of the composite film 215 are connected with each other at the positions of the recessed portions 51. That is, in the example shown in FIG. 56, electrical connection from the first material layer 212 of the first electrode 210E to the lead 250 via the composite film 215 is realized by the same configuration as the example of the connection of the composite films 225A with the lead 260 which has previously been described with reference to FIG. 7 and FIG. 8.

Although not shown, the same connection as that of the example previously described with reference to FIG. 7 and FIG. 8 is also formed between the composite film 225 on the second electrode 220E side and the lead 260. That is, the first electrically-conductive layer 21 and the second electrically-conductive layer 22 in the composite film 225 on the second electrode 220E side are also electrically connected with the lead 260 at the positions of the plurality of recessed portions 61 of the upper surface 260a of the lead 260.

It is not essential that the upper surface 250a of the lead 250 has the recessed portions 51. The composite film 215 of the first electrode 210E and the lead 250 may be connected with each other by the same connection structure as that of the example previously described with reference to FIG. 39. Likewise, the same connection structure as that of the example previously described with reference to FIG. 39 may be realized between the composite film 225 on the second electrode 220E side and the lead 260.

An electrical and mechanical connection between a composite film as a current collector and a lead can be formed by, for example, ultrasonic bonding. When a channel of electrical conduction is formed using ultrasonic bonding, falling off of the lead from the composite film, rupture of the composite film starting from a position which is between the lead and the composite film and which is near a third portion, etc., can be suppressed, and an electric double layer capacitor of excellent reliability can be provided.

Hereinafter, the components of the electric double layer capacitor 100E are described in more detail.

(First Material Layer 212E, Second Material Layer 222E)

As described above, the first material layer 212E on the first electrode 210E side and the second material layer 222E on the second electrode 220E side can be made of a common material. A representative example of the active material in the first material layer 212E and the second material layer 222E is activated carbon. As the active material of the first material layer 212E and the second material layer 222E, carbon materials such as fullerene, graphene, and the like, can be employed as well as the materials of the second material layer 222 which are oriented to uses of the lithium ion secondary battery, such as graphite, carbon nanotubes, etc.

As the active material of the first material layer 212E and the second material layer 222E, a silicon-containing carbon material may be used. The silicon-containing carbon material can be produced according to a method disclosed in Japanese Laid-Open Patent Publication No. 2020-064971. The silicon-containing carbon material is realized by, for example, mixing tetramethoxysilane, tetraethoxysilane, tetrabutoxysilane, or the like, with a carbon material such as activated carbon in ethanol as the solvent, further adding water and a hydrochloric acid, and thereafter drying the resultant mixture. The entire disclosure of Japanese Laid-Open Patent Publication No. 2020-064971 is incorporated by reference in this specification.

As the binder for the first material layer 212E and the second material layer 222E, for example, an electrically-conductive polymer such as polyacetylene can be used. The electrically-conductive polymer also serves as a conductive assistant.

(Electrolyte 290E)

As the electrolyte 290E, an aqueous electrolytic solution, a non-aqueous electrolytic solution, or an ionic liquid can be used. The solute in the non-aqueous electrolytic solution is a salt containing a cation and an anion. The cation used can be quaternary ammonium such as tetraethylammonium, triethylmethylammonium, spiro-(1,1′)-bipyrrolidinium or diethylmethyl-2-methoxyethylammonium (DEME), or imidazolium such as 1,3-dialkylimidazolium, 1,2,3-trialkylimidazolium, 1-ethyl-3-methylimidazolium (EMI) or 1,2-dimethyl-3-propylimidazolium (DMPI). The anion used can be BF₄⁻, PF₆⁻, ClO₄⁻, AlCl₄⁻ or CF₃SO₃⁻.

As the solvent of the non-aqueous electrolytic solution, acetonitrile, propionitrile, dimethylformamide, tetrahydrofuran, dimethoxymethane, sulfolane, dimethyl sulfoxide, ethylene glycol, propylene glycol, methyl cellosolve, or the like, can be used as well as the organic solvents mentioned as the solvent of the electrolyte 290. One of the above-described organic solvents may be solely used. A mixture of two or more of the organic solvents which are mixed in an arbitrary ratio may be used.

### Other Variation Examples

In each of the above-described embodiments, a composite film which has electrically-conductive layers on opposite surfaces is employed for both of the current collector on the positive electrode side and the current collector on the negative electrode side. However, it is not essential for the embodiments of the present disclosure that such a composite film is employed for both of the positive electrode and the negative electrode. For example, copper foil may be employed for the current collector on the negative electrode side while the composite film is employed for the current collector on the positive electrode side. Alternatively, such a configuration is possible that the composite film is employed for the current collector on the negative electrode side while aluminum foil is employed for the current collector on the positive electrode side.

### Examples

[Evaluation of Change in Thickness of Multilayer Structure of Current Collector]

We produced samples by assembling a laminated-type secondary battery cell in which a composite film was employed for either one of the current collector of the positive electrode and the current collector of the negative electrode and connecting a lead to tab regions of the current collectors by ultrasonic bonding. Herein, we prepared a plurality of samples with the number of current collectors and the shape of the tip end of the horn being varied, and evaluated the change in thickness of the multilayer structure of the current collectors after the ultrasonic bonding as compared with the thickness before the ultrasonic bonding and the bonding quality.

(Battery 1-1)

The cell of Battery 1-1 was produced through the following procedure. Firstly, as the current collector on the positive electrode side, a composite film including a sheet of polyethylene terephthalate and aluminum electrically-conductive layers on opposite surfaces of the sheet was prepared. Then, active material layers were formed on the composite film so as not to cover some regions. The formation of the active material layers was realized by applying a paint containing a positive electrode active material onto the composite film, drying the paint, and thereafter rolling out the dried paint. As the positive electrode active material, lithium cobaltate (LiCoO₂) was used. The active material layers were formed on opposite surfaces of the composite film. Then, the composite film was punched into a predetermined shape so as to include a region of the composite film in which the active material layer is not provided, whereby a plurality of positive electrodes, each including a composite film as the current collector and partially having a tab region, were produced.

A plurality of negative electrodes were prepared through substantially the same procedure as that for the positive electrodes. Note that, however, herein, copper foil not including a resin insulating layer was used as the current collector on the negative electrode side. Further, active material layers were placed on opposite surfaces of the copper foil. The formation of the active material layer was realized by applying a paint containing a negative electrode active material onto the composite film, drying the paint, and thereafter rolling out the dried paint. Graphite was used as the negative electrode material.

Then, 9 positive electrodes and 10 negative electrodes were alternately stacked up with separators interposed therebetween, whereby a cell was assembled. The separators used had a thickness of 12 μm and were made of polyethylene. Herein, the positive electrodes, the negative electrodes and the separators were stacked up such that the outermost part was a negative electrode. Further, the arrangement of the respective electrodes in the cell was adjusted such that the tab regions of the composite films of the positive electrodes overlap one another and the tab regions of the copper foil of the negative electrodes overlap one another.

Then, a 100 μm thick aluminum plate was provided as the lead on the positive electrode side, and the multilayer structure of the tab regions on the positive electrode side was connected to the lead on the positive electrode side by ultrasonic bonding. Herein, the ultrasonic bonding was performed using a horn 80X which was shaped so as to have a plurality of raised portions 84X across the upper surface such as shown in FIG. 57. The material of the horn 80X was hardened iron.

Each of the raised portions 84X of the horn 80X shown in FIG. 57 had the shape of a truncated pyramid in which two opposite lateral surfaces formed the angle of 90°. Each of the raised portions 84X had a top surface 84a. In the horn 80X, the plurality of raised portions 84X were arranged along two mutually-orthogonal directions across the upper surface of the horn 80X. The arrangement pitch of the raised portions 84X, i.e., the distance P1 between the centers of two adjacent raised portions 84X, was 1 mm. In a cross-sectional view of the horn 80X taken along the direction along which the plurality of raised portions 84X were arranged, the width T1 of the top surface 84a was 0.47 mm, and the width V1 of the bottom of a valley 84v formed between two raised portions 84X was 0.05 mm. The distance M1 from the bottom of the valley 84v to the top surface 84a of the raised portions 84X was 0.24 mm.

The conditions of the ultrasonic bonding employed for the connection of the lead on the positive electrode side are as follows. Note that, in the following description, “Amplitude” is represented in a proportion with respect to the power of the machine (800 W).

Pressing pressure: 0.2 MPa

Amplitude: 100%

Duration of application of vibrations: 0.4 s

Direction of vibrations: transverse vibrations (reciprocal movement)

Oscillation frequency: 40 kHz

How many times bonded: Once

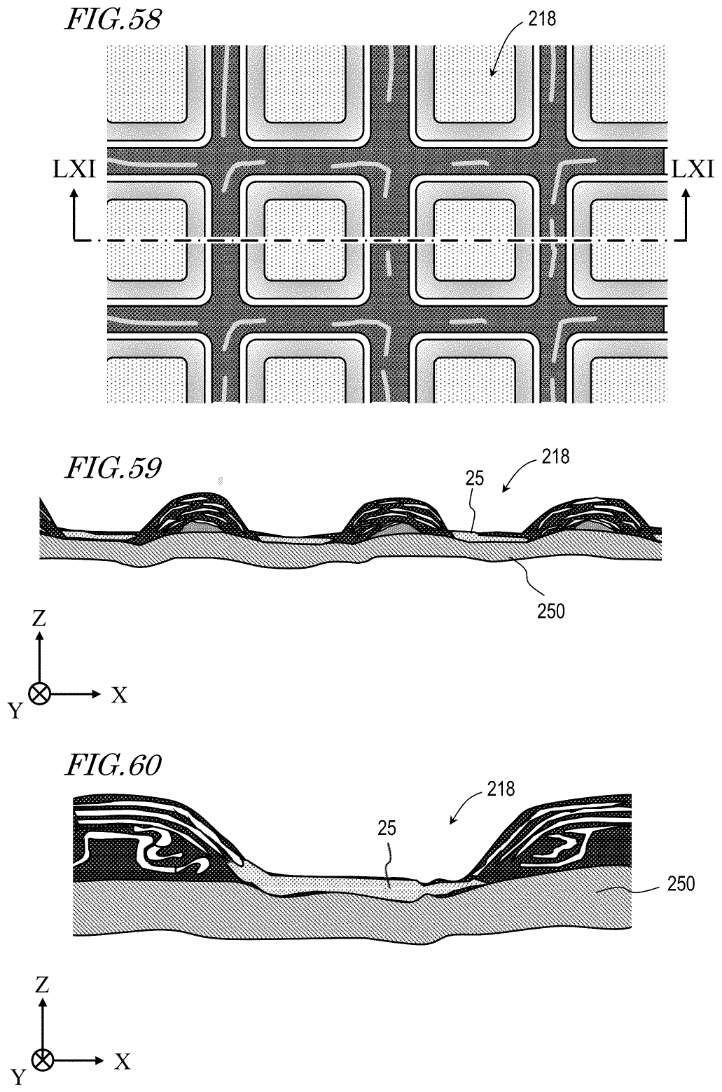

FIG. 58 is a schematic diagram in which a microscopic image of the third portion on the positive electrode side of Battery 1-1 as viewed in the stacking direction of the composite films is depicted with lines. FIG. 59 and FIG. 60 are schematic diagrams in which a microscopic image of a cross section regarding the third portion on the positive electrode side after execution of ultrasonic bonding is depicted with lines. FIG. 59 is based on a microscopic image regarding a vertical cross section of the composite films shown in FIG. 58 taken along line LXI-LXI. FIG. 60 is a partially enlarged view of FIG. 59. As shown in FIG. 59 and FIG. 60, in a part of the upper surface of the lead which was compressed between the raised portions 84X of the horn 80X and the anvil in the stacking direction of the tab regions (Z direction of the drawing), a recessed portion was formed. Further, it was confirmed from the diagram shown in FIG. 60 that a flat region of about 450 μm in width was formed at the bottom of a recessed portion 218.

Now, attention is paid to the tab regions of the current collectors. It was found that, in a part of the tab regions of the current collectors overlapping the recessed portions of the upper surface of the lead, almost all of the resin material was expelled from the region between the aluminum electrically-conductive layers, and a bonded portion was formed by solid-phase bonding between electrically-conductive layers in each of the composite films and solid-phase bonding between electrically-conductive layers of two adjacent composite films. It was also confirmed that solid-phase bonding occurred between the lead and the electrically-conductive layers of the composite films. That is, it was found that electrical connection was produced between the electrically-conductive layers of each of 9 composite films and the lead.

Before execution of the ultrasonic bonding, the total of the thickness of the lead on the positive electrode side and the thickness of the multilayer structure of the tab regions was 0.16 mm. On the other hand, after execution of the ultrasonic bonding, at the position of the recessed portion of the lead, the distance from the lower surface of the lead to the upper surface of the bonded portion was reduced to 0.11 mm. Note that the distance from the lower surface of the lead to the upper surface of the bonded portion was measured while the lead was placed on a surface plate. It is estimated that, in regions of each of the composite films sandwiched between the raised portions 84X of the horn 80X and the anvil, polyethylene terephthalate in the sheet supporting the electrically-conductive layers was melted by frictional heat produced by ultrasonic vibrations and moved to regions overlapping the valleys 84v of the horn 80X.

Now, attention is paid to regions of the composite films lying between recessed portions of the lead. As shown in FIG. 59 and FIG. 60, in the regions between the recessed portions of the lead, the composite films were horizontally compressed because of depression by the raised portions 84X of the horn 80X toward the anvil and, as a result, the composite films bulged in a direction away from the upper surface of the lead. The distance from the lower surface of the lead to the highest part of the composite films in the regions between the recessed portions of the lead was 0.26 mm. That is, the increase of about 63% was confirmed as compared with the distance before execution of the ultrasonic bonding. Further, as seen from FIG. 59 and FIG. 60, in the regions between the recessed portions of the lead, the composite films were horizontally compressed and, as a result, a complicated shape arose in particularly composite films located close to the lead.

Further, the multilayer structure of the tab regions on the negative electrode side was also connected to the lead on the negative electrode side by ultrasonic bonding. The lead on the negative electrode side was a 100 μm thick nickel plate.

The conditions of the ultrasonic bonding employed for the connection of the lead on the negative electrode side are as follows.

Pressing pressure: 0.1 MPa

Amplitude: 50%

Duration of application of vibrations: 0.06 s

Direction of vibrations: transverse vibrations (reciprocal movement)

Oscillation frequency: 40 kHz

How many times bonded: Once

Before execution of the ultrasonic bonding, the total of the thickness of the lead on the negative electrode side and the thickness of the multilayer structure of the tab regions was 0.18 mm. On the other hand, after execution of the ultrasonic bonding, the distance from the lower surface of the lead to the upper surface of the composite film of the uppermost layer remained at 0.18 mm irrespective of whether it was a region in which solid-phase bonding occurred between the electrically-conductive layer of the composite film and the lead or a region in which no solid-phase bonding occurred.

In the third portion of the negative electrode, copper foil as the current collector and the lead which is made of nickel are bonded to each other. Solid-phase bonding is produced between these components by ultrasonic bonding, although the current collector or the lead is not necessarily melted by application of ultrasonic vibrations. It can be said that a large change would not occur in the thickness of the lead and the multilayer structure of the copper foil after the ultrasonic bonding step as compared with the thickness before the ultrasonic bonding step.

After execution of the ultrasonic bonding, the cell was covered with a laminate film as the enclosure, an electrolytic solution was poured therein, and thereafter the laminate film was sealed. Through the process described hereinabove, Battery 1-1 was produced.

(Battery 1-2)

A cell of Battery 1-2 was assembled in the same way as the cell of Battery 1-1 except that the number of positive electrodes was 19 and the number of negative electrodes was 20. Thereafter, by ultrasonic bonding, the multilayer structure of the composite films on the positive electrode side was connected to an aluminum lead, and the multilayer structure of copper foil on the negative electrode side was connected to a nickel lead. Note that, however, herein, on both the positive electrode side and the negative electrode side, a 0.2 mm thick lead was bonded to a current collector.

The conditions of the ultrasonic bonding employed for the connection of the lead on the positive electrode side are as follows.

Pressing pressure: 0.25 MPa

Amplitude: 100%

Duration of application of vibrations: 0.5 s

Direction of vibrations: transverse vibrations (reciprocal movement)

Oscillation frequency: 40 kHz

How many times bonded: Once

The conditions of the ultrasonic bonding employed for the connection of the lead on the negative electrode side are as follows.

Pressing pressure: 0.125 MPa

Amplitude: 50%

Duration of application of vibrations: 0.08 s

Direction of vibrations: transverse vibrations (reciprocal movement)

Oscillation frequency: 40 kHz

How many times bonded: Once

Before execution of the ultrasonic bonding, the total of the thickness of the lead on the positive electrode side and the thickness of the multilayer structure of the tab regions was 0.32 mm. After execution of the ultrasonic bonding, the distance from the lower surface of the lead to the highest part of the composite films in the regions between the recessed portions of the lead increased to 0.68 mm. Meanwhile, as for the negative electrode, the distance from the lower surface of the lead to the upper surface of the copper foil of the uppermost layer remained at 0.32 mm, i.e., no change was found in the distance, after the ultrasonic bonding step as compared with the distance before the ultrasonic bonding step.

Thereafter, in the same way as Battery 1-1, the cell with the lead connected thereto was placed together with the electrolytic solution inside the enclosure and, thereafter, the enclosure was sealed, whereby Battery 1-2 was produced. Note that the thickness of the polyethylene terephthalate sheet in the composite films of each of the positive electrodes of Battery 1-1 and Battery 1-2 was in the range of 5-7 μm, and the thickness of the aluminum electrically-conductive layer was in the range of 0.5-1 μm. The thickness of the copper foil of each of the negative electrodes was in the range of 6-8 μm.

(Battery 1-3)

Battery 1-3 was produced through the following procedure. Battery 1-3 is different from Battery 1-1 in that aluminum foil was used for the current collector on the positive electrode side instead of the composite film having the electrically-conductive layers and a composite film was used instead of the copper foil.

Firstly, a plurality of positive electrodes were prepared through the following procedure. Herein, aluminum foil, which did not include a resin insulating layer, was used as the current collector on the positive electrode side. Active material layers were formed on opposite surfaces of the aluminum foil as the current collector. In this step, the active material layers were provided on the foil so as not to cover some regions of each of the upper surface and the lower surface of the foil. Thereafter, the foil was punched into a predetermined shape so as to include a region of the foil in which the active material layer was not provided, whereby a plurality of positive electrodes each including a tab region were produced.

For the current collector on the negative electrode side, a composite film including a polyethylene terephthalate sheet and copper electrically-conductive layers formed on opposite surfaces of the polyethylene terephthalate sheet was provided. Then, active material layers were formed on opposite surfaces of the composite film so as not to cover some regions of the composite film. The active material layers were formed on opposite surfaces of the composite film. Then, the composite film was punched into a predetermined shape so as to include a region of the composite film in which the active material layer is not provided, whereby a plurality of negative electrodes, each including a composite film as the current collector and partially having a tab region, were produced.

Then, 9 positive electrodes and 10 negative electrodes were alternately stacked up with separators interposed therebetween likewise as in Battery 1-1, whereby a cell was assembled. Thereafter, by ultrasonic bonding, the multilayer structure of the tab regions on the positive electrode side was connected to the lead on the positive electrode side (0.1 mm thick aluminum plate) and the multilayer structure of the tab regions on negative electrode side was connected to the lead on the negative electrode side (0.1 mm thick nickel plate) likewise as in Battery 1-1.

The conditions of the ultrasonic bonding employed for the connection of the lead on the positive electrode side are as follows.

Pressing pressure: 0.1 MPa

Amplitude: 45%

Duration of application of vibrations: 0.06 s

Direction of vibrations: transverse vibrations (reciprocal movement)

Oscillation frequency: 40 kHz

How many times bonded: Once

The conditions of the ultrasonic bonding employed for the connection of the lead on the negative electrode side are as follows.

Pressing pressure: 0.2 MPa

Amplitude: 100%

Duration of application of vibrations: 0.35 s

Direction of vibrations: transverse vibrations (reciprocal movement)

Oscillation frequency: 40 kHz

How many times bonded: Once

Before execution of the ultrasonic bonding, the total of the thickness of the lead on the positive electrode side and the thickness of the multilayer structure of the tab regions was 0.21 mm. After execution of the ultrasonic bonding, the distance from the lower surface of the lead to the upper surface of the aluminum foil of the uppermost layer remained at 0.21 mm, i.e., no change was found.

Before execution of the ultrasonic bonding, the total of the thickness of the lead on the negative electrode side and the thickness of the multilayer structure of the tab regions was 0.16 mm. After execution of the ultrasonic bonding, the distance from the lower surface of the lead to the highest part of the composite films in the regions between the recessed portions of the lead increased to 0.29 mm. Thereafter, in the same way as Battery 1-1, the cell with the lead connected thereto was placed together with the electrolytic solution inside the enclosure and, thereafter, the enclosure was sealed, whereby Battery 1-3 was produced.

(Battery 1-4)

A cell of Battery 1-4 was assembled in the same way as the cell of Battery 1-3 except that the number of positive electrodes was 19 and the number of negative electrodes was 20. Thereafter, by ultrasonic bonding, the multilayer structure of the aluminum foil on the positive electrode side was connected to an aluminum lead, and the multilayer structure of the composite films on the negative electrode side was connected to a nickel lead. Note that, however, herein, on both the positive electrode side and the negative electrode side, a 0.2 mm thick lead was bonded to a current collector likewise as in Battery 1-2.

The conditions of the ultrasonic bonding employed for the connection of the lead on the positive electrode side are as follows.

Pressing pressure: 0.125 MPa

Amplitude: 45%

Duration of application of vibrations: 0.08 s

Direction of vibrations: transverse vibrations (reciprocal movement)

Oscillation frequency: 40 kHz

How many times bonded: Once

The conditions of the ultrasonic bonding employed for the connection of the lead on the negative electrode side are as follows.

Pressing pressure: 0.25 MPa

Amplitude: 100%

Duration of application of vibrations: 0.4 s

Direction of vibrations: transverse vibrations (reciprocal movement)

Oscillation frequency: 40 kHz

How many times bonded: Once

The distance from the lower surface of the lead on the positive electrode side to the upper surface of the aluminum foil of the uppermost layer remained at 0.43 mm, i.e., no change was found in the distance, after the ultrasonic bonding step as compared with the distance before the ultrasonic bonding step. Meanwhile, before execution of the ultrasonic bonding, the total of the thickness of the lead on the negative electrode side and the thickness of the multilayer structure of the tab regions was 0.32 mm. After execution of the ultrasonic bonding, the distance from the lower surface of the lead to the highest part of the composite films in the regions between the recessed portions of the lead increased to 0.57 mm.

Thereafter, in the same way as Battery 1-1, the cell with the lead connected thereto was placed together with the electrolytic solution inside the enclosure and, thereafter, the enclosure was sealed, whereby Battery 1-4 was produced. Note that the thickness of the aluminum foil of each of the positive electrodes of Battery 1-3 and Battery 1-4 was in the range of 11-13 μm. The thickness of the polyethylene terephthalate sheet in the composite films of each of the negative electrodes was in the range of 3-5 μm, and the thickness of the copper electrically-conductive layer was in the range of 0.3-1 μm.

(Evaluation of Electrical Connection and Battery Performance)

As for each of Battery 1-1 to Battery 1-4, the connection resistance between the current collector (composite film) on the positive electrode side or the negative electrode side and the lead was examined.

Measurement of the connection resistance was carried out as follows. Firstly, in the positive or negative electrode at the uppermost part of each battery (i.e., at a position most distant from the lead), the active material layer located at the upper surface of the composite film that was the current collector was partially peeled away such that the electrically-conductive layer (aluminum foil or copper foil) was exposed, and the resistance between the exposed part of the electrically-conductive layer and the lead was measured. The distance from the end on the lead side of the current collector to the exposed part of the electrically-conductive layer was about 1 cm. In the measurement of the connection resistance, a BATTERY HiTESTER manufactured by HIOKI was used. Then, the positive or negative electrode was turned over, and the active material layer located at the lower surface of the composite film was partially peeled away such that the electrically-conductive layer was exposed. The resistance between the exposed part of the electrically-conductive layer and the lead was measured in the same way. Thereafter, the measured positive or negative electrode and the underlying counter electrode were peeled away, and the same measurement was also carried out on the second positive or negative electrode as counted from the top. In this way, as for all of the positive or negative electrodes in each battery (in Battery 1-1, 9 positive electrodes), the connection resistance between the electrically-conductive layers at the front and rear surfaces of the composite film and the lead was sequentially measured, and it was confirmed whether or not an electrical connection was established. Herein, 100 mΩ was assumed as the criterion. When the measurement of the connection resistance was not more than 100 mΩ, it was determined that an electrical connection was established.

As a result, in each of Battery 1-1 to Battery 1-4, the resistance between the electrically-conductive layers (aluminum foil or copper foil) of all the composite films and the lead was not more than 100 mΩ, and it was confirmed that an electrical connection was established. The largeness of the connection resistance was compared between Battery 1-1 and Battery 1-3, but a large difference was not found. Also, the largeness of the connection resistance was compared between Battery 1-2 and Battery 1-4, but a large difference was not found.

That is, even when a composite film was used as the current collector instead of the metal foil, a realized connection resistance was not inferior to that achieved in a case where the metal foil was used for the current collector. It was found that, even when a composite film was used as the current collector instead of the metal foil, increase of the connection resistance can be avoided by forming a connection with the lead using ultrasonic bonding.

Further, as for each of Battery 1-1 to Battery 1-4, an operation check was carried out by a charge/discharge test. It was found from this operation check that, by employing a composite film for either or both of the current collector on the positive electrode side and the current collector on the negative electrode side, the effect of reducing the weight of the power storage device can be expected without degrading the reliability.

[Verification 1 of Effect of Tip End Shape of Horn on Bonding Quality]

(Battery 2)

Next, a cell of Battery 2 was produced in the same way as Battery 1-1, and leads were connected respectively to a tab region on the positive electrode side and a tab region on the negative electrode side by ultrasonic bonding. Note that, however, the tip end of the horn used herein for the ultrasonic bonding had a different shape from that of the horn used in production of Battery 1-1.

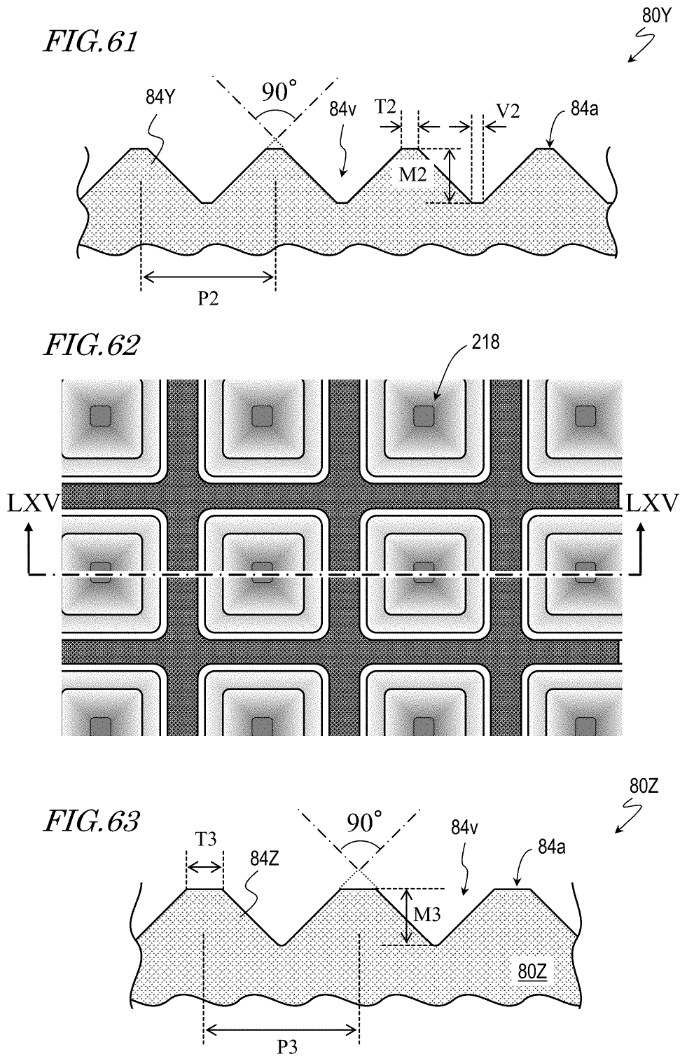

FIG. 61 shows a cross-sectional shape of the horn used in production of Battery 2. The horn 80Y shown in FIG. 61 had a plurality of raised portions 84Y arranged along two mutually-orthogonal directions as did the horn 80X shown in FIG. 57. The distance between the centers of the raised portions 84Y (arrangement pitch) P2 was 1 mm, which was equal to the distance between the centers of the raised portions 84X of the horn 80X shown in FIG. 57. The number of raised portions 84Y of the horn 80Y was also equal to the number of raised portions 84X in the horn 80X shown in FIG. 57.

The shapes of respective parts of the horn 80Y are as follows. Each of the raised portions 84Y had the shape of a truncated pyramid of which two opposite lateral surfaces formed the angle of 90° and partially had a top surface 84a. The width T2 of the top surface 84a in a cross section of the horn 80Y taken along the direction in which the plurality of raised portions 84Y are arranged was 0.12 mm, and the width V2 of the bottom of a valley 84v formed between two raised portions 84Y was 0.05 mm. The distance M2 from the bottom of the valley 84v to the top surface 84a of the raised portions 84Y was 0.415 mm.

In production of Battery 2, the conditions of the ultrasonic bonding employed for the connection of the lead on the positive electrode side are as follows.

Pressing pressure: 0.2 MPa

Amplitude: 100%

Duration of application of vibrations: 0.4 s

Direction of vibrations: transverse vibrations (reciprocal movement)

Oscillation frequency: 40 kHz

How many times bonded: Once

After Battery 2 was produced, a cross section of the third portion between the lead and the composite films was observed, and the effect of the shape of the tip end of the horn on the bonding quality was evaluated.

FIG. 62 is a schematic diagram in which a microscopic image of the third portion on the positive electrode side of Battery 2 as viewed in the stacking direction of the composite films is depicted with lines. As a result of the cross-sectional observation of Battery 2, it was found that recessed portions 218 were formed in parts of the upper surface of the lead which were compressed in the stacking direction between the raised portions 84Y of the horn 80Y and the anvil likewise as in the third portion of Battery 1-1.

We observed a vertical cross section of the composite films shown in FIG. 62 taken along line LXV-LXV with a microscope and confirmed that a flat region of about 160 μm in width was formed at the bottom of the recessed portions 218. It was also found likewise as in Battery 1-1 that, in part overlapping the recessed portions of the upper surface of the lead, almost all of the resin material was expelled from the region between the aluminum electrically-conductive layers, and a bonded portion was formed by solid-phase bonding between electrically-conductive layers in each of the composite films and solid-phase bonding between electrically-conductive layers of two adjacent composite films. Further, a bonded portion was also formed by solid-phase bonding between the lead and the electrically-conductive layers of the composite film.

As compared with the third portion of Battery 1-1 shown in FIG. 57 to FIG. 60, it was found that the third portion of Battery 2 had deeper recessed portions. This is estimated to be because, as compared with the horn 80X, the area of the top surface 84a of the raised portions 84Y of the horn 80Y was reduced and, as a result, the lead was more strongly compressed.

In Battery 2, in the regions between the recessed portions of the lead, by depression with the raised portions 84Y of the horn 80Y toward the anvil, the composite films were horizontally compressed so as to bulge in a direction away from the upper surface of the lead. Note that, however, in the multilayer structure of the composite films, no complicated bend occurred in a cross section of the composite films except for some layers located closer to the lead unlike the example shown in FIG. 59 and FIG. 60. This is estimated to be because, in the horn 80Y shown in FIG. 61, the distance from the bottom of the valleys 84v to the top surface 84a was enlarged as compared with the horn 80X shown in FIG. 57. That is, it is estimated that, as a result of the enlarged space between the raised portions 84Y of the horn 80Y, a greater part of the respective composite films compressed horizontally can be received in the valleys 84v of the horn 80Y.

Thus, it was found that, by adjusting the shape of the tip end of the horn used in the ultrasonic bonding, the shape of the recessed portions of the lead and the shape of the composite films at positions between the recessed portions of the lead can be controlled to some extent. Note that, in Battery 2, the lead exhibited a wavy shape in some cross sections, although it is estimated that the wavy shape itself of the lead will not largely affect the properties achieved when the cell is employed for a power storage device.

Comparing the shape of the raised portions 84Y of the horn 80Y shown in FIG. 61 and the shape of the raised portions 84X of the horn 80X shown in FIG. 57, the width of the top surface 84a as viewed in cross section was greater in the raised portions 84X (T1>T2). That is, the top surface 84a of the raised portions 84X can have a greater area. Thus, the weld interface between the electrically-conductive layers of the composite films and the lead can be enlarged, and the raised portions 84X of the horn 80X shown in FIG. 57 is more advantageous from the viewpoint of reducing the connection resistance between the composite films and the lead. Note that, however, regions of the insulating layer of the composite films sandwiched between the raised portions of the horn and the anvil increase and, as a result, the resin material of the insulating layer is pushed to the outside of the raised portions of the horn, and therefore, higher pressing pressure is likely to be required. Further, to enlarge the space for receiving the composite films deformed by pressing so as to bulge, it is possible that enlargement of the arrangement pitch of the raised portions is required. Thus, when the raised portions of the horn used is shaped so as to have a larger top surface 84a, the area of each of the third portions formed in the multilayer structure of the tab regions can increase.

From the viewpoint of the bonding strength in each of the bonded portions formed at the positions corresponding to the raised portions of the horn, the case of using the horn 80X shown in FIG. 57 can be advantageous as compared with the case of using the horn 80Y shown in FIG. 61. Note that, however, as in the horn 80Y shown in FIG. 61, even if the area of the top surface 84a of each of the raised portions is relatively small, decrease of the bonding strength of the third portion as a whole can be avoided by increasing the number of raised portions. The width of the bonded portion as viewed in cross section may be greater, or on the contrary smaller, than the distance between the centers of two adjacent bonded portions. The relationship in largeness between the width of the bonded portion and the distance between the centers of two adjacent bonded portions can be appropriately changed according to the shape of the horn.

(Battery 3)

Next, a cell of Battery 3 as a comparative example was produced in the same way as Battery 1-1, and leads were connected respectively to a tab region on the positive electrode side and a tab region on the negative electrode side by ultrasonic bonding. Note that, however, the tip end of the horn used herein for the ultrasonic bonding had a different shape from that of the horn used in production of Battery 1-1 and that of the horn used in production of Battery 2.

FIG. 63 shows a cross-sectional shape of the horn used in production of Battery 3. The horn 80Z shown in FIG. 63 also had a plurality of raised portions 84Z arranged along two mutually-orthogonal directions as did the horn 80X shown in FIG. 57 and the horn 80Y shown in FIG. 61. The distance between the centers of the raised portions 84Z (arrangement pitch) P3 was 0.4 mm. Each of the raised portions 84Z had the shape of a truncated pyramid of which two opposite lateral surfaces formed the angle of 90° and partially had a top surface 84a. The width T3 of the top surface 84a in a cross section of the horn 80Z taken along the direction in which the plurality of raised portions 84Z are arranged was 0.06 mm. The distance M3 from the bottom of the valley 84v formed between two raised portions 84Z to the top surface 84a of the raised portions 84Z was 0.17 mm.

In production of Battery 3, the conditions of the ultrasonic bonding employed for the connection of the lead on the positive electrode side are as follows.

Pressing pressure: 0.25 MPa

Amplitude: 100%

Duration of application of vibrations: 0.4 s

Direction of vibrations: transverse vibrations (reciprocal movement)

Oscillation frequency: 40 kHz

How many times bonded: Once

After Battery 3 was produced, a cross section of the third portion between the lead and the composite films was observed, and the effect of the shape of the tip end of the horn on the bonding quality was evaluated.

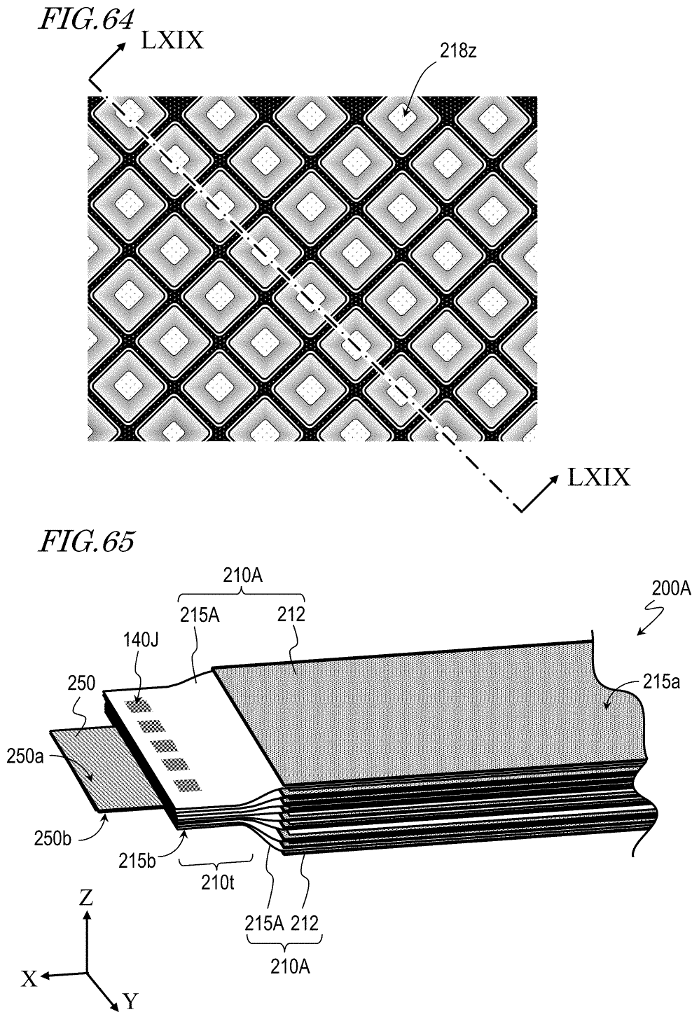

FIG. 64 is a schematic diagram in which a microscopic image of the third portion on the positive electrode side of Battery 3 as viewed in the stacking direction of the composite films is depicted with lines. As a result of the cross-sectional observation of Battery 3, it was found that, in the third portion of Battery 3, features 218z like recessed portions were formed in parts of the upper surface of the lead which were compressed between the raised portions 84Z of the horn 80Z and the anvil, and the lead was not partially but entirely deformed into a wavy shape.

We observed a vertical cross section of the composite films shown in FIG. 64 taken along line LXIX-LXIX with a microscope and confirmed that a recessed part of the upper surface of the lead included a flat region of about 140 μm in width at the bottom. In Battery 3, features 218z like recessed portions were formed in the upper surface of the lead, but the connection between the electrically-conductive layers of the composite films and the lead was not sufficiently formed and the entirety of the lead was deformed.

One of possible reasons of the above-described unintended excessive deformation in the lead is that, due to narrow intervals between the raised portions at the tip end of the horn or a small height of the raised portions, expelling of the resin material from the region between the electrically-conductive layers of respective composite films required higher pressure. Further, it is estimated that when the intervals between the raised portions at the tip end of the horn are narrow or when the height of the raised portions is small, valley portions formed at the tip end of the horn are small and, therefore, the largeness of the space for receiving the respective composite films which are horizontally compressed is insufficient.

[Verification 2 of Effect of Tip End Shape of Horn on Bonding Quality]

(Electrode Structure 4-1)

The bonding quality between the lead and the composite films was further evaluated with a horn having a changed tip end shape. The number of composite films as the current collector on the positive electrode side was 10. The multilayer structure of the composite films was connected to the lead by ultrasonic bonding, whereby Electrode Structure 4-1 was produced. The connection between the multilayer structure of the composite films and the lead was carried out in the same way as Battery 1-1 except that the shape of the tip end of the horn used in the ultrasonic bonding was changed.

The horn used in the ultrasonic bonding of the lead in Electrode Structure 4-1 had a plurality of raised portions arranged along two mutually-orthogonal directions and each having a truncated pyramid shape as did the horn 80X shown in FIG. 57. The arrangement pitch of the raised portions was 0.62 mm. The width of the top surface of the raised portions in a cross section of the horn taken along the direction in which the raised portions were arranged was 0.21 mm.

Before execution of the ultrasonic bonding, the total of the thickness of the lead on the positive electrode side and the thickness of the multilayer structure of the tab regions was 0.16 mm. On the other hand, after execution of the ultrasonic bonding, the distance from the lower surface of the lead to the highest part of the composite films in the regions between the recessed portions of the lead increased to 0.29 mm.

(Electrode Structure 4-2)

The bonding quality between the lead and the composite films was further evaluated with a horn having a changed tip end shape. Electrode Structure 4-2 was produced in the same way as Electrode Structure 4-1 except that the shape of the horn used in the ultrasonic bonding was changed. In the horn used in the ultrasonic bonding of Electrode Structure 4-2, the arrangement pitch of the raised portions was 0.3 mm, and the width of the top surface of each of the raised portions was 0.1 mm.

Before execution of the ultrasonic bonding, the total of the thickness of the lead on the positive electrode side and the thickness of the multilayer structure of the tab regions was 0.16 mm. On the other hand, after execution of the ultrasonic bonding, the distance from the lower surface of the lead to the highest part of the composite films in the regions between the recessed portions of the lead increased to 0.2 mm.

As for each of Electrode Structure 4-1 and Electrode Structure 4-2, the connection resistance between the current collector on the positive electrode side and the lead was measured in the same way as each of Battery 1-1 to Battery 1-4. As for Electrode Structure 4-1, the value of the measured connection resistance was generally equal to that achieved with a metal foil current collector. However, in Electrode Structure 4-2, the value of the measured connection resistance was not sufficiently small. It was understood from the comparison between Electrode Structure 4-1 and Electrode Structure 4-2 that, when the arrangement pitch of the raised portions of the horn is an inappropriate value, for example, when the arrangement pitch of the raised portions of the horn is too small for the number of composite films in the cell, it is possible that the electrical connection cannot appropriately be formed between the electrodes in the cell and the lead.

[Verification of Effect of Number of Composite Films on Bonding Quality]

Next, Electrode Structure 5-1 to Electrode Structure 5-4 were produced through the same procedure as Electrode Structure 4-1 except that the number of composite films connected to the lead was changed. Further, the degree of bulging of the multilayer structure of the composite films from the lead in the regions between the recessed portions formed in the lead was compared.

(Electrode Structure 5-1)

In Electrode Structure 5-1, the number of positive electrodes was 5. Before execution of the ultrasonic bonding, the thickness of the multilayer structure of the tab regions was 0.04 mm. After execution of the ultrasonic bonding, the distance from the upper surface of the lead to the highest part of the composite films in the regions between the recessed portions of the lead increased to 0.07 mm. That is, in the regions between the recessed portions of the lead, the distance from the upper surface of the lead to the highest part of the composite films exhibited an increase of about 75% as compared with the original distance before execution of the ultrasonic bonding.

(Electrode Structure 5-2)

In Electrode Structure 5-2, the number of positive electrodes was 10. Before execution of the ultrasonic bonding, the thickness of the multilayer structure of the tab regions was 0.07 mm. After execution of the ultrasonic bonding, the distance from the upper surface of the lead to the highest part of the composite films in the regions between the recessed portions of the lead increased to 0.17 mm. That is, in the regions between the recessed portions of the lead, the distance from the upper surface of the lead to the highest part of the composite films exhibited an increase of about 143% as compared with the original distance before execution of the ultrasonic bonding.

(Electrode Structure 5-3)

In the cell of Electrode Structure 5-3, the number of positive electrodes was 15. In Electrode Structure 5-3, a 0.2 mm thick lead was bonded to a multilayer structure of 15 composite films likewise as in Battery 1-2.

Before execution of the ultrasonic bonding, the thickness of the multilayer structure of the tab regions was 0.11 mm. After execution of the ultrasonic bonding, the distance from the upper surface of the lead to the highest part of the composite films in the regions between the recessed portions of the lead increased to 0.31 mm. That is, in the regions between the recessed portions of the lead, the distance from the upper surface of the lead to the highest part of the composite films exhibited an increase of about 182% as compared with the original distance before execution of the ultrasonic bonding.

(Electrode Structure 5-4)

In Electrode Structure 5-4, the number of positive electrodes was 20. Also, in Electrode Structure 5-4, a 0.2 mm thick lead was bonded to the multilayer structure of the composite films likewise as in Electrode Structure 5-3.

Before execution of the ultrasonic bonding, the thickness of the multilayer structure of the tab regions was 0.15 mm. After execution of the ultrasonic bonding, the distance from the upper surface of the lead to the highest part of the composite films in the regions between the recessed portions of the lead increased to 0.48 mm. That is, in the regions between the recessed portions of the lead, the distance from the upper surface of the lead to the highest part of the composite films exhibited an increase of about 220% as compared with the original distance before execution of the ultrasonic bonding.

Thus, the change of the distance from the upper surface of the lead to the highest part of the composite films after the ultrasonic bonding step as compared with the distance before the ultrasonic bonding step varies depending on the number of composite films connected with the lead by the ultrasonic bonding. Note that, however, this change can vary depending on the shape of the tip end of the horn used in the ultrasonic bonding even when the number of composite films is common. The degree of bulging of the composite films in the regions between the recessed portions of the lead can vary depending on the arrangement pitch of the raised portions of the horn, the area of a region of the surface of the raised portions of the horn which is in contact with the one which is the uppermost layer included in the multilayer structure of the composite films, etc.

### INDUSTRIAL APPLICABILITY

An electrode for power storage devices according to an embodiment of the present disclosure is useful for a power supply in various electronic devices, electric motors, etc. A power storage device according to an embodiment of the present disclosure is applicable to, for example, a power supply for vehicles represented by bicycles and automobiles, a power supply for communication devices represented by smartphones, a power supply for various sensors, and a power supply for engines of Unmanned eXtended Vehicles (UxV).

### REFERENCE SIGNS LIST

11, 21 first electrically-conductive layer (of composite film)
12, 22 second electrically-conductive layer (of composite film)
14, 24 first layer
24r resin
25 bonded portion
28a opening (of recessed portion of composite film)
28p raised portion
51, 61, 61P-61V recessed portion (in upper surface of lead)
61a opening (of recessed portion in upper surface of lead)
62, 62A, 62B recessed portion (in lower surface of lead)
63 recessed portion (of composite film)
80, 80A, 80B, 80X-80Z horn
84, 84A, 84B, 84X-84Z raised portion (of horn)
90 anvil
94 raised portion (of anvil)
100A-100D lithium ion secondary battery
100E electric double layer capacitor
200A-200E cell
210A-210E first electrode (positive electrode)
210t tab region
212, 212E first material layer (active material layer)
215, 215A-215D composite film
220A-220E second electrode (negative electrode)
220t tab region
222, 222E second material layer (active material layer)
225, 225A-225D composite film
228, 228U, 228V recessed portion (of composite film)
240J third portion
250, 260 conductor plate (lead)
270, 270A, 270B third layer (separator)
270Ca, 270Cb, 270E third layer (separator)
290, 290E electrolyte
300 enclosure

1. An electrode for power storage devices, comprising:
a conductor plate having a first surface which has at least one first recessed portion and a second surface located opposite to the first surface, the first surface including a first region located outside the first recessed portion; and
a first composite film including a first layer which contains an insulative material, a first electrically-conductive layer and a second electrically-conductive layer, the first layer being provided between the first electrically-conductive layer and the second electrically-conductive layer, wherein
the first electrically-conductive layer of the first composite film is connected with the conductor plate at the first recessed portion, and
the second electrically-conductive layer of the first composite film is connected with the first electrically-conductive layer at a position overlapping the first recessed portion as viewed in a normal direction of the first region of the conductor plate.

2. The electrode for power storage devices of claim 1, wherein an organic substance is contained in a portion overlapping the first recessed portion as viewed in the normal direction, the organic substance being at a position deeper than the first region of the first surface.

3. The electrode for power storage devices of claim 1, wherein
the first electrically-conductive layer of the first composite film has a third surface facing the first region of the conductor plate, and the second electrically-conductive layer of the first composite film has a fourth surface located on a side opposite to the third surface with respect to the first layer, and
a distance along the normal direction from a part of the fourth surface of the second electrically-conductive layer overlapping the first recessed portion of the conductor plate as viewed in the normal direction to the conductor plate is smaller than a distance along the normal direction from a part of the fourth surface of the second electrically-conductive layer overlapping the first region of the conductor plate as viewed in the normal direction.

4. The electrode for power storage devices of claim 1, wherein a bottom of the first recessed portion includes a flat region.

5. The electrode for power storage devices of claim 1, further comprising a second composite film, the second composite film including a third electrically-conductive layer, a fourth electrically-conductive layer, and a second layer which contains an insulative material, wherein
the second layer is provided between the third electrically-conductive layer and the fourth electrically-conductive layer,
at least part of the third electrically-conductive layer is provided between the fourth electrically-conductive layer and the first composite film,
the fourth electrically-conductive layer has a fifth surface located on a side opposite to the third electrically-conductive layer,
the third electrically-conductive layer is connected with the first electrically-conductive layer and the second electrically-conductive layer of the first composite film at a position overlapping the first recessed portion as viewed in the normal direction,
the fourth electrically-conductive layer is connected with the third electrically-conductive layer at a position overlapping the first recessed portion as viewed in the normal direction, and
the fifth surface of the fourth electrically-conductive layer includes, at a portion overlapping the first recessed portion as viewed in the normal direction, a portion closer to the second surface than a portion of the first surface of the conductor plate located in the first region.

6. The electrode for power storage devices of claim 1, wherein the second surface of the conductor plate has one or more second recessed portions.

7. The electrode for power storage devices of claim 6, wherein the one or more second recessed portions include a second recessed portion located at a position overlapping the first recessed portion as viewed in the normal direction.

8. The electrode for power storage devices of claim 6, wherein
the at least one first recessed portion includes two first recessed portions arranged along a first direction perpendicular to the normal direction, and
the one or more second recessed portions include a second recessed portion located between the two first recessed portions as viewed in the normal direction.

9. The electrode for power storage devices of claim 1, wherein the at least one first recessed portion includes two first recessed portions arranged along a first direction perpendicular to the normal direction.

10. The electrode for power storage devices of claim 8, wherein the first layer of the first composite film includes a portion whose thickness increases in a direction from one to the other of the two first recessed portions.

11. The electrode for power storage devices of claim 8, wherein
the first electrically-conductive layer includes a first arc-shaped portion curved in a cross section perpendicular to the first region, and
the first arc-shaped portion is present between the two first recessed portions.

12. The electrode for power storage devices of claim 8, wherein
a part of a sixth surface of the first electrically-conductive layer which is on a side opposite to the conductor plate is curved in a direction away from the conductor plate in a cross section perpendicular to the first region, and
the part of the sixth surface is present between the two first recessed portions.

13. The electrode for power storage devices of claim 8, wherein
the first electrically-conductive layer of the first composite film includes a first turned-back section in which the first electrically-conductive layer is curved so as to mutually override such that the first electrically-conductive layer mutually overlaps as viewed in the normal direction, and
the first turned-back section is present between the two first recessed portions.

14. The electrode for power storage devices of claim 11, wherein
the second electrically-conductive layer includes a second arc-shaped portion curved in a cross section perpendicular to the first region, and
the second arc-shaped portion is present between the two first recessed portions.

15. The electrode for power storage devices of claim 11, wherein
a part of a surface of the second electrically-conductive layer which is distant from the conductor plate is curved in a direction away from the conductor plate in a cross section perpendicular to the first region, and
the part of the surface of the second electrically-conductive layer is present between the two first recessed portions.

16. The electrode for power storage devices of claim 11, wherein
the second electrically-conductive layer of the first composite film includes a second turned-back section in which the second electrically-conductive layer is curved so as to mutually override such that the second electrically-conductive layer mutually overlaps as viewed in the normal direction, and
the second turned-back section is present between the two first recessed portions.

17. The electrode for power storage devices of claim 8, wherein
each of the two first recessed portions has an opening in the first surface of the conductor plate, and
a maximum of a width of one of the openings is greater than a minimum of a distance from the one to the other of the openings.

18. The electrode for power storage devices of claim 8, wherein
each of the two first recessed portions has an opening in the first surface of the conductor plate, and
a maximum of a width of one of the openings is smaller than a minimum of a distance from the one to the other of the openings.

19. The electrode for power storage devices of claim 8, wherein
each of the two first recessed portions has an opening in the first surface of the conductor plate, and
a width along the first direction of one of the openings is smaller than a width along a second direction of the one of the openings, the second direction being perpendicular to the normal direction and the first direction.

20. The electrode for power storage devices of claim 8, wherein
each of the two first recessed portions has an opening in the first surface of the conductor plate, and
one of the openings includes a portion whose width varies along the first direction or a second direction that is perpendicular to the first direction.

21. The electrode for power storage devices of claim 8, wherein
each of the two first recessed portions has an opening in the first surface of the conductor plate, and
one of the openings has a crooked shape.

22. The electrode for power storage devices of claim 8, wherein
each of the two first recessed portions has an opening in the first surface of the conductor plate, and
one of the openings has a meandering shape.

23. The electrode for power storage devices of claim 17, wherein the openings have a rectangular shape.

24. The electrode for power storage devices of claim 1, wherein the at least one first recessed portion includes a plurality of first recessed portions arranged along a third direction and a fourth direction which are perpendicular to the normal direction and which are different from each other.

25. The electrode for power storage devices of claim 24, wherein
the plurality of first recessed portions include at least three first recessed portions arranged along the third direction, each of the at least three first recessed portions having an opening in the first surface of the conductor plate,
the at least three first recessed portions include a first set and a second set of two first recessed portions, in each of which sets the two first recessed portions are adjacent along the third direction with the first region interposed therebetween, and
a distance between openings of the two first recessed portions included in the first set is different from a distance between openings of the two first recessed portions included in the second set.

26. The electrode for power storage devices of claim 1, wherein the first composite film has a third recessed portion at a position which is on a side opposite to the conductor plate and which corresponds to each first recessed portion of the conductor plate, the third recessed portion being recessed toward the conductor plate.

27. The electrode for power storage devices of claim 9, further comprising a first active material layer provided on a part of the first composite film, wherein
the first layer of the first composite film includes
a first portion lying between the two first recessed portions, and
a second portion overlapping the first active material layer, and
a thickness along the normal direction of at least part of the first portion is greater than a thickness of the second portion.

28. A power storage device, comprising:
the electrode for power storage devices as set forth in claim 27;
a second electrode;
a second active material layer provided on the second electrode; and
an electrolyte and a separator provided between the first active material layer and the second active material layer.

29. A power storage device, comprising:
the electrode for power storage devices as set forth in claim 1;
a second electrode; and
an electrolyte provided between a part of the first composite film and the second electrode.

30. The power storage device of claim 29, further comprising
a first active material layer provided on the part of the first composite film,
a separator provided between the first active material layer and the second electrode, and
a second active material layer provided on the second electrode,
wherein the second active material layer is provided between the second electrode and the separator.

31. A secondary battery, comprising:
the power storage device as set forth in claim 28; and
an enclosure covering the energy storage device,
wherein at least one of the first active material layer and the second active material layer contains a material capable of intercalating and deintercalating lithium ions.

32. The secondary battery of claim 31, wherein the first electrically-conductive layer contains aluminum.

33. The secondary battery of claim 31, wherein the first electrically-conductive layer contains copper.

34. The secondary battery of claim 31, wherein one of the first active material layer and the second active material layer contains carbon.
